(19) United States
(12) Patent Application Publication
(10) Pub. No.: US 2026/0369617 A1
(43) Pub. Date: Nov. 19, 2026

(54) Secondary Battery, Electronic Device, And Vehicle

(71) Applicant: Semiconductor Energy Laboratory Co., Ltd., Kanagawa-ken (JP)

(72) Inventors: Shunpei YAMAZAKI, Setagaya, Tokyo (JP); Atsushi KAWATSUKI, Yokohama, Kanagawa (JP); Kousuke SASAKI, Atsugi, Kanagawa (JP); Kazutaka KURIKI, Ebina, Kanagawa (JP)

(73) Assignee: Semiconductor Energy Laboratory Co., Ltd., Kanagawa-ken (JP)

(21) Appl. No.: 19/488,425

(22) PCT Filed: May 27, 2024
(86) PCT No.: PCT/IB2024/055123

§ 371 Date: Nov. 26, 2025

(30) Foreign Application Priority Data
Jun. 2, 2023 (JP) 2023-091391
Mar. 14, 2024 (JP) 2024-039774

(51) Int. Cl. H01M 4/62; B60L 50/64; H01M 4/36; H01M 4/525; H01M 4/58; H01M 10/0525; H01M 10/0569

(52) U.S. Cl. CPC H01M 4/628; H01M 4/364; H01M 4/525; H01M 4/5825; H01M 10/0525; H01M 10/0569; B60L 50/64; H01M 2220/20; H01M 2300/0034; H01M 2300/0037

(57) ABSTRACT

To provide a positive electrode that is stable in a high potential state or a high temperature state and a highly safe secondary battery. The secondary battery includes a positive electrode, a negative electrode, and an electrolyte. The positive electrode includes a first positive electrode active material and a second positive electrode active material, the first positive electrode active material is represented by LiM1O₂ (M1 represents one or two or more selected from Fe, Ni, Co, Mn, and Al), and the second positive electrode active material is represented by LiM2PO₄ (M2 represents one or two or more selected from Fe, Ni, Co, and Mn). The first positive electrode active material contains an additive element X on a surface portion (X comprises one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic). The negative electrode contains graphite, and the graphite has a specific surface area of greater than or equal to 0.8 m²/g and 8 m²/g which is measured by a BET method.

### TECHNICAL FIELD

The present invention relates to a secondary battery. Alternatively, the present invention relates to an electronic device and a vehicle each including a secondary battery.

The technical field of the present invention is not limited the above. For example, the present invention relates to a positive electrode active material. Furthermore, the present invention relates to a manufacturing method or a fabrication method for the above technical field.

Note that an electronic device in this specification refers to a general device including a positive electrode active material or a secondary battery, and typically includes electro-optical devices, information terminal devices, and the like.

Note that in this specification, a power storage device refers to general elements and devices each having a function of storing power, and typically includes lithium-ion secondary batteries, lithium-ion capacitors, electric double layer capacitors, and the like.

### BACKGROUND ART

In recent years, a variety of power storage devices such as lithium-ion secondary batteries and lithium-ion capacitors have been actively developed. In particular, lithium-ion secondary batteries with high output and high energy density have been used in many applications such as electronic devices including mobile phones, smartphones, and laptop computers, and vehicles including electric vehicles (EVs), and are essential as rechargeable energy supply sources for today's information society.

As positive electrode active materials of lithium-ion secondary batteries, composite oxides, such as lithium cobalt oxide and lithium nickel-cobalt-manganese oxide each having a layered rock-salt structure, have been widely used. These materials have characteristics of high capacity and high discharge voltage, which are useful for active materials for power storage devices; to exhibit high capacity, a positive electrode is exposed to a high potential versus a lithium potential at the time of charge. In such a high potential state, extraction of a large amount of lithium sometimes reduces the stability of the crystal structure to cause significant deterioration in charge and discharge cycles. In the aforementioned background, improvements of positive electrode active materials included in positive electrodes of secondary batteries are actively conducted so as to achieve highly stable secondary batteries with high capacity (e.g., Patent Document 1 to Patent Document 3).

In addition, a crystal structure of a positive electrode active material has also been studied (Non-Patent Document 1 to Non-Patent Document 4).

XRD (X-ray diffraction) is one of methods used for analysis of a crystal structure of a positive electrode active material. With the use of the ICSD (Inorganic Crystal Structure Database) described in Non-Patent Document 5, XRD data can be analyzed. For example, the ICSD can be referred to for the lattice constant of the lithium cobalt oxide described in Non-Patent Document 6. For Rietveld analysis, the analysis program RIETAN-FP (Non-Patent Document 7) can be used, for example.

As image processing software, for example, ImageJ (Non-Patent Document 8 to Non-Patent Document 10) is known. Using this software makes it possible to analyze the shape of a positive electrode active material, for example.

Nanobeam electron diffraction can also be effectively used to identify the crystal structure of a positive electrode active material, in particular, the crystal structure of a surface portion of the positive electrode active material. For analysis of electron diffraction patterns, an analysis program called ReciPro (Non-Patent Document 11) can be used, for example.

Fluorides such as fluorite (calcium fluoride) have been used as fusing agents in iron manufacture and the like for a very long time, and the physical properties of fluorides have been studied (Non-Patent Document 12).

It is said to be difficult for lithium-ion secondary batteries to achieve both high capacity and safety. For example, the positive electrode active material having a layered rock-salt crystal structure has been disadvantageous in terms of safety because the crystal structure will be collapsed by excessive extraction of lithium ions at the time of charging, easily resulting in thermal runaway. For example, lithium-ion secondary batteries are known to enter thermal runaway after going through several states when the temperature increases during charging (Non-Patent Document 13). Moreover, various researches and developments have been conducted for the reliability and safety of lithium-ion secondary batteries. For example, Non-Patent Document 14 mentions the thermal stability of a positive electrode active material and an electrolyte solution.

As seen in Non-Patent Document 15, for example, Shannon's ionic radii are known.

### REFERENCE

### Patent Document

[Patent Document 1] Japanese Published Patent Application No. 2018-088400
[Patent Document 2] International Publication No. WO2018/203168 Pamphlet
[Patent Document 3] Japanese Published Patent Application No. 2020-140954

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348
[Non-Patent Document 2] Motohashi, T. et al., “Electronic phase diagram of the layered cobalt oxide system LiₓCoO₂ (0.0≤x≤1.0)”, Physical Review B, 80 (16); 165114
[Non-Patent Document 3] Zhaohui Chen et al., “Staging Phase Transitions in LiₓCoO₂”, Journal of The Electrochemical Society, 2002, 149 (12), A1604-A1609
[Non-Patent Document 4] G. G. Amatucci et al., “CoO₂, The End Member of the LiₓCoO₂ Solid Solution”, J. Electrochem. Soc., 143 (3), 1114 (1996)
[Non-Patent Document 5] Belsky, A. et al., “New developments in the Inorganic Crystal Structure Database (ICSD): accessibility in support of materials research and design”, Acta Cryst., (2002) B58 364-369.
[Non-Patent Document 6] Akimoto, J.; Gotoh, Y.; Oosawa, Y. “Synthesis and structure refinement of LiCoO₂ single crystals”, Journal of Solid State Chemistry (1998) 141, pp. 298-302
[Non-Patent Document 7] F. Izumi and K. Momma, Solid State Phenom., 130, 15-20 (2007).
[Non-Patent Document 8] Rasband, W. S., ImageJ, U. S. National Institutes of Health, Bethesda, Maryland, USA, http://rsb.info.nih.gov/ij/, 1997-2012.
[Non-Patent Document 9] Schneider, C. A., Rasband, W. S., Eliceiri, K. W., “NIH Image to ImageJ: 25 years of image analysis”, Nature Methods, 9, 671-675, 2012.
[Non-Patent Document 10] Abramoff, M. D., Magelhaes, P. J., Ram, S. J., “Image Processing with ImageJ”, Biophotonics International, volume 11, issue 7, pp. 36-42, 2004.
[Non-Patent Document 11] Seto, Y. & Ohtsuka, M., “ReciPro: free and open-source multipurpose crystallographic software integrating a crystal model database and viewer, diffraction and microscopy simulators, and diffraction data analysis tools” (2022) J. Appl. Cryst., 55.
[Non-Patent Document 12] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1], 12-17 (1953).
[Non-Patent Document 13] Nobuo Eda, “2-4: Mechanism of Heat Generation” in “Learning Charging and Discharging Techniques of Li Ion Battery from Data”, CQ Publishing Co., Ltd., Apr. 4, 2020, pp. 68-72
[Non-Patent Document 14] Shinya Kitano et al., GS Yuasa Technical Report, Vol. 2, No. 2, December 2015, pp. 18-24
[Non-Patent Document 15] Shannon et al., Acta A, 32 (1976) 751.

### SUMMARY OF THE INVENTION

### Problems to be Solved by the Invention

Lithium cobalt oxide (sometimes referred to as LiCoO₂ or LCO) is considered to have low thermal stability when too many lithium ions are extracted therefrom by charging. In a lithium-ion secondary battery, when an internal short circuit is caused by a nail penetration test, Joule heat is generated to make lithium cobalt oxide have high temperatures and release oxygen. The oxygen released from the lithium cobalt oxide reacts with an electrolyte solution or the like, which leads to thermal runaway in some cases. In spite of the active improvements of positive active materials conducted in Patent Documents 1 to 3, secondary batteries has room for improvement in terms of various aspects like safety, charge and discharge capacity, cycle performance, reliability, cost, and the like.

In view of the above, an object of one embodiment of the present invention is to provide a highly safe secondary battery. Another object of one embodiment of the present invention is to provide a secondary battery that is stable in a high potential state and/or a high temperature state. Another object of one embodiment of the present invention is to provide a secondary battery including a positive electrode active material whose crystal structure is not easily broken even when charging and discharging are repeated. Another object of one embodiment of the present invention is to provide a secondary battery including a positive electrode active material enabling excellent charge and discharge cycle performance. Another object of one embodiment of the present invention is to provide a secondary battery including a positive electrode active material that enables a high discharge capacity.

Note that the description of these objects does not preclude the presence of other objects. One embodiment of the present invention does not necessarily achieve all these objects. Note that other objects can be derived from the description of the specification, the drawings, and the claims.

### Means for Solving the Problems

In view of the above description, one embodiment of the present invention is a secondary battery including a positive electrode active material composite. In this specification and the like, a positive electrode active material composite refers to a structure including a first positive electrode active material and a second positive electrode active material covering at least part of the surface of the first positive electrode active material, preferably, a structure in which substantially the entire surface of the first positive electrode active material is covered with the second positive electrode active material. Here, a state where substantially the entire surface is covered with the second positive electrode active material means a state where the first positive electrode active material is covered with the second positive electrode active material without being in direct contact with an electrolyte. For example, in the case where the second positive electrode active material covers 80% or more, preferably 95% or more, further preferably 95% or more of the surface of the first positive electrode active material in a cross section of the first positive electrode active material, it can be said that the first positive electrode active material is not in direct contact with the electrolyte.

In a preferable mode, the particle diameter (typically, the median diameter D50) of the first positive electrode active material is 1/10 or less, preferably 1/50 or less, further preferably 1/100 or less of the particle diameter (typically, the median diameter D50) of the second positive electrode active material. In that case, a structure is preferable in which 10 or more, preferably 15 or more, further preferably 20 or more second positive electrode active materials are prepared to cover a surface of the first positive electrode active material.

The interface between the first positive electrode active material and the second positive electrode active material is preferably clear; however, a baking step makes it difficult to observe the interface in some cases.

In a further preferable mode, the composition of the first positive electrode active material is different from that of the second positive electrode active material. In another preferable mode, the second positive electrode active material have a higher crystal structure stability in a high-voltage charged state than the first positive electrode active material. In another preferable mode, the battery characteristics of a secondary battery including a positive electrode using only the first positive electrode active material are different from the battery characteristics of a secondary battery including a positive electrode using only the second positive electrode active material.

According to one embodiment of the present invention described above, the potential of the surface of the first positive electrode active material can be expected to be reduced. Reducing the voltage of the surface of the first positive electrode active material is sometimes referred to as mitigating an electric field applied to the positive electrode active material in this specification and the like. That is, when at least part of the first positive electrode active material is covered with the second positive electrode active material, a function of mitigating an electric field can be expected, and a highly safe secondary battery can be provided.

Furthermore, according to one embodiment of the present invention described above, a region where the first positive electrode active material is in direct contact with the electrolyte is reduced or eliminated; thus, release of the transition metal element and/or oxygen from the first positive electrode active material can be inhibited even when the first positive electrode active material is exposed to a high voltage charged state, so that a decrease in discharge capacity due to repeated charging and discharging can be inhibited.

When the first positive electrode active material is covered with the second positive electrode active material having a more stable crystal structure, a secondary battery with improved stability at high temperatures or a secondary battery with improved fire resistance can be provided. Specifically, when a material having a stable crystal structure is used, typically, lithium cobalt oxide to which magnesium and fluorine are added, lithium cobalt oxide to which magnesium, fluorine, aluminum, and nickel are added, or lithium nickel-cobalt-manganese oxide (with a preferable ratio of nickel:cobalt:manganese=8:1:1 or nickel:cobalt:manganese=9:0.5:0.5 or the like) also for the first positive electrode active material, a secondary battery with improved stability at high temperatures or a secondary battery with improved fire resistance can be provided. The lithium nickel-cobalt-manganese oxide is preferably a secondary particle. Furthermore, the lithium nickel-cobalt-manganese oxide is preferably covered with aluminum oxide. In this specification and the like, a secondary particle coated with a particular oxide is referred to as a metal oxide coated composite oxide in some cases. Since the above-described materials that can be used for the first positive electrode active material are excellent in stability in a high-voltage charged state, a secondary battery with improved heat resistance and/or fire resistance can be provided. Note that lithium cobalt oxide to which magnesium, fluorine, aluminum, and nickel are added is described later; the lithium cobalt oxide is a unique lithium cobalt oxide having a feature that large amounts of magnesium, fluorine, and aluminum are distributed in the surface portion of the positive electrode active material and nickel is widely distributed throughout the particle. Such a unique lithium cobalt oxide is particularly preferable as the first positive electrode active material.

As the second positive electrode active material, LiM2PO₄ (M2 is one or more selected from Fe, Ni, Co, and Mn) is preferably used. LiM2PO₄ (M2 is one or more selected from Fe, Ni, Co, and Mn) has high stability, particularly at high temperatures, and has a stable crystal structure even in a high-voltage charged state. Accordingly, the higher the mixing ratio of the second positive electrode active material in the positive electrode of one embodiment of the present invention is, the higher the fire resistance and the heat resistance of the secondary battery can be. As a preferable example of the mixing ratio, the ratio of the first positive electrode active material to the second positive electrode active material preferably satisfies 7:3, 8:2, or 9:1. Even in the case where the mixing proportion of the second positive electrode active material is reduced, a secondary battery using the second positive electrode active material can have high fire resistance, compared with a secondary battery not using the second positive electrode active material.

The above LiM2PO₄ (M2 is one or more selected from Fe, Ni, Co, and Mn) may be coated with carbon. A carbon coat layer is referred to as a carbon layer in this specification and the like in some cases.

In the positive electrode of the present invention, a carbon layer such as a carbon coat layer may be provided between the first positive electrode active material and the second positive electrode active material, namely, at a position corresponding to the interface between the first positive electrode active material and the second positive electrode active material. The carbon layer may be a layer containing a conductive material such as carbon nanotube (CNT), a graphene compound, or acetylene black (AB). A binder may be provided together with the carbon layer or instead of the carbon layer. Even in the structure where the carbon layer and/or the binder are positioned between the first positive electrode active material and the second positive electrode active material, the contact area between the first positive electrode active material and the electrolyte can be reduced by the second positive electrode active material.

One embodiment of the present invention is a secondary battery including a positive electrode, a negative electrode, and an electrolyte. The positive electrode includes a first positive electrode active material and a second positive electrode active material. The first positive electrode active material is represented by LiM1O₂ (M1 represents one or two or more selected from Fe, Ni, Co, Mn, and Al). The second positive electrode active material is represented by LiM2PO₄ (M2 represents one or two or more selected from Fe, Ni, Co, and Mn). The first positive electrode active material includes an additive element X on a surface portion (X represents one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic). The negative electrode includes graphite, and the graphite has a specific surface area greater than or equal to 0.8 m²/g and 8 m²/g which is measured by a BET method.

Another embodiment of the present invention is a secondary battery including a positive electrode, a negative electrode, and an electrolyte. The positive electrode includes a first positive electrode active material and a second positive electrode active material. The first positive electrode active material is represented by LiM1O₂ (M1 represents one or more selected from Fe, Ni, Co, Mn, and Al). The second positive electrode active material is represented by LiM2PO₄ (M2 represents one or more selected from Fe, Ni, Co, and Mn). The first positive electrode active material includes an additive element X on a surface portion (X includes one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic). The negative electrode includes graphite, and the graphite has a median diameter (D50) greater than or equal to 3 μm and less than or equal to 50 μm which is measured by a laser diffraction method.

In the present invention, the electrolyte preferably includes a fluorinated cyclic carbonate and a fluorinated chain carbonate as a solvent.

Preferably, in the present invention, the electrolyte includes a fluoroethylene carbonate and methyl trifluoropropionate as a solvent, and when a total volume of the fluoroethylene carbonate and the methyl trifluoropropionate is 100 vol %, a volume ratio of the fluoroethylene carbonate to the methyl trifluoropropionate is y:100−y (where 5≤y≤30).

Preferably, in the present invention, the additive element X includes at least magnesium and fluorine, and when a cross section of the first positive electrode active material is analyzed by STEM-EDX line analysis, a peak of a concentration of the fluorine is positioned closer to a surface than a peak of a concentration of the magnesium is.

Another embodiment of the present invention is a vehicle or an electronic device including the secondary battery.

### Effect of the Invention

According to one embodiment of the present invention, a highly safe secondary battery can be provided. According to another embodiment of the present invention, a secondary battery that is stable in a high potential state and/or a high temperature state can be provided. According to another embodiment of the present invention, a secondary battery including a positive electrode active material whose crystal structure is not easily broken even when charging and discharging are repeated can be provided. According to another embodiment of the present invention, a secondary battery including a positive electrode active material that enables excellent charge and discharge cycle performance can be provided. According to another embodiment of the present invention, a secondary battery including a positive electrode active material that enables a high discharge capacity can be provided.

Note that the description of these effects does not preclude the presence of other effects. One embodiment of the present invention does not need to have all these effects. Other effects will be apparent from and can be derived from the description of the specification, the drawings, the claims, and the like.

### BRIEF DESCRIPTION OF THE DRAWINGS

FIG. 1A and FIG. 1B are cross-sectional views illustrating a positive electrode active material composite of one embodiment of the present invention.

FIG. 2A and FIG. 2B are cross-sectional views illustrating a positive electrode active material composite of one embodiment of the present invention.

FIG. 3A and FIG. 3B are cross-sectional views illustrating a positive electrode active material composite of one embodiment of the present invention.

FIG. 4A and FIG. 4B are diagrams illustrating a method for forming a positive electrode active material composite of one embodiment of the present invention.

FIG. 5A to FIG. 5C are diagrams illustrating a method for forming a positive electrode active material composite of one embodiment of the present invention.

FIG. 6A and FIG. 6B are diagrams illustrating a nail penetration test.

FIG. 7 is a diagram illustrating motion of nail penetration.

FIG. 8 is a graph showing a change at the time of an internal temperature increase in a secondary battery in which an internal short circuit has occurred.

FIG. 9 is a graph showing a change at the time of an internal temperature increase of a secondary battery.

FIG. 10 is a diagram illustrating crystal structures of a positive electrode active material of one embodiment of the present invention.

FIG. 11 is a diagram illustrating the charge depth and crystal structures of a positive electrode active material.

FIG. 12 shows XRD patterns calculated from crystal structures.

FIG. 13 shows XRD patterns calculated from crystal structures.

FIG. 14A and FIG. 14B show XRD patterns calculated from crystal structures.

FIG. 15A and FIG. 15B are diagrams showing distributions of additive elements.

FIG. 16A to FIG. 16C are diagrams illustrating an example of a method of forming a positive electrode active material.

FIG. 17A to FIG. 17C are diagrams each illustrating an example of a method of forming of a positive electrode active material.

FIG. 18 is a diagram for illustrating an example of a formation method of a positive electrode active material.

FIG. 19A to FIG. 19C are diagrams each illustrating an example of a method of forming a positive electrode active material.

FIG. 20A is an exploded perspective view of a coin-type secondary battery, FIG. 20B is an external view of the coin-type secondary battery, and FIG. 20C is a cross-sectional perspective view thereof.

FIG. 21A illustrates an example of a cylindrical secondary battery. FIG. 21B illustrates an example of the cylindrical secondary battery. FIG. 21C illustrates an example of a power storage system including a plurality of cylindrical secondary batteries. FIG. 21D illustrates an example of a power storage system including a plurality of cylindrical secondary batteries.

FIG. 22A and FIG. 22B are diagrams illustrating examples of a secondary battery, and FIG. 22C is a diagram illustrating the internal state of the secondary battery.

FIG. 23A to FIG. 23C are diagrams illustrating an example of a secondary battery.

FIG. 24A and FIG. 24B are each an external view of a secondary battery.

FIG. 25A to FIG. 25C are diagrams illustrating a secondary battery and a method for manufacturing the secondary battery.

FIG. 26A to FIG. 26C are diagrams illustrating structure examples of a battery pack.

FIG. 27A and FIG. 27B are diagrams illustrating examples of a secondary battery.

FIG. 28A to FIG. 28C are diagrams illustrating an example of a secondary battery.

FIG. 29A and FIG. 29B are diagrams illustrating an example of a secondary battery.

FIG. 30A is a perspective view of a battery pack of one embodiment of the present invention, FIG. 30B is a block diagram of the battery pack, and FIG. 30C is a block diagram of a vehicle having a motor.

FIG. 31A to FIG. 31D are diagrams illustrating examples of transport vehicles.

FIG. 32A and FIG. 32B are diagrams each illustrating a power storage device of one embodiment of the present invention.

FIG. 33A is a diagram illustrating an electric bicycle, FIG. 33B is a diagram illustrating a secondary battery of an electric bicycle, and FIG. 33C is a diagram illustrating an electric motorcycle.

FIG. 34A to FIG. 34D are diagrams each illustrating an example of an electronic device.

FIG. 35A illustrates examples of wearable devices, FIG. 35B is a perspective view of a watch-type device, and FIG. 35C is a diagram illustrating a side surface of the watch-type device.

FIG. 35D is a diagram illustrating an example of wireless earphones.

FIG. 36 is a graph showing DSC measurement results.

FIG. 37A and FIG. 37B are graphs of charge and discharge curves.

FIG. 38A and FIG. 38B are graphs of cycle tests.

FIG. 39A and FIG. 39B are photographs of the nail penetration test.

FIG. 40 is a graph showing DSC measurement results.

### MODE FOR CARRYING OUT THE INVENTION

Hereinafter, embodiments of the present invention will be described in detail below with reference to the drawings. However, the present invention is not limited to the description below and it is easily understood by those skilled in the art that the mode and details can be modified in various ways. In addition, the present invention should not be construed as being limited to the description of the embodiments below.

A secondary battery includes a positive electrode and a negative electrode, for example. A positive electrode active material is a material included in the positive electrode. The positive electrode active material is a substance that performs a reaction contributing to a charge and discharge capacity, for example. Note that in some cases, the positive electrode active material partly contains a substance that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

In this specification and the like, particles are not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

Particle diameters can be measured by laser diffraction particle distribution and can be compared by the numerical values of D50. Here, D50 is a particle diameter when the cumulative amount is 50% in a cumulative curve obtained as a result of the particle size distribution measurement, i.e., a median diameter. Measurement of the size of a particle is not limited to laser diffraction particle distribution measurement; in the case where the size is less than or equal to the lower measurement limit of laser diffraction particle distribution measurement, the major axis of a cross section of the particle may be measured by analysis with a SEM (Scanning Electron Microscope), a TEM (Transmission Electron Microscope), or the like.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing − (minus sign) in front of the number instead of placing a bar over the number.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of the rock-salt crystal structure is distorted and the symmetry of the layered rock-salt crystal structure is inferior to that of the rock-salt crystal structure in some cases.

In this specification and the like, a rock-salt crystal structure refers to a structure in which cations and anions are alternately arranged. Note that a cation or anion vacancy may be included in part of the crystal structure.

In this specification and the like, the theoretical capacity of a positive electrode active material refers to the amount of electricity for the case where all the lithium that can be inserted into and extracted from the positive electrode active material is extracted. For example, the theoretical capacity of LiFePO₄ is 170 mAh/g per weight of the active material, the theoretical capacity of LiCoO₂ is 274 mAh/g per weight of the active material, the theoretical capacity of LiNiO₂ is 275 mAh/g per weight of the active material, and the theoretical capacity of LiMn₂O₄ is 148 mAh/g per weight of the active material.

In this specification and the like, the charge depth obtained when all the lithium that can be inserted and extracted is inserted is 0, and the charge depth obtained when all the lithium that can be inserted and extracted in a positive electrode active material is extracted is 1.

In this specification and the like, an example in which a lithium metal is used for a counter electrode in a secondary battery including a positive electrode and a positive electrode active material of one embodiment of the present invention is described in some cases; however, the secondary battery of one embodiment of the present invention is not limited to this example. A different material such as graphite or lithium titanate may be used for a negative electrode, for example. The properties of the positive electrode and the positive electrode active material of one embodiment of the present invention, such as a crystal structure unlikely to be broken by repeated charge and discharge and excellent cycle performance, are not affected by the material of the negative electrode. The secondary battery of one embodiment of the present invention probably has improved cycle performance owing to the synergy between the positive electrode active material and a negative electrode active material.

Note that in this specification and the like, ignition in a nail penetration test refers to a state where fire is observed outside an exterior body within 1 minute after nail penetration or a state where thermal runaway of a secondary battery has occurred within 1 minute after nail penetration. For example, a state where a pyrolysate(s) of a positive electrode and/or a negative electrode are/is observed at a position more than or equal to 2 cm away from a penetration point after a nail penetration test is finished is referred to as a state where thermal runaway has occurred. The pyrolysate(s) of the positive electrode and/or the negative electrode includes, for example, aluminum oxide formed by oxidation of aluminum of a positive electrode current collector or copper oxide formed by oxidation of copper of a negative electrode current collector.

For example, in the case where LiCoO₂ having a layered rock-salt structure is used as a positive electrode active material, theoretically, the atomic ratio O/Co is 2. Meanwhile, the ratio O/Co decreases when oxygen is released from LiCoO₂ owing to thermal runaway. Thus, a state where energy dispersive X-ray spectroscopy (EDX) analysis after a nail penetration test is finished reveals that the ratio O/Co at a position more than or equal to 2 cm away from a penetration point is less than 1.3, for example, is referred to as a state where thermal runaway has occurred. In other words, a state where EDX analysis reveals that the ratio O/Co at a position more than or equal to 2 cm away from the penetration point is greater than or equal to 1.3 can be referred to as a state where no thermal runaway has occurred.

Meanwhile, a state where fire, a spark, and/or fuming that are/is observed remain(s) at a penetration point in a nail penetration test, i.e., fire does not spread, and thermal runaway of a secondary battery does not occur is not referred to as ignition. For example, a secondary battery that does not suffer from the above ignition even after undergoing a nail penetration test can be regarded as a secondary battery that does not ignite.

Note that the description is made on the assumption that materials (such as a positive electrode active material, a negative electrode active material, an electrolyte solution, and a separator) of a secondary battery have not deteriorated unless otherwise specified. A decrease in discharge capacity due to aging treatment and burn-in treatment during the manufacturing process of a secondary battery is not regarded as deterioration. For example, the case where discharge capacity is higher than or equal to 97% of the rated capacity of a secondary battery composed of a cell or an assembled battery can be regarded as a non-deteriorated state. The rated capacity conforms to JIS C 8711:2019 in the case of a secondary battery for a portable device. The rated capacity of other secondary batteries conform to the JIS described above, JIS for electric vehicle propulsion, industrial use, and the like, standards defined by IEC, or the like.

In this specification and the like, in some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ions in the present invention, alkali metal ions or alkaline earth metal ions can be used; specifically, sodium ions or the like can be used. In that case, the present invention can be understood by replacing lithium ions with sodium ions or the like. Furthermore, in the case where there is no limitation on carrier ions, the term “secondary battery” is sometimes used.

In this specification and the like, the (001) plane, the (003) plane, and the like are sometimes collectively referred to as the (001) plane. In this specification and the like, the (001) plane is sometimes referred to as a C-plane, a basal plane, or the like. In lithium cobalt oxide, lithium has a two-dimensional diffusion path. That is, it can be said that the diffusion path of lithium lies along a plane. In this specification and the like, a plane where the diffusion path of lithium is exposed, i.e., a plane other than a plane into/from which lithium is inserted and extracted (specifically, the (001) plane), is sometimes referred to as an edge plane.

In this specification and the like, the loading level refers to the weight of an active material per unit surface area of a current collector. The loading level of a negative electrode active material can be adjusted in accordance with the capacity of a positive electrode. The above loading level is preferably a loading level per surface of a current collector in the case of both-side coating where slurry including an active material is applied onto both surfaces of the current collector. A lower loading level leads to lower discharge capacity. Thus, the loading level of a positive electrode active material is preferably larger than or equal to 8.0 mg/cm².

In this specification and the like, a secondary particle refers to a particle formed by aggregation of primary particles. In this specification and the like, a single particle is synonymous with a primary particle. In this specification and the like, a single crystal particle refers to a crystal particle whose inner portion has no grain boundary, whereas a polycrystal particle refers to a crystal particle whose inner portion has a grain boundary. A polycrystal particle may be regarded as a group of a plurality of crystallites, and a grain boundary may be regarded as an interface between two or more crystallites.

In this specification and the like, “carbonate” refers to an organic compound containing at least one carbonic ester in its molecular structure and includes cyclic carbonate and chain carbonate, unless otherwise specified. “Chain” includes both straight-chain and branched-chain.

In this specification and the like, the phrase “A and/or B” is sometimes used and is an example of an expression that comprehends only A, only B, and A and B.

### Embodiment 1

In this embodiment, a positive electrode active material of one embodiment of the present invention is described. Note that a layer including a positive electrode active material is referred to as a positive electrode active material layer, and the positive electrode active material layer includes at least a conductive material and/or a binder. In this specification and the like, a positive electrode active material layer and a positive electrode current collector are collectively referred to as a positive electrode.

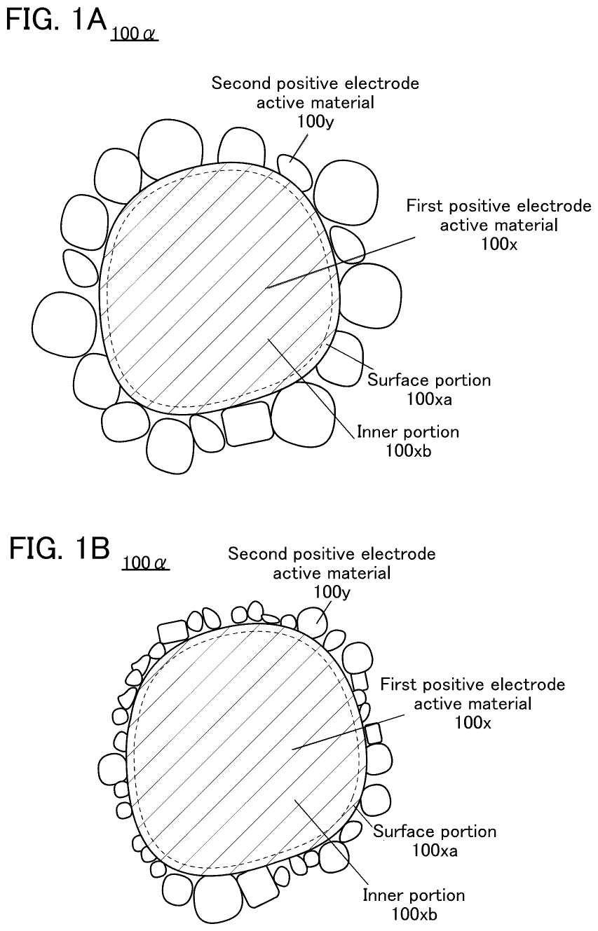

A positive electrode active material layer of one embodiment of the present invention includes a positive electrode active material composite 100α illustrated in FIG. 1A. The positive electrode active material composite 100α includes a first positive electrode active material 100x and a second positive electrode active material 100y. Note that there is no limitation on the bonding state between the first positive electrode active material 100x and the second positive electrode active material 100y in the present invention. That is, a state where the first positive electrode active material 100x is attached to the second positive electrode active material 100y is also regarded as the positive electrode active material composite 100α, and a state where the first positive electrode active material 100x is fixed to the second positive electrode active material 100y is also regarded as the positive electrode active material composite 100α. Note that the state where they are fixed includes a sintered state.

The first positive electrode active material 100x preferably has an average particle diameter of greater than or equal to 9 μm and less than 20 μm and a maximum particle diameter of less than 30 μm, and preferably has a large diameter (also referred to as a large particle diameter). A secondary particle may be used as the first positive electrode active material 100x, and the secondary particle preferably has an average particle diameter of greater than or equal to 9 μm and less than 20 μm and a maximum particle diameter of less than 30 μm. As the first positive electrode active material 100x, lithium cobalt oxide can be used. Furthermore, the second positive electrode active material 100y preferably has an average particle diameter less than or equal to 5 μm, preferably greater than or equal to 0.1 μm and less than or equal to 5 μm, and a maximum particle diameter less than 9 μm, and preferably has a small diameter (also referred to as a small particle diameter). As the second positive electrode active material 100y, lithium iron phosphate can be used. In this specification and the like, a median diameter (D50) can be used as the average particle diameter. In this specification and the like, a particle diameter that can be observed in one 100-μm-square cross section of a positive electrode can be used as the maximum particle diameter.

The first positive electrode active material 100x preferably has a structure including a surface portion 100xa and an inner portion 100xb, and in FIG. 1A, the interface between the surface portion 100xa and the inner portion 100xb is indicated by a dashed line. As described later, for the surface portion 100xa, a composite oxide, typically lithium cobalt oxide, having a unique layered rock-salt crystal structure containing an additive element X such as magnesium is preferably used as the first positive electrode active material 100x. Although FIG. 1A illustrates the second positive electrode active material 100y that includes neither a surface portion nor an inner portion, the second positive electrode active material 100y may also include the surface portion and the inner portion.

In this specification and the like, the surface portion of a positive electrode active material refers to a region with a depth of less than or equal to 100 nm, preferably a region with a depth of less than or equal to 50 nm. The surface portion is synonymous with the vicinity of a surface and a region in the vicinity of a surface. Note that the depth refers to a distance from a surface of the positive electrode active material toward an inner portion, which is perpendicular or substantially perpendicular to the surface. The “substantially perpendicular to the surface” refers to an angle with respect to the surface of greater than or equal to 80° and less than or equal to 100° (except 90°). The inner portion refers to a region that is deeper than the surface portion of the positive electrode active material. The inner portion is synonymous with a bulk or a core.

The positive electrode active material layer of one embodiment of the present invention includes the second positive electrode active material 100y in addition to the first positive electrode active material 100x, whereby a positive electrode with high safety can be provided. For example, in the case where a material having an olivine crystal structure, typically lithium iron phosphate, is used as a material used for the second positive electrode active material 100y, the crystal structure can be maintained even when lithium ions are extracted because a PO₄ structure is next to lithium sites in the olivine crystal structure, whereby high safety can be ensured. When the second positive electrode active material 100y described above is added to the first positive electrode active material 100x, the safety of the secondary battery is expected to be improved. Furthermore, in the case where the second positive electrode active material 100y is present around the first positive electrode active material 100x, dissolution of oxygen and/or cobalt from the first positive electrode active material 100x can be inhibited, which increases the safety of the secondary battery. Alternatively, when the positive electrode active material layer includes the second positive electrode active material 100y in addition to the first positive electrode active material 100x, the electrode density in the positive electrode, that is, the weight of the positive electrode active material (including the first positive electrode active material and the second positive electrode active material) per unit area or unit volume can be increased. Since the second positive electrode active material 100y has a small particle diameter, cleavage hardly occurs even when the pressing pressure at the time of manufacturing the positive electrode is increased. Thus, the pressing pressure for the positive electrode including the second positive electrode active material 100y can be made higher than that for the positive electrode not including the second positive electrode active material 100y, so that the electrode density can be increased while cleavage is inhibited. That is, addition of the second positive electrode active material 100y in the positive electrode active material layer can increase the electrode density of the positive electrode.

### <Pressing Pressure>

The above pressing refers to a step of applying pressure with a press machine after application of a positive electrode slurry to a positive electrode current collector. Although a crack triggered by pressing might be generated in the positive electrode active material, the second positive electrode active material 100y has a small particle diameter and thus is less likely to suffer such a crack. The positive electrode active material composite 100α like this can be subjected to high-pressure pressing and/or multiple-stage pressing as well. The high pressure is typically higher than or equal to 1000 kN/m and lower than or equal to 2000 kN/m, preferably higher than or equal to 1200 kN/m and lower than or equal to 1500 KN/m as a linear pressure of a press machine. For this pressing, two or more steps may be performed. In the case where pressing is performed in two or more steps, the linear pressure is preferably higher than or equal to 1000 kN/m and lower than or equal to 2000 kN/m, further preferably higher than or equal to 1200 kN/m and lower than or equal to 1500 KN/m in an arbitrary number of press steps. For example, when the second pressing is performed, the second pressing is performed at preferably higher than or equal to 1000 kN/m and lower than or equal to 2000 kN/m, further preferably higher than or equal to 1200 kN/m and lower than or equal to 1500 KN/m. Moreover, the first linear pressure is preferably lower than the second linear pressure, in which case generation of a crack can be inhibited. Note that the first linear pressure is higher than or equal to 100 kN/m and lower than or equal to 300 kN/m, preferably higher than or equal to 180 kN/m and lower than or equal to 250 kN/m. Even in the case where pressing is performed using only such a low linear pressure, the electrode density of the positive electrode active material composite 100α can be increased.

### <Electrode Density>

The electrode density of the positive electrode is preferably higher than or equal to 2.9 g/cm³ and lower than or equal to 4.5 g/cm³, further preferably higher than or equal to 3.5 g/cm³ and lower than or equal to 4.3 g/cm³. The electrode density can probably be within the above range when the linear pressure is set as described above. Alternatively, when the positive electrode active material composite 100α is formed through a heating step, the first positive electrode active material 100x and the second positive electrode active material 100y are sintered in some cases; after the sintering, the electrode density is probably within the range. In general, it is considered that safety might be lost when the electrode density is high; however, since the positive electrode active material composite 100α is used in the present invention, both high electrode density and safety can be achieved.

Furthermore, it is difficult to obtain a structure in which the first positive electrode active material 100x is not in contact with the electrolyte in the positive electrode active material layer; however, the presence of the second positive electrode active material 100y can reduce the area where the first positive electrode active material 100x is in contact with the electrolyte. Therefore, a positive electrode having higher safety can be provided. A decomposition product of an electrolyte may be attached to a slight region where the first positive electrode active material 100x is in contact with the electrolyte, i.e., part of the surface of the first positive electrode active material 100x. A decomposition product of an electrolyte may be attached to the entire surface or part of the surface of the second positive electrode active material 100y. The decomposition product of an electrolyte can be rephrased as a decomposition product of an electrolyte solution. The decomposition product is presumed to inhibit an excessive reaction with the electrolyte; thus, a positive electrode with high safety can be provided. Thus, a decomposition product may be attached to the positive electrode active material contained in the positive electrode active material composite 100α of one embodiment of the present invention.

Furthermore, a potential applied to the first positive electrode active material 100x is expected to be lowered owing to the presence of the second positive electrode active material 100y. Thus, even when an active material having a layered rock-salt crystal structure is used as the first positive electrode active material 100x and is exposed to a high voltage state, the decomposition of the electrolyte can be inhibited due to a decrease in voltage of the surface of the first positive electrode active material 100x, so that a positive electrode with higher safety can be provided. The decrease in voltage might cause a concern about a decrease in discharge capacity; however, in the present invention, the electrode density can be increased as described above, so that the concern about a decrease in discharge capacity can be dispelled. Furthermore, the second positive electrode active material 100y is also an active material capable of occluding and releasing carrier ions, so that the concern about a decrease in discharge capacity can be dispelled.

### <Surface Smoothness of Positive Electrode Active Material>

The shape of the surface of the positive electrode active material included in the positive electrode active material composite 100α is described. The positive electrode active material is preferably smooth as a whole. In other words, the positive electrode active material preferably has a shiny surface as a whole. The above-described positive electrode active material can be regarded as having no corner or being rounded. It is preferable that the positive electrode active material be smooth as a whole also in the state where the first positive electrode active material 100x and the second positive electrode active material 100y are sintered.

In order to satisfy the above description, it is preferable that no or very few ultrafine particles be attached to the surface at least in evaluation of powder of the first positive electrode active material 100x. In this specification and the like, an ultrafine particle refers to a metal oxide particle with a particle diameter greater than or equal to 0.001 μm and less than or equal to 0.1 μm. The ultrafine particle may be a fragment of the positive electrode active material and/or a start material (additive element source) of an additive element X that has not reacted, for example.

The particle diameter of the ultrafine particle is the Feret diameter or the equivalent circle diameter of projected area measured from a surface SEM (Scanning Electron Microscope) image. A state where the number of the ultrafine particles in a surface SEM image is less than or equal to 10/cm², preferably less than or equal to 5/cm² can be referred to as a state where there are no or few ultrafine particles.

The level of the surface smoothness of the first positive electrode active material 100x can be quantified from its cross-sectional SEM image. First, the first positive electrode active material 100x is processed with an FIB or the like, so that its cross section is exposed. At this time, the first positive electrode active material 100x is preferably covered with a protective film, a protective agent, or the like. Next, a SEM image of the interface between the first positive electrode active material 100x and the protective film or the like is captured. The SEM image is subjected to noise processing using image processing software. For example, the Gaussian Blur (σ=2) is performed, followed by binarization. In addition, interface extraction is performed using image processing software. Moreover, an interface line between the first positive electrode active material 100x and the protective film or the like is selected with a magic hand tool or the like, and data is extracted to spreadsheet software or the like. Note that the image processing software used for the noise processing, the interface extraction, or the like is not particularly limited, and for example, “ImageJ” can be used.

Next, with the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. In addition, the spreadsheet software or the like is not particularly limited, and Microsoft Office Excel can be used, for example. The surface roughness obtained in this manner is the surface roughness in the range of 400 nm of the circumference of the first positive electrode active material 100x.

On the surface of the particle of the first positive electrode active material 100x, root-mean-square (RMS) surface roughness, which is an index of roughness, is preferably less than 3 nm, further preferably less than 1 nm, still further preferably less than 0.5 nm.

The smooth surface is described using the powder evaluation of the first positive electrode active material 100x. In addition, also in powder evolution of the second positive electrode active material 100y and another positive electrode active material included in the positive electrode active material composite 100α, states similar to the state of the first positive electrode active material 100x are preferably exhibited.

### <Crystallinity>

The crystallinity of the positive electrode active material included in the positive electrode active material composite 100α is described. A high crystallinity is preferable, and a single crystal or a polycrystal is further preferable. It is particularly preferable that the positive electrode active material be a single crystal, in which case a crack is unlikely to be generated even when the volume of the positive electrode active material is changed due to charging and discharging. Moreover, the positive electrode active material is preferably a single crystal, in which case a secondary battery using the positive electrode active material has high safety.

To satisfy the above description, a single crystal or a polycrystal is desirably exhibited at least in the powder evaluation of the first positive electrode active material 100x. In addition, also in powder evaluation of the second positive electrode active material 100y and another positive electrode active material included in the positive electrode active material composite 100α, a single crystal or a polycrystal is desirably exhibited, as in the powder evaluation of the first positive electrode active material 100x.

### <Dislocation>

In the first positive electrode active material 100x, especially in the inner portion 100xb, the number of defects including dislocation is preferably small. Note that dislocation is a kind of crystal defect and is different from a point defect. Such dislocation can be observed with a TEM, for example. Defects such as dislocation are sometimes not observed in a specific 1-μm-square area of an observation sample in the case where the density of defects such as dislocation is sufficiently low. Note that dislocation is a kind of crystal defect and is different from a point defect. Furthermore, also in powder evaluation of the second positive electrode active material 100y and another positive electrode active material included in the positive electrode active material composite 100x, the number of defects including dislocation is preferably small, as in the powder evaluation of the first positive electrode active material 100x.

### <Crystallite Size>

The crystallite size of the positive electrode active material included in the positive electrode active material composite 100α is described. The crystallite size is measured by XRD. Specifically, the crystallite size is preferably greater than or equal to 300 nm, for example. There is a relation in which the crystallite size measured by XRD is larger as the number of dislocations is smaller in the region observed by the above-described TEM.

The crystallite size can be calculated using ICSD coll. code. 172909 as literature data of lithium cobalt oxide and a diffraction pattern that is obtained with Bruker D8 ADVANCE as an XRD apparatus, for example, under the following conditions: CuKα₁ source is used as an X-ray source, 2θ is from 15° to 90°, an increment is 0.005°, and a detector is LYNXEYE XE-T. Analysis can be conducted using DIFFRAC.TOPAS ver. 6 as crystal structure analysis software. A value of LVol-IB, which is calculated by the above method, is preferably employed as a crystallite size.

A diffraction pattern for calculation of the crystallite size is preferably obtained with only the positive electrode active material as a measurement target, or may be obtained from a positive electrode including a current collector, a binder, a conductive material, and the like in addition to the positive electrode active material. Note that the positive electrode active material may have orientation owing to, for example, pressure application in a manufacturing process of the positive electrode. With high orientation, the crystallite size might fail to be calculated accurately; thus, it is further preferable to obtain a diffraction pattern in the following manner: a positive electrode active material layer is taken out from the positive electrode, a binder and the like in the positive electrode active material layer are removed to some extent using an organic solvent or the like, and the positive electrode active material is put in a sample holder, for example. Furthermore, in the case of a powder sample, a diffraction pattern can be obtained in a manner where powder is attached onto a reflection-free silicon plate coated with grease, for example.

### <Differential Scanning Calorimetry Analysis>

In differential scanning calorimetry (DSC) measurement, the amount of heat in the positive electrode active material composite 100α is expected to be smaller than that in the case where only the first positive electrode active material 100x is measured. For DSC measurement, a high-sensitive differential scanning calorimeter (Thermo plus EVO2 DSC8231) manufactured by Rigaku Corporation, can be used.

The positive electrode active material layer of one embodiment of the present invention may include the positive electrode active material composite 100α illustrated in FIG. 1B. In the positive electrode active material composite 100α illustrated in FIG. 1B, the second positive electrode active material 100y has an average particle diameter of greater than or equal to 0.1 μm and less than or equal to 5 μm and a maximum particle diameter of less than 9 μm, and is smaller than the second positive electrode active material 100y illustrated in FIG. 1A. It is found that as the average particle diameter and/or the maximum particle diameter of the second positive electrode active material 100y decrease, the contact area with the first positive electrode active material 100x, i.e., the interface with the first positive electrode active material 100x, increases. The positive electrode active material composite 100α illustrated in FIG. 1B is a preferred mode, because the area where the first positive electrode active material 100x is in contact with the electrolyte can be further reduced. The other structures in FIG. 1B are similar to those described with reference to FIG. 1A.

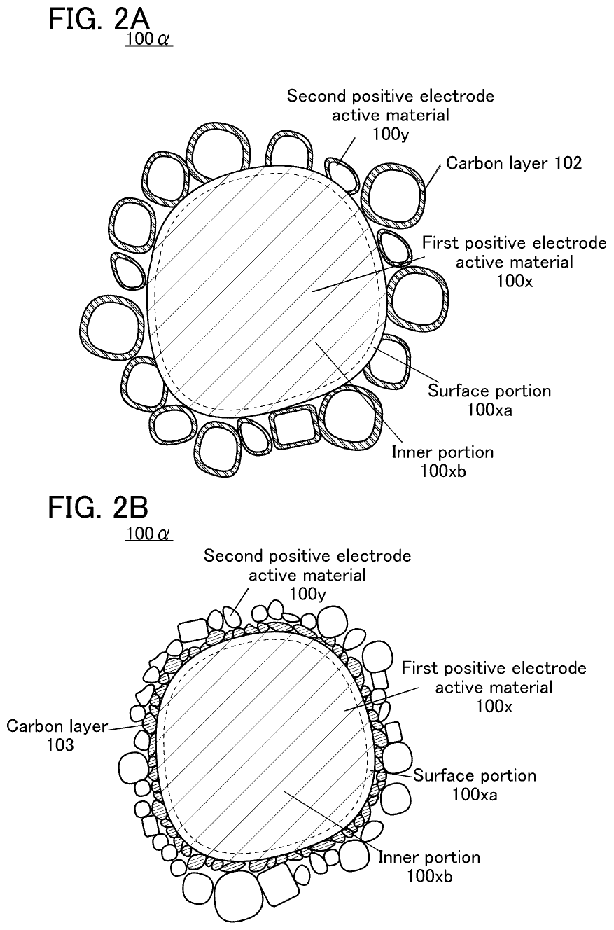

The positive electrode active material layer of one embodiment of the present invention may include the positive electrode active material composite 100α illustrated in FIG. 2A. As illustrated in FIG. 2A, the positive electrode active material composite 100α of one embodiment of the present invention may include the second positive electrode active material 100y covered with a carbon layer 102. As the material used for the second positive electrode active material 100y has higher electric resistance, safety is improved. In view of the above, a structure in which the resistance is moderately reduced with the use of the carbon layer 102 is preferable. Furthermore, a potential applied to the first positive electrode active material 100x is expected to be further lowered owing to the second positive electrode active material 100y covered with the carbon layer 102. The other structures in FIG. 2A are similar to those described with reference to FIG. 1A and FIG. 1B.

The positive electrode active material layer of one embodiment of the present invention may include the positive electrode active material composite 100α illustrated in FIG. 2B. As illustrated in FIG. 2B, the positive electrode active material composite 100α of one embodiment of the present invention may include the carbon layer 103 between the first positive electrode active material 100x and the second positive electrode active material 100y. One kind or two or more kinds selected from carbon black such as acetylene black or furnace black, graphite such as artificial graphite or natural graphite, carbon fiber such as carbon nanofiber or carbon nanotube, and a graphene compound can be used as the carbon layer 103. Furthermore, the carbon layer 103 may include a binder in addition to the above conductive material, and the mixing proportion of the conductive material is preferably higher than that of the binder. The carbon layer 103 is expected to further lower the potential applied to the first positive electrode active material 100x. The other structures in FIG. 2B are similar to those described with reference to FIG. 1A to FIG. 2A.

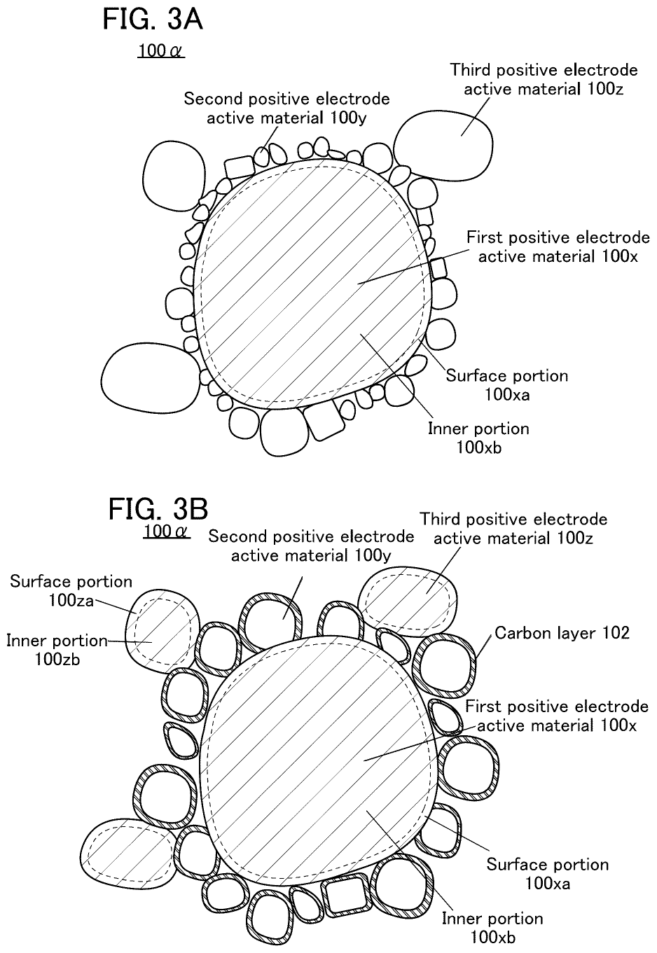

The positive electrode active material layer of one embodiment of the present invention may include the positive electrode active material composite 100α illustrated in FIG. 3A. As illustrated in FIG. 3A, the positive electrode active material composite 100α of one embodiment of the present invention may contain a third positive electrode active material 100z in addition to the first positive electrode active material 100x and the second positive electrode active material 100y. The second positive electrode active material 100y has a small particle diameter in the ranges of the average particle diameter and the maximum particle diameter as illustrated in FIG. 1B. The third positive electrode active material 100z preferably has an average particle diameter of greater than or equal to 5 μm and less than or equal to 9 μm, and preferably has a medium diameter (also referred to as a medium particle diameter). The content of the third positive electrode active material 100z can be smaller than the content of the second positive electrode active material 100y. The content can be expressed by a numerical value in mass %. When two or more positive electrode active materials with different particle diameters are added to the first positive electrode active material 100x, the density of the positive electrode active material that contributes to a battery reaction in the positive electrode active material layer can be increased. The third positive electrode active material 100z may have the same composition as the second positive electrode active material 100y or the same composition as the first positive electrode active material 100x. The other structures in FIG. 3A are similar to those described with reference to FIG. 1A to FIG. 2B.

The positive electrode active material layer of one embodiment of the present invention may include the positive electrode active material composite 100α illustrated in FIG. 3B. As illustrated in FIG. 3B, the positive electrode active material composite 100α of one embodiment of the present invention may contain the third positive electrode active material 100z in addition to the first positive electrode active material 100x and the second positive electrode active material 100y. The third positive electrode active material 100z may have the same composition as the second positive electrode active material 100y or the same composition as the first positive electrode active material 100x. Furthermore, the third positive electrode active material 100z preferably includes a surface portion 100za and an inner portion 100zb. The surface portion 100za can have the same composition as the surface portion 100xa, and the inner portion 100zb can have the same composition as the inner portion 100xb. The content of the third positive electrode active material 100z can be smaller than the content of the second positive electrode active material 100y. The content can be expressed by a numerical value in mass %. When two or more positive electrode active materials with different particle diameters are added to the first positive electrode active material 100x, the density of the positive electrode active material that contributes to a battery reaction in the positive electrode active material layer can be increased. The other structures in FIG. 3B are similar to those described with reference to FIG. 1A to FIG. 3A.

### [Positive Electrode Active Material Composite]

Regarding the positive electrode active material composite of one embodiment of the present invention, the structure including the first positive electrode active material 100x and the second positive electrode active material 100y and the structure including the first positive electrode active material 100x, the second positive electrode active material 100y, and the third positive electrode active material 100z are described; a desired mode of the positive electrode active material composite is a structure in which at least part of a smooth surface of the first positive electrode active material 100x is covered with the second positive electrode active material 100y. Alternatively, a desired mode of the positive electrode active material composite is a structure in which at least part of the smooth surface of the first positive electrode active material 100x is covered with the second positive electrode active material 100y and the third positive electrode active material 100z.

Here, the state where the first positive electrode active material 100x is covered is preferably a structure where substantially the entire surface of the first positive electrode active material 100x is covered with at least the second positive electrode active material 100y, and the state where substantially the entire surface of the first positive electrode active material 100x is covered is an ideal state where the first positive electrode active material 100x is not in direct contact with the electrolyte. Thus, in the present invention, part of the surface of the first positive electrode active material 100x may be covered with the third positive electrode active material 100z. In other words, the above-described state is a state where, in one cross section of the positive electrode active material composite, the second positive electrode active material 100y and/or the third positive electrode active material 100z cover 80% or more, preferably 90% or more of the first positive electrode active material 100x.

By covering at least part of the surface of the first positive electrode active material 100x with the second positive electrode active material 100y and/or the third positive electrode active material 100z, the region where the first positive electrode active material 100x is in direct contact with the electrolyte decreases. Thus, release of the transition metal element and/or oxygen from the first positive electrode active material 100x in a high-voltage charged state can be inhibited. Furthermore, release of the additive element X and/or oxygen from the first positive electrode active material 100x in a high-voltage charged state can be inhibited. Accordingly, a capacity reduction due to repeated charging and discharging can be inhibited.

The state where at least part of the surface of the first positive electrode active material 100x is covered with the second positive electrode active material 100y and/or the third positive electrode active material 100z or the like probably exhibits charge-discharge characteristics different from those in the case where the first positive electrode active material 100x and the second positive electrode active material 100y and/or the third positive electrode active material 100z are simply mixed.

With the use of the second positive electrode active material 100y and/or the third positive electrode active material 100z, which have a stable crystal structure even in a high-voltage charged state, a secondary battery including the positive electrode active material composite of one embodiment of the present invention can achieve an effect such as improvement in safety. In particular, by using, as the first positive electrode active material 100x, the material having excellent stability in a high-voltage charged state, such as lithium cobalt oxide to which magnesium and fluorine are added; lithium cobalt oxide to which magnesium, fluorine, aluminum, and nickel are added; or a metal-oxide-coated composite oxide in which secondary particles of lithium nickel-cobalt-manganese oxide with a nickel:cobalt:manganese ratio of 8:1:1, 9:0.5:0.5, or the like are coated with aluminum oxide, the positive electrode active material composite can have further improved durability and further improved stability in a high-voltage charged state. In addition, the secondary battery using the positive electrode active material composite can have further improved heat resistance and/or fire resistance. Note that a feature of lithium cobalt oxide to which magnesium, fluorine, aluminum, and nickel are added lies in that large amounts of magnesium, fluorine, and aluminum are contained in the surface portion of the positive electrode active material particle and nickel is widely distributed throughout the particle. Thus, in the case where initial heating described later is performed, repetitive high-voltage charge and discharge performance are significantly excellent. Thus, the above-described lithium cobalt oxide is a particularly preferable material as the first positive electrode active material 100x.

Note that in this embodiment, the structure in which at least part of the surface of the positive electrode active material composite is covered with the carbon layer 103 containing a graphene compound or the like is described as the positive electrode of the present invention. The state where the carbon layer 103 covers the first positive electrode active material 100x is a state where the carbon layer 103 covers 80% or more, preferably 90% or more of the first positive electrode active material 100x in one cross section of the positive electrode active material composite.

### [Positive Electrode Active Material]

As the first positive electrode active material 100x, a composite oxide that is represented by LiM1O₂ (M1 is one or two or more selected from Fe, Ni, Co, Mn, and Al) and has a layered rock-salt crystal structure can be used. In addition, as the first positive electrode active material 100x, a composite oxide which is represented by LiM1O₂ and to which an additive element X is added can be used. As the additive element X contained in the first positive electrode active material 100x, it is preferable to use one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic. These elements further stabilize the crystal structure of the first positive electrode active material 100x in some cases. These elements further stabilize the crystal structure included in the first positive electrode active material 100x in some cases. Magnesium is an element that can inhibit a shift in the CoO₂ layer of lithium cobalt oxide, and lithium cobalt oxide to which magnesium is added is preferably used as the first positive electrode active material 100x. In addition to the above, as the first positive electrode active material 100x, lithium cobalt oxide to which magnesium and fluorine are added; lithium cobalt oxide to which magnesium, fluorine, aluminum, and nickel are added; lithium cobalt oxide to which magnesium, fluorine, and titanium are added; lithium nickel-cobalt oxide to which magnesium and fluorine are added; lithium cobalt-aluminum oxide to which magnesium and fluorine are added; lithium nickel-cobalt-aluminum oxide to which magnesium and fluorine are added; lithium nickel-cobalt-manganese oxide to which magnesium and fluorine are added; or the like is preferably used. Needless to say, lithium cobalt oxide, lithium nickel-cobalt-aluminum oxide, lithium nickel-cobalt-manganese oxide, or the like that does not contain the additive element X may be used as the first positive electrode active material 100x. Here, as for the proportions of the transition metals of the lithium nickel-cobalt-manganese oxide, the proportion of nickel is preferably high; e.g., a material with a ratio (weight ratio) of nickel:cobalt:manganese=8:1:1 or nickel:cobalt:manganese=9:0.5:0.5 is preferred. In the case of the above-described lithium nickel-cobalt-manganese oxide, calcium is preferably used as the additive element X.

In addition, as the first positive electrode active material 100x, a material in which secondary particles of the composite oxide represented by LiM1O₂ (M1 is one or two or more selected from Fe, Ni, Co, Mn, and Al) are coated with a metal oxide may be used. As the metal oxide, an oxide of one or two or more of metals selected from Al, Ti, Nb, Zr, La, and Li can be used. For example, a metal-oxide-coated composite oxide in which secondary particles of the composite oxide represented by LiM1O₂ (M1 is one or more selected from Fe, Ni, Co, Mn, and Al) are coated with aluminum oxide can be used as the first positive electrode active material 100x. For example, a metal-oxide-coated composite oxide in which secondary particles of lithium nickel-cobalt-manganese oxide with a ratio (weight ratio) of nickel:cobalt:manganese=8:1:1 or nickel:cobalt:manganese=9:0.5:0.5 are coated with aluminum oxide can be used. Here, the thickness of the coating layer is preferably small, for example, greater than or equal to 1 nm and less than or equal to 200 nm, further preferably greater than or equal to 1 nm and less than or equal to 100 nm. In the case of the above-described lithium nickel-cobalt-manganese oxide, calcium is preferably used as the additive element X.

As the method for forming the first positive electrode active material 100x, a formation method described in an embodiment below can be used.

As the second positive electrode active material 100y, LiM2PO₄ having an olivine crystal structure (M2 is one or two or more selected from Fe, Ni, Co, and Mn) can be used. Examples of LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFe_{f}Ni_{g}CoₕMnᵢPO₄ (f+g+h+i is 1 or less, 0<f<1, 0<g<1, 0<h<1, and 0<i<1). In addition, the carbon layer 102 may be provided on the particle surface of the second positive electrode active material 100y.

As a method for forming the second positive electrode active material 100y, a known method can be used.

### [Carbon Layer]

The carbon layer 103 included in the positive electrode active material composite 100α is described again. As the carbon layer 103, one kind or two or more kinds of carbon black such as acetylene black or furnace black, graphite such as artificial graphite or natural graphite, carbon fiber such as carbon nanofiber or carbon nanotube, and a graphene compound can be used.

A graphene compound in this specification and the like includes multilayer graphene, multi graphene, graphene oxide, multilayer graphene oxide, multi graphene oxide, reduced graphene oxide, reduced multilayer graphene oxide, reduced multi graphene oxide, or the like. A graphene compound contains carbon, has a plate-like shape, a sheet-like shape, or the like, and has a two-dimensional structure formed of six-membered rings of carbon atoms. A graphene compound preferably has a curved shape. A graphene compound having a plate-like shape, a sheet-like shape, or the like may be referred to as a carbon sheet. A graphene compound preferably includes a functional group. The graphene compound may be rounded like carbon nanofiber.

In this specification and the like, for example, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms, for example. The reduced graphene oxide may be referred to as a carbon sheet. The reduced graphene oxide functions by itself but a plurality of reduced graphene oxide may be stacked. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even in a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even in a small amount.

Reducing graphene oxide can form a vacancy in a graphene compound in some cases. In other words, the graphene compound preferably includes a vacancy in part of a carbon sheet. In the graphene compound, a vacancy through which carrier ions such as lithium ions can pass is provided in part of a carbon sheet, which can facilitate insertion and extraction of carrier ions in the surface of an active material covered with the graphene compound to increase the rate characteristics of a secondary battery. The vacancy provided in part of the carbon sheet is referred to as a hole, a defect, or a gap in some cases.

In a reduction method of oxide graphene, it is preferable to perform reduction after formation of a layer to be an active material layer by using graphene oxide as the graphene compound and mixing the graphene oxide with an active material. That is, the formed active material layer preferably contains reduced graphene oxide. When graphene oxide with extremely high dispersibility in a polar solvent is used to form the graphene compound, the graphene compound can be substantially uniformly dispersed in the active material layer. The solvent is removed by volatilization from a dispersion medium containing the uniformly dispersed graphene oxide to reduce the graphene oxide; hence, the graphene compounds remaining in the active material layer partly overlap with each other and are dispersed to make a surface contact with each other, thereby forming a three-dimensional conductive path. Note that graphene oxide can be reduced by heat treatment or with the use of a reducing agent, for example.

The carbon layer 103 may contain a material in which an end portion of graphene is terminated with fluorine.

The graphene compound has a sheet shape. Thus, in the cross section of the active material layer, sheet-shaped graphene compounds are observed to be dispersed in some cases. The plurality of graphene compounds are formed to partly cover a plurality of particulate active materials or adhere to the surfaces of the plurality of particulate active materials, so that the graphene compounds make surface contact with the particulate active materials.

When a plurality of graphene compounds are bonded to each other, a net-like graphene compound sheet (hereinafter referred to as a graphene compound net or a graphene net) can be formed. A graphene net that covers active materials can function also as a binder for bonding the active materials. Accordingly, the amount of the binder can be reduced, or the binder does not have to be used. This can increase the proportion of the active material in the electrode volume and the electrode weight. That is to say, the discharge capacity of the secondary battery can be increased.

With a spray dry apparatus, a graphene compound that is the conductive material can be formed as a coating film to cover the entire surface of the active material. Since the graphene compounds are positioned between active materials, the graphene compounds are electrically connected to each other, so that a conductive path is formed.

A catalyst used in formation of the graphene compound may be contained, together with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

### [Forming Method of Positive Electrode Active Material Composite]

The above-described positive electrode active material composite 100α is obtained by a composite formation process using positive electrode active materials prepared. As the composite formation process, a composite formation process using mechanical energy such as a mechanochemical method, a mechanofusion method, or a ball mill method can be used, for example. As another composite formation process, a composite formation process by a liquid phase reaction such as a coprecipitation method, a hydrothermal method, or a sol-gel method can be used. As another composite formation process, a composite formation process by a gas phase reaction such as a barrel sputtering method, an ALD (Atomic Layer Deposition) method, an evaporation method, or a CVD (Chemical Vapor Deposition) method can be used. That is, one or two or more processes selected from the above methods can be used for the composite formation process. Heat treatment may be performed after the composite formation process.

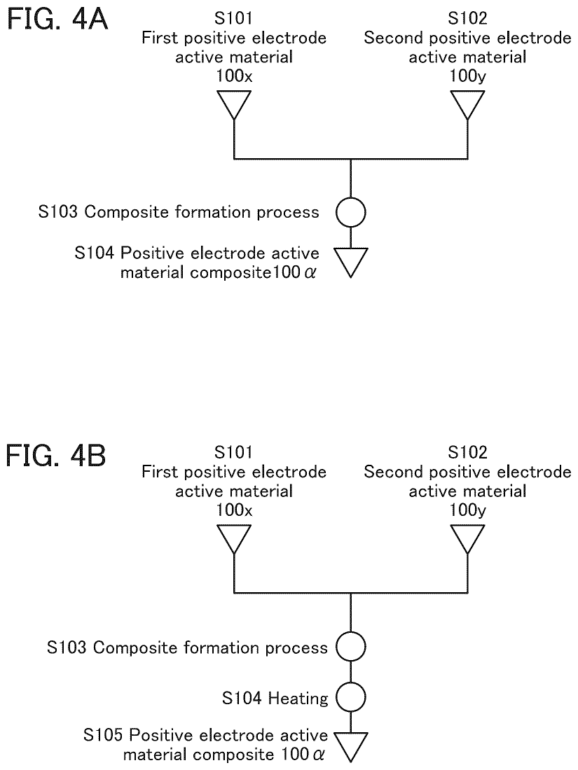

In this embodiment, a formation method in which a composite formation process using mechanical energy is performed on the first positive electrode active material 100x and the second positive electrode active material 100y is described with reference to FIG. 4A and FIG. 4B. Note that the present invention should not be interpreted as being limited to these descriptions.

In FIG. 4A, the first positive electrode active material 100x is prepared in Step S101 and the second positive electrode active material 100y is prepared in Step S102.

As the first positive electrode active material 100x, it is preferable to use a composite oxide represented by LiM1O₂ (M1 is one or more selected from Fe, Ni, Co, Mn, and Al), it is further preferable to use a composite oxide to which an additive element X is added, and preferable examples thereof include a lithium cobalt oxide to which magnesium and fluorine are added and a lithium cobalt oxide to which magnesium, fluorine, aluminum, and nickel are added. In particular, lithium cobalt oxide that has been subjected to the initial heating is preferably used. By the initial heating, lithium cobalt oxide having a smooth surface can be obtained. The initial heating refers to heating performed on lithium cobalt oxide, and it is preferable to perform the initial heating before introduction of the additive element X to obtain a smooth surface.

As another example of the first positive electrode active material 100x, lithium nickel-cobalt-manganese oxide can be used. Here, as for the proportions of the transition metals in the lithium nickel-cobalt-manganese oxide, the proportion of nickel is preferably high; e.g., a material with a nickel:cobalt:manganese ratio of 8:1:1 or a nickel:cobalt:manganese ratio of 9:0.5:0.5 is preferable.

As another example of the first positive electrode active material 100x, a metal-oxide-coated composite oxide in which secondary particles of lithium nickel-cobalt-manganese oxide are coated with a metal oxide, typically, aluminum oxide, can be used. The thickness of the metal oxide is preferably small, for example, greater than or equal to 1 nm and less than or equal to 200 nm, further preferably greater than or equal to 1 nm and less than or equal to 100 nm.

As the second positive electrode active material 100y, LiM2PO₄ having an olivine crystal structure (M2 is one or more selected from Fe, Ni, Co, and Mn) can be used. The above-described material, e.g., LiFePO₄, LiMnPO₄, LiFeₐMn_{b}PO₄ (a+b is 1 or less, 0<a<1, 0<b<1), or LiFeₐNi_{b}PO₄ (a+b is 1 or less, 0<a<1, 0<b<1) can be used as LiM2PO₄. In addition, the carbon layer 102 may be provided on the surface of the second positive electrode active material 100y. Note that the second positive electrode active material 100y can have the same composition as the positive electrode active material mentioned in the description of the first positive electrode active material 100x as long as the second positive electrode active material 100y can have the above-described small particle diameter.

Note that as the combination of the first positive electrode active material 100x and the second positive electrode active material 100y, it is desirable to select a combination that is less likely to cause a step in charge and discharge curves in accordance with characteristics required for a secondary battery. Alternatively, as the combination of the first positive electrode active material 100x and the second positive electrode active material 100y, it is desirable to select a combination that causes a step in charge and discharge curves at a desired charge rate. In the case where a step is caused in the charge and discharge curves, the step is preferably positioned at a charge rate that does not affect circuit design.

Next, in Step S103, a composite formation process of the first positive electrode active material 100x and the second positive electrode active material 100y is performed. In the case of performing the composite formation process by using mechanical energy, the composite formation process can be performed by a mechanochemical method. Alternatively, the composite formation process may be performed by a mechanofusion method.

In the case where a ball mill is used in Step S103, zirconia balls are preferably used as media, for example. In order to perform mixing, a dry ball mill process is desired. In the case of performing a wet ball mill process, acetone can be used. In the case of performing a wet ball mill process, it is preferable to use dehydrated acetone with a moisture content of 100 ppm or lower, desirably 10 ppm or lower.

The composite formation process in Step S103 can create a state where at least part of the surface, desirably, substantially the entire surface of a particle of the first positive electrode active material 100x is covered with the second positive electrode active material 100y.

Through the above steps, the positive electrode active material composite 100α of one embodiment of the present invention can be formed (Step S104).

In a formation method illustrated in FIG. 4B, the steps up to Step S103 are the same as those in the formation method illustrated in FIG. 4A, and heat treatment is performed in Step S104 after Step S103. The heating in Step S104 is performed in an oxygen-containing atmosphere or a nitrogen-containing atmosphere at higher than or equal to 500 °C and lower than or equal to 950 °C, preferably higher than or equal to 600 °C and lower than or equal to 850 °C, for longer than or equal to 1 hour and shorter than or equal to 60 hours, preferably for longer than or equal to 2 hours and shorter than or equal to 20 hours. When the heating is performed at higher than or equal to 600 °C and lower than or equal to 850 °C in an oxygen-containing atmosphere or a nitrogen-containing atmosphere, the electrode density of the positive electrode active material composite 100α can be increased.

Through the above steps, the positive electrode active material composite 100α of one embodiment of the present invention can be formed (Step S105).

Note that in order to form a favorable coating state in the composite formation process, the ratio of the particle diameter of the second positive electrode active material 100y to the particle diameter of the first positive electrode active material 100x (the particle diameter of the second positive electrode active material 100y/the particle diameter of the first positive electrode active material 100x) is preferably greater than or equal to 1/50 and less than or equal to ½, further preferably greater than or equal to 1/20 and less than or equal to ⅕.

### [Fluorination Treatment]

Fluorination treatment may be performed on each of the prepared positive electrode active materials. The concentration of fluorine on the surface of each of the positive electrode active materials can be increased. The positive electrode active material with a high fluorine concentration can inhibit dissolution of the additive element X and/or a transition metal from the positive electrode active material.

Examples of the fluorination treatment include a method in which a positive electrode active material is made to directly react with a fluorine gas or a mixed gas of a fluorine gas and an inert gas. For example, the positive electrode active material to be processed is left in a fluorine gas or a mixed gas for a certain period of time. Alternatively, plasma treatment using a fluorine gas or a mixed gas is performed on the positive electrode active material to be processed. As a result, a positive electrode active material having a surface where fluorine is present can be obtained. The fluorination treatment may be performed using hydrofluoric acid or the like. By the fluorination treatment, part of oxygen of magnesium oxide that can be present in the surface portion 100xa is substituted by fluorine in some cases. That is, part of oxygen in the oxide containing the additive element X that is present in the surface portion 100xa is substituted by fluorine in some cases. Fluorine has high electronegativity and thus can be substituted for part of oxygen. Furthermore, in the case where an oxide containing the additive element X has an oxygen vacancy or the like, fluorine may be bonded to the vacancy. The above-described fluorine is preferably present at least on the outermost surface of the positive electrode active material. Since the outermost surface is a region in contact with the electrolyte, the outermost surface generally deteriorates first; however, the presence of fluorine can inhibit the deterioration. That is, the fluorination treatment can improve the resistance to an electrolyte. Thus, a highly safe secondary battery that is less likely to ignite in a nail penetration test can be provided.

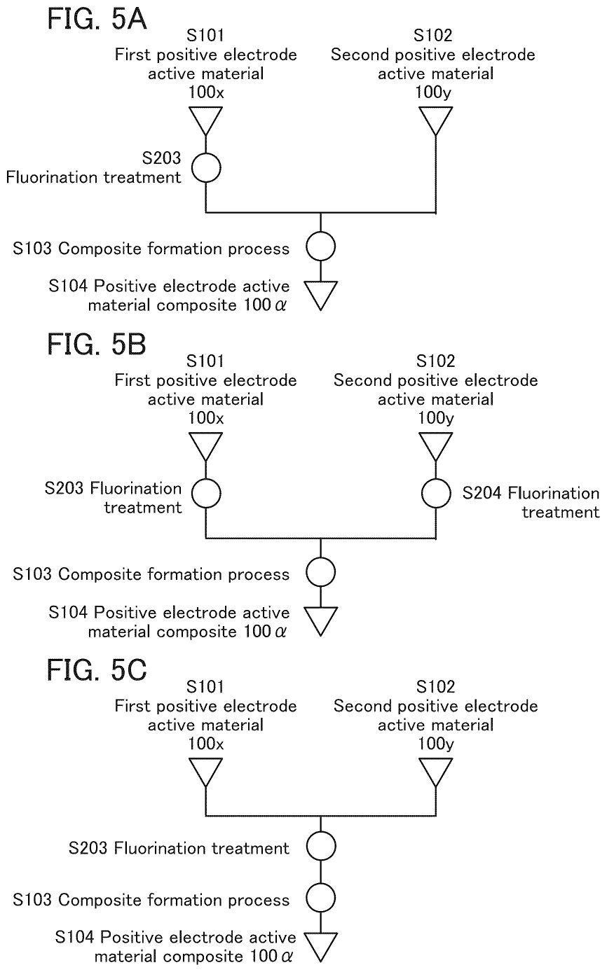

In a formation method illustrated in FIG. 5A, the steps up to Step S102 are the same as those in the formation method illustrated in FIG. 4A, and the above-described fluorination treatment is performed in Step S203 after Step S101. After that, Step S103 is performed, which is the same as that in the formation method illustrated in FIG. 4A.

Through the above steps, the positive electrode active material composite 100 of one embodiment of the present invention can be formed (Step S104).

In a formation method illustrated in FIG. 5B, the steps up to Step S203 are the same as those in the formation method illustrated in FIG. 5A, and the above-described fluorination treatment is performed in Step S204 after Step S102. After that, Step S103 is performed, which is the same as that in the formation method illustrated in FIG. 4A.

Through the above steps, the positive electrode active material composite 100x of one embodiment of the present invention can be formed (Step S104).

In the formation method illustrated in FIG. 5C, the steps up to Step S102 are the same as those in the formation method illustrated in FIG. 4A, and in Step S203, the above-described fluorination treatment is performed on a state where the first positive electrode active material 100x and the second positive electrode active material 100y are mixed. After that, Step S103 is performed, which is the same as that in the formation method illustrated in FIG. 4A.

Through the above steps, the positive electrode active material composite 100x of one embodiment of the present invention can be formed (Step S104).

Although the method using the first positive electrode active material 100x and the second positive electrode active material 100y is described with reference to FIG. 4 and FIG. 5, the same procedure can be performed for addition of the third positive electrode active material 100z.

This embodiment can be implemented in appropriate combination with any of the other embodiments.

### Embodiment 2

In this embodiment, a nail penetration test device will be described. The nail penetration test is a type of safety testing for secondary batteries, and in the nail penetration test, a nail having a predetermined diameter within the range of 2 mm to 10 mm penetrates a secondary battery in a fully charged state at a predetermined speed.

### <Nail Penetration Test Device>

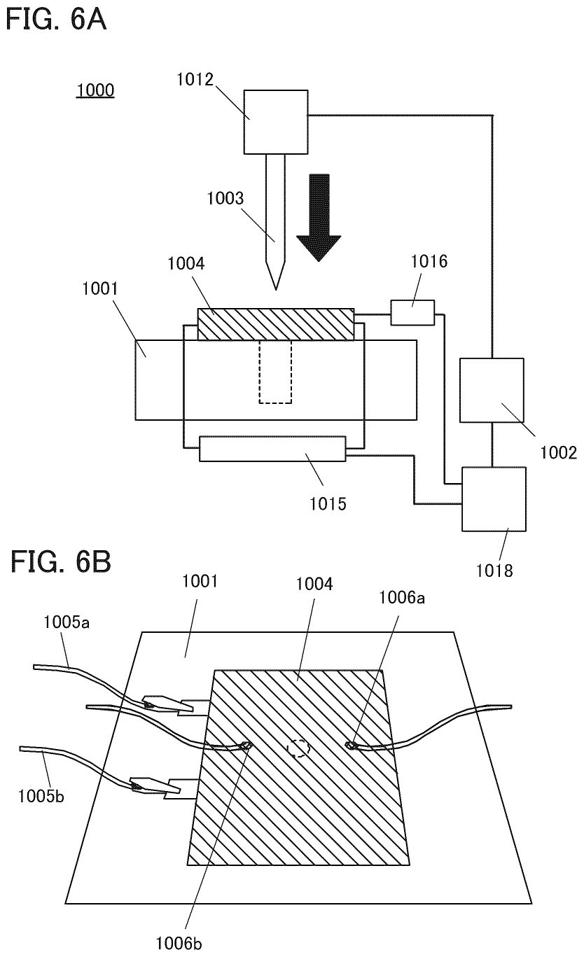

A nail penetration test device is described first. FIG. 6A is a side view of a nail penetration test device 1000 and FIG. 6B is a perspective view of a stage of the nail penetration test device 1000. The nail penetration test device 1000 illustrated in FIG. 6A includes a stage 1001, a driving portion 1002, a nail 1003, a voltage measuring device 1015, a temperature measuring device 1016, and a control portion 1018. The driving portion 1002 includes a driving mechanism 1012 for moving the nail 1003 in the arrow direction indicated in the diagram. The driving mechanism 1012 is operative to make the nail 1003 pass through a secondary battery 1004 placed over the stage 1001. Here, the secondary battery 1004 is in a fully charged state (the state of charge (SOC) equals 100%). This operation is referred to as nail penetration operation. The dashed line in FIG. 6A shows a depression of the stage 1001 for holding the nail 1003 that has passed through the secondary battery in the nail penetration operation.

Data on the voltage of the secondary battery during the nail penetration operation is transmitted from the voltage measuring device 1015 to the control portion 1018. Specifically, the amount of change in voltage or the like is transmitted to the control portion 1018. Data on the temperature during the nail penetration operation is transmitted from the temperature measuring device 1016 to the control portion 1018. To control operation conditions of the nail 1003, the control portion 1018 can transmit a control signal to the driving portion 1002.

FIG. 6B is a perspective view illustrating the upper side of the stage 1001 of the nail penetration test device 1000 and the vicinity of the upper side. The secondary battery 1004 placed over the stage 1001 is electrically connected to a wiring 1005a and a wiring 1005b. The wiring 1005a and the wiring 1005b, which belong to the voltage measuring device 1015, are electrically connected to a positive electrode side tab and a negative electrode side tab of the secondary battery 1004, so that the voltage of the secondary battery 1004 can be measured. The voltage of the secondary battery 1004 is simply referred to as a voltage, or is referred to as a voltage value between positive and negative electrodes, a battery voltage, a cell voltage, or an open-circuit voltage. In the case where a temperature sensor is used as the temperature measuring device 1016, the temperature sensor is provided to be in contact with a surface of an exterior body of the secondary battery 1004.

In the example illustrated in FIG. 6B, a first temperature sensor 1006a and a second temperature sensor 1006b are provided; alternatively, one temperature sensor or three or more temperature sensors may be provided. In FIG. 6B, the first temperature sensor 1006a is provided on a side where the wiring 1005a and the wiring 1005b are not disposed, and the second temperature sensor 1006b is provided on the side where the wiring 1005a and the wiring 1005b are disposed. It is preferable to provide two or more temperature sensors because in the case where one temperature sensor cannot be used owing to expansion of the exterior body or the like, another of the temperature sensors can be used.

The side where the wiring 1005a and the wiring 1005b are disposed has a welded region, whereas the side where the wiring 1005a and the wiring 1005b are not disposed does not have the above welded region because the exterior body is bent at this side. This structure is preferable because it would inhibit expansion at the side where the wiring 1005a and the wiring 1005b are not disposed if the exterior body expands, making the first temperature sensor 1006a less likely to be peeled off than the second temperature sensor 1006b.

The dashed line ellipse in FIG. 6B shows the region in which the nail 1003 passes through the secondary battery 1004 in the nail penetration operation. It is preferable that the first temperature sensor 1006a and the second temperature sensor 1006b be provided in the regions that are equidistant from the region in which the nail 1003 passes through the secondary battery. Typically, the first temperature sensor 1006a and the second temperature sensor 1006b are provided preferably less than or equal to 5 cm away from the region in which the nail 1003 passes through the secondary battery, further preferably less than or equal to 2 cm away from the region. In that case, preferably, it is possible to monitor a temperature change in the vicinity of the region in which the nail 1003 passes through the secondary battery. In the case where two or more temperature sensors are provided, the nail penetration operation is preferably started after it is confirmed that the difference between the temperatures indicated by the temperature sensors is less than or equal to ±5 °C, preferably less than or equal to ±2 °C.

### <Secondary Battery in Nail Penetration Test>

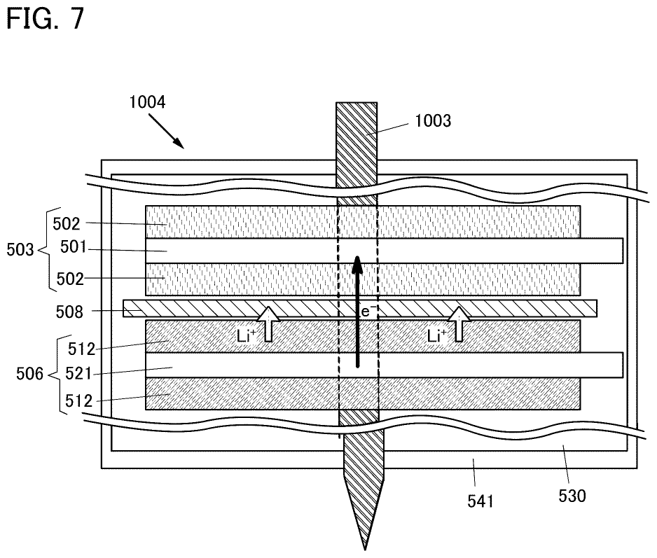

Next, the state of the secondary battery in the nail penetration test is specifically described with reference to FIG. 7 and the like. In the nail penetration test, the nail 1003 having a predetermined diameter in the range of 2 mm to 10 mm penetrates the secondary battery 1004 in a fully charged state at a predetermined speed. FIG. 7 is a cross-sectional view illustrating the state where the nail 1003 penetrates the secondary battery 1004. The secondary battery 1004 has a structure in which a positive electrode 503, a separator 508, a negative electrode 506, and an electrolyte solution 530 are held in an exterior body 541. The positive electrode 503 includes a positive electrode current collector 501 and positive electrode active material layers 502 formed over both surfaces of the positive electrode current collector 501. The structure described in the above embodiment is preferably employed for the positive electrode active material layers. The negative electrode 506 includes a negative electrode current collector 521 and negative electrode active material layers 512 formed on both surfaces of the negative electrode current collector 521.

As illustrated in FIG. 7, when the nail 1003 penetrates the secondary battery 1004, or specifically, when the nail 1003 passes through the positive electrode 503 and the negative electrode 506, an internal short circuit occurs. This makes the potential of the nail 1003 equal to that of the negative electrode 506, so that an electron (e⁻) flows to the positive electrode 503 through the nail 1003 and the like as indicated by the black arrows and Joule heat is generated in the portion where the internal short circuit has occurred and the vicinity of the portion. The internal short circuit causes carrier ions, typically lithium ions (Li⁺), to be extracted from the negative electrode 506 and to be released into the electrolyte solution as indicated by the white arrows. Note that before all the lithium ions are released from the negative electrode, reductive decomposition of the electrolyte solution starts on the negative electrode surface owing to a rapid increase in the battery temperature by the Joule heat generated by the internal short circuit. This is one of electrochemical reactions and is referred to as a reduction reaction of an electrolyte solution by a negative electrode.

In the case where the Joule heat increases the temperature of the secondary battery 1004 and the positive electrode active material is lithium cobalt oxide, the lithium cobalt oxide sometimes undergoes a phase change (i.e., a structural change) to an H1-3 type structure or an O1 type structure to further generate heat. The H1-3 type structure and the O1 type structure will be described later.

Then, the electron (e⁻) that has flowed to the positive electrode 503 reduces Co, which is tetravalent in the lithium cobalt oxide in the charged state, to trivalent or divalent Co. This reduction reaction causes oxygen release from the lithium cobalt oxide, and an oxidation reaction due to the oxygen decomposes the electrolyte solution 530. This is one of electrochemical reactions and is referred to as an oxidation reaction of an electrolyte solution by a positive electrode. The speed at which a current flows into the first positive electrode active material 100x or the like slightly varies depending on the insulating property of the positive electrode active material, and it is presumable that the speed at which a current flows affects the above electrochemical reaction.

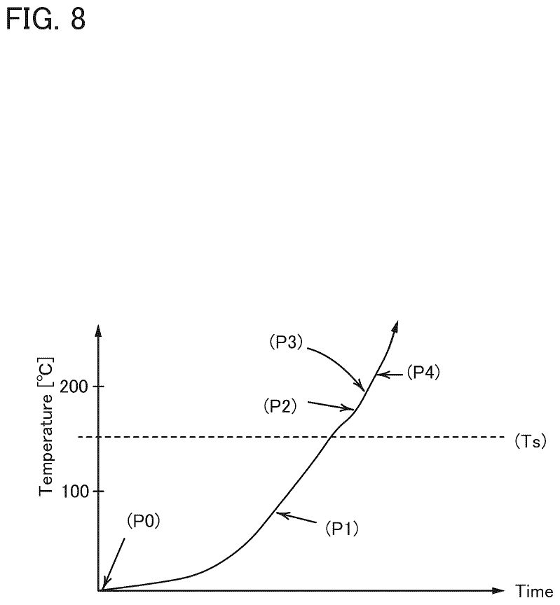

When an internal short circuit of a secondary battery occurs as described above, the temperature is presumed to change as shown in the graph of FIG. 8. FIG. 8 is the graph cited from [FIG. 2-12] on p. 70 of Non-Patent Document 13, which is partly retouched. This graph shows the temperature (specifically, the internal temperature) of a secondary battery as a function of time. Upon an internal short circuit at (P0), the temperature of the secondary battery increases over time. When the temperature of the secondary battery increases to reach approximately 100 °C as indicated by (P1) owing to heat generation due to Joule heat by the internal short circuit, the temperature sometimes further increases to exceed the threshold temperature for thermal runaway of the secondary battery, the reference temperature (Ts). Then, reduction of an electrolyte solution by a negative electrode (the negative electrode is C₆Li when graphite is used) and heat generation of the electrolyte solution are caused at (P2), oxidation of the electrolyte solution by a positive electrode and heat generation of the electrolyte solution are caused at (P3), and heat generation due to thermal decomposition of the electrolyte solution is caused at (P4). Accordingly, the secondary battery enters thermal runaway, resulting in ignition, fuming, or the like.

In a positive electrode active material at this time, a reaction occurs in which electrons rapidly flowing into the positive electrode active material reduce cobalt Co⁴⁺ to Co²⁺ and oxygen is released from the positive electrode active material. This reaction, which is an exothermic reaction, accelerates thermal runaway. In other words, inhibiting this reaction enables a safe secondary battery that does not easily undergo thermal runaway.

To inhibit the above reaction, for example, it is preferable that a surface portion of the positive electrode active material contain an additive element X inhibiting release of oxygen and the concentration of the additive element X be higher in the surface portion than in an inner portion. When no oxygen is released from the positive electrode active material, the above reduction reaction (e.g., the reaction in which Co⁴⁺ becomes Co²⁺) is inhibited. Examples of the additive element X inhibiting release of oxygen include magnesium and aluminum. Magnesium is suitable as the additive element X inhibiting release of oxygen because oxygen closer to magnesium requires higher energy for release. Nickel is also presumed to have an effect of inhibiting release of oxygen when present at a lithium site.

Even when cobalt or the like is reduced, insertion of lithium ions into the positive electrode active material before oxygen release would maintain electrical neutrality and thus prevent oxygen release. It can be thus said that regardless of whether electrons rapidly flow into the positive electrode active material, the crystal structure of the positive electrode active material should at least remain stable until insertion of lithium ions into the positive electrode active material from the negative electrode through the electrolyte solution is completed.

To prevent fuming, heat generation, and the like in the nail penetration test, it is probably preferable that an increase in the temperature of the secondary battery be inhibited and the negative electrode, the positive electrode, and/or the electrolyte solution have stable characteristics at high temperatures. Specifically, it is preferable that the first positive electrode active material 100x have a stable structure from which no oxygen is released, or specifically, no oxygen is released even at high temperatures. Alternatively, the first positive electrode active material 100x preferably has a structure such that a current flows to the positive electrode active material at a low speed. In that case, a significant effect that thermal runaway is less likely to occur and thus ignition or the like is less likely to occur can be obtained. As described later, the first positive electrode active material 100x of one embodiment of the present invention can have both the above stable structure and the structure such that a current flows at a low speed.

### <Thermal Runaway of Secondary Battery>

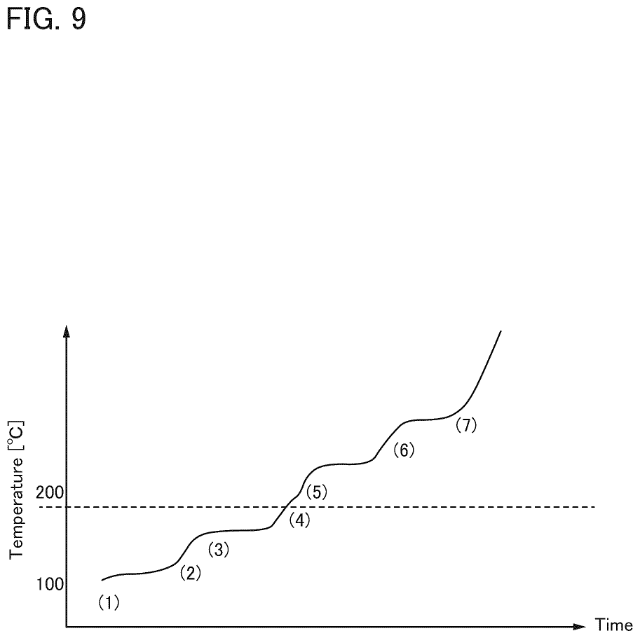

The mechanism of thermal runaway of a secondary battery is described with reference to FIG. 9 showing a graph cited from [FIG. 2-11] on p. 69 of Non-Patent Document 13, which is partly retouched. A secondary battery as described above enters thermal runaway after going through some states when the temperature (specifically, the internal temperature) increases during charging, for example. FIG. 9 is a graph showing the temperature of a secondary battery as a function of time. When the temperature of the secondary battery reaches 100 °C or the vicinity thereof, for example, (1) collapse of a solid electrolyte interphase (SEI) of a negative electrode and heat generation are caused. When the temperature of the secondary battery exceeds 100 °C, (2) reduction of an electrolyte solution by the negative electrode (the negative electrode is C₆Li when graphite is used) and heat generation of the electrolyte solution are caused. At 150 °C and the vicinity thereof, (3) oxidation of the electrolyte solution by a positive electrode and heat generation of the electrolyte solution are caused. When the temperature of the secondary battery reaches 180 °C or the vicinity thereof, (4) thermal decomposition of the electrolyte solution is caused and (5) oxygen release from the positive electrode and thermal decomposition of the positive electrode (the thermal decomposition includes a structural change of a positive electrode active material) are caused. Subsequently, when the temperature of the secondary battery exceeds 200 °C, (6) decomposition of the negative electrode is caused, and finally, (7) the positive electrode and the negative electrode come into direct contact with each other. The secondary battery enters thermal runaway after going through such states, specifically the state (5), the state (6), or the state (7).

To prevent thermal runaway, it is probably preferable that an increase in the temperature of the secondary battery be inhibited and the negative electrode, the positive electrode, and/or the electrolyte solution have stable characteristics at high temperatures.

### <Feature of Secondary Battery in Nail Penetration Test>

The features of the secondary battery in the nail penetration test performed on the secondary battery including the second electrode including the positive electrode active material composite described in Embodiment 1 or the like are described.

An increase in the temperature of the secondary battery when the nail penetration test is conducted, i.e., the difference between the temperature before the nail penetration test and the maximum temperature reached after the nail penetration (also referred to as temperature rise ΔT), is preferably less than or equal to 130 °C, further preferably less than or equal to 100 °C, further preferably less than or equal to 70 °C, still further preferably less than or equal to 50 °C. The temperature is a temperature at a position less than or equal to 5 cm away from the nail hole, preferably less than or equal to 2 cm away from the nail hole, and is specifically a value output with the use of the temperature sensor disposed less than or equal to 5 cm away from the nail hole, preferably less than or equal to 2 cm away from the nail hole. The temperature sensor is preferably provided to be in contact with the exterior body of the secondary battery.

The maximum temperature at the time of the nail penetration test is preferably lower than or equal to 250 °C, further preferably lower than or equal to 200 °C, still further preferably lower than or equal to 180 °C. Further preferably, the maximum temperature is lower than the temperature at which oxygen release from the positive electrode and thermal decomposition of the positive electrode are caused.

The maximum temperature at the time of the nail penetration test is preferably lower than or equal to 150 °C, further preferably lower than or equal to 100 °C, still further preferably lower than or equal to 80 °C. Further preferably, the maximum temperature is lower than the temperature at which oxidation of the electrolyte solution by the positive electrode is caused. Further preferably, the maximum temperature is lower than the flash point of a mixed solvent used in the electrolyte solution. In the case where the flash point of the mixed solvent is unknown, the flash points of the solvents contained in the mixed solvent can be referred to. Further preferably, the maximum temperature is lower than the softening point of the separator. For example, the softening point of polypropylene that can be used as the separator is approximately 155 °C.

This embodiment can be implemented in appropriate combination with any of the other embodiments.

### Embodiment 3

In this embodiment, the first positive electrode active material 100x is described.

### <Element Contained>

The first positive electrode active material 100x contains lithium, a transition metal M1, oxygen, and an additive element X. The first positive electrode active material 100x can be regarded as a composite oxide represented by LiM1O₂ to which a plurality of additive elements X are added. Note that the positive electrode active material of one embodiment of the present invention preferably has a crystal structure of a lithium composite oxide represented by LiM1O₂, and the composition is not strictly limited to Li:M1:O=1:1:2.

As the transition metal M1 contained in the first positive electrode active material 100x, a metal that can form, together with lithium, a composite oxide having the layered rock-salt structure belonging to the space group R-3m is preferably used. For example, at least one of manganese, cobalt, and nickel can be used. That is, as the transition metal contained in the first positive electrode active material 100x, only cobalt may be used, only nickel may be used, two metals of cobalt and manganese may be used or two metals of cobalt and nickel may be used, or three metals of cobalt, manganese, and nickel may be used. In other words, the first positive electrode active material 100x can contain a composite oxide containing lithium and the transition metal M1, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Specifically, using cobalt at greater than or equal to 75 at %, preferably greater than or equal to 90 at %, further preferably greater than or equal to 95 at % as the transition metal M1 contained in the first positive electrode active material 100x brings many advantages such as relatively easy synthesis, easy handling, and excellent cycle performance.

Using nickel at greater than or equal to 33 at %, preferably greater than or equal to 60 at %, further preferably greater than or equal to 80 at % as the transition metal M1 contained in the first positive electrode active material 100x is preferable, in which case the cost of materials is lower than that in the case of using a large amount of cobalt and discharge capacity per weight is increased in some cases.

Moreover, when nickel is partly contained as the transition metal M1 together with cobalt, a shift in a layered structure formed of octahedrons of cobalt and oxygen is sometimes inhibited. The inhibition of the shift enables higher stability of the crystal structure particularly in a high-temperature charged state in some cases, which is preferable. This is presumably because nickel is easily diffused into the inner portion of lithium cobalt oxide and is present in a cobalt site at the time of discharging but can be positioned in a lithium site owing to cation mixing at the time of charging. Nickel in the lithium site at the time of charging functions as a pillar supporting the layered structure formed of octahedrons of cobalt and oxygen and presumably contributes to stabilization of the crystal structure.

Note that manganese is not necessarily contained as the transition metal M1. In addition, nickel is not necessarily contained. Furthermore, cobalt is not necessarily contained.

As the additive elements X, at least one of magnesium, fluorine, aluminum, titanium, zirconium, yttrium, vanadium, iron, chromium, niobium, lanthanum, hafnium, zinc, silicon, sulfur, phosphorus, boron, and arsenic is preferably used. In particular, using phosphorus as the additive element X is preferable because the continuous charge tolerance can be improved and thus a highly safe secondary battery can be provided.

Manganese, titanium, vanadium, and chromium are materials each of which is likely to be tetravalent stably and thus can further contribute to structure stability in some cases when used as the transition metal M1 of the first positive electrode active material 100x.

These additive elements X further stabilize the crystal structure included in the first positive electrode active material 100x in some cases. That is, the first positive electrode active material 100x can contain lithium cobalt oxide to which magnesium and fluorine are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the additive elements X may be rephrased as mixtures, some of materials, impurities, or the like.

The additive element X in the first positive electrode active material 100x is preferably added at a concentration that does not largely change the crystallinity of the composite oxide represented by LiM1O₂. For example, the additive element X is preferably added at an amount with which the Jahn-Teller effect is not exhibited.

Note that as the additive elements X, magnesium, fluorine, aluminum, titanium, zirconium, yttrium, vanadium, iron, chromium, niobium, lanthanum, hafnium, zinc, silicon, sulfur, phosphorus, or boron may not be necessarily contained.

### <Inner Portion 100Xb>

The inner portion 100xb contains lithium, a transition metal M, and oxygen. It can be said that the inner portion 100xb includes composite oxide containing lithium and a transition metal. The inner portion 100xb can contain lithium cobalt oxide to which magnesium and fluorine are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like.

The inner portion 100xb preferably includes a layered rock-salt crystal structure. The layered rock-salt crystal structure is preferable for the inner portion 100xb because lithium is likely to be diffused two-dimensionally. The inner portion 100xb preferably has a layered rock-salt crystal structure, in which case the additive element X, typically magnesium, easily segregates to the surface portion 100xa. However, the entire inner portion 100xb does not necessarily have a layered rock-salt crystal structure. For example, part of the inner portion 100xb may include crystal defects, may be amorphous, or may have another crystal structure. The inner portion 100xb is referred to as a first region in some cases.

### <Surface Portion 100Xa>

The surface portion 100xa contains at least the additive element X. For example, in the case where the surface portion 100xa contains magnesium as the additive element X, the surface portion 100xa may contain magnesium oxide having a rock-salt crystal structure. Fluorine may be substituted for part of oxygen in magnesium oxide. Magnesium oxide contained in the surface portion 100xa is an electrochemically stable material that is less likely to deteriorate even when charge and discharge are repeated; thus, magnesium oxide is suitable for a coating layer.

When the thickness of the surface portion 100xa is too small, the function as a coating layer is degraded; in contrast, a too large thickness causes a decrease in capacity. Thus, the thickness of the surface portion 100xa is preferably greater than or equal to 0.5 nm and less than or equal to 50 nm, further preferably greater than or equal to 0.5 nm and less than or equal to 3 nm. The thickness of the surface portion 100xa can be measured using one cross section of the positive electrode active material.

The surface portion 100xa preferably has a rock-salt crystal structure, in which case orientations of crystals are likely to be aligned with those of the inner portion 100xb and the surface portion xa is likely to function as a stable coating layer. Note that the entire surface portion 100xa does not necessarily have a rock-salt crystal structure. For example, part of the surface portion 100xa may be amorphous or have another crystal structure.

Anions of a layered rock-salt crystal and anions of a rock-salt crystal form a cubic close-packed structure (face-centered cubic lattice structure). When these crystals are in contact with each other, there is a crystal plane at which orientations of cubic close-packed structures composed of anions are aligned. Note that a space group of the layered rock-salt crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal is different from that in the rock-salt crystal. In this specification, a state where the orientations of the cubic close-packed structures composed of anions in the layered rock-salt crystal and the rock-salt crystal are aligned with each other is referred to as a state where crystal orientations are substantially aligned with each other in some cases.

Substantial alignment of the crystal orientations in two regions can be determined from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, or the like. X-ray diffraction (XRD), electron diffraction, neutron diffraction, and the like can also be used for determination. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in the TEM image and the like, a light element such as oxygen or fluorine cannot be clearly observed in some cases; however, in such a case, alignment of orientations can be determined with arrangement of metal elements.

However, in the surface portion 100xa where only MgO is contained or MgO and CoO(II) form a solid solution, it is difficult to insert and extract lithium. Thus, the surface portion 100xa should include at least cobalt, and also include lithium in a discharged state to have the path through which lithium is inserted and extracted. The cobalt concentration is preferably higher than the magnesium concentration.

In general, when charging and discharging are repeated, a side reaction occurs in a positive electrode active material, for example, a transition metal such as manganese or cobalt is dissolved in an electrolyte solution, oxygen is released, the additive element X is dissolved, and/or the crystal structure becomes unstable, so that the positive electrode active material deteriorates. However, the first positive electrode active material 100x of one embodiment of the present invention includes the surface portion 100xa; thus, the crystal structure of the composite oxide of lithium and the transition metal contained in the inner portion 100xb can be more stable.

The surface portion 100xa of the first positive electrode active material 100x has a reinforcing function of preventing breakage of the CoO₂ layer structure in the inner portion 100xb. In particular, when lithium ions are extracted from the first positive electrode active material 100x by charging, the surface portion 100xa has a reinforcement function so that the structure of the CoO₂ layer in the inner portion 100xb is not broken. The surface portion 100xa is referred to as a barrier film of the first positive electrode active material 100x. Note that the above-described reinforcement includes inhibiting release of oxygen from the first positive electrode active material 100x. The above-described reinforcement includes inhibiting a shift in the structure of the CoO₂ layer. The above-described reinforcement includes inhibition of a structural change in the surface portion 100xa and the inner portion 100xb. The above-described reinforcement means inhibition of decomposition of an electrolyte on the surface of the first positive electrode active material 100x.

The surface portion 100xa is one of regions that tend to become unstable by charging and discharging and easily trigger deterioration of the crystal structure. Thus, the surface portion 100xa preferably has a composition and a crystal structure that are more stable at room temperature than those of the inner portion 100xb. For example, at least part of the surface portion 100xa preferably has a rock-salt crystal structure. Alternatively, the surface portion 100xa preferably has both a layered rock-salt crystal structure and a rock-salt crystal structure. As described above, when the surface portion 100xa has a crystal structure different from that of the inner portion 100xb, the above-described reinforcement effect can be significantly exhibited. Needless to say, the surface portion 100xa may have the same crystal structure as the inner portion 100xb as long as the above-described reinforcement effect is exhibited.

The surface portion 100xa contains the additive element X and preferably further contains the same transition metal as the inner portion 100xb does. When the surface portion 100xa and the inner portion 100xb contain the same transition metal, the valence of the transition metal is preferably different between these two regions. Specifically, it is preferable that, in the transition metal contained in the inner portion 100xb, the number of trivalent atoms be larger than the number of atoms exhibiting other valences, and in the transition metal contained in the surface portion 100xa, the number of divalent atoms be larger than the number of atoms exhibiting other valences.

When the surface portion 100xa contains a large amount of a divalent transition metal, typically, divalent cobalt, it contains much metal oxide having atomic ratio of transition metal:oxygen=1:1, such as CoO(II), MnO(II), and Ni(II). The metal oxide can form a stable solid solution with magnesium oxide, which is also divalent metal oxide. Thus, the surface portion 100xa can be a coating layer which is more stable and favorable.

### <Distribution of Additive Element X>

It is preferable that the additive element X in the first positive electrode active material 100x be appropriately distributed. In this specification and the like, the distribution of an element indicates that the element is successively detected by a given analysis method to the extent that the detection value is no longer on the noise level. A continuous change in the concentration of the element is referred to as a concentration gradient in some cases. A local maximum value of the distribution is referred to as a peak in some cases. In addition, a peak can be specified from a distribution limited to a certain region. The above-described distribution is not limited to normal distributions. In the case where the distribution corresponds to a normal distribution, the half width of the distribution can also be determined.

As described above, the surface portion 100xa of the first positive electrode active material 100x preferably has a higher concentration of the additive element X than the inner portion 100xb and has a composition different from that of the inner portion 100xb. The surface portion 100xa having such a composition preferably has a crystal structure stable at room temperature (25 °C). Accordingly, the surface portion 100xa may have a crystal structure different from that of the inner portion 100xb. For example, as described above, at least part of the surface portion xa of the first positive electrode active material 100x may have a rock-salt crystal structure. When the surface portion 100xa and the inner portion 100xb have different crystal structures, the orientations of crystals in the surface portion 100xa and the inner portion 100xb are preferably substantially aligned with each other.

However, in the surface portion 100xa where only the additive element X and oxygen, e.g., MgO, are contained or MgO and CoO(II) form a solid solution, it is difficult to insert and extract lithium. Thus, the surface portion 100xa should contain at least the transition metal M1, also contain lithium in a discharged state, and have a path through which lithium is inserted and extracted. Moreover, the concentration of the transition metal M1 is preferably higher than the concentration of the additive element X.

Note that the first positive electrode active material 100x of one embodiment of the present invention is not limited thereto. The first positive electrode active material 100x may contain an additive element X having no concentration gradient.

When the additive element X is distributed in the above manner, deterioration of the first positive electrode active material 100x due to charging and discharging can be reduced. That is, deterioration of a secondary battery can be inhibited. A highly safe secondary battery can be provided.

### [Type of Additive Element X]

Magnesium can be used as the additive element X. A magnesium ion is divalent and is more stable in lithium sites than in transition metal sites in the layered rock-salt crystal structure; thus, the magnesium ion is likely to enter the lithium sites. An appropriate magnesium concentration in the lithium sites of the surface portion 100xa can facilitate the maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charging and discharging, and is thus preferable. However, excess magnesium might adversely affect insertion and extraction of lithium.

Aluminum can be used as the additive element X. An aluminum ion is trivalent and can be at a transition metal site in the layered rock-salt crystal structure. Aluminum can inhibit dissolution of surrounding cobalt. The bonding strength of aluminum with oxygen is high, thereby inhibiting extraction of oxygen around aluminum. Hence, aluminum contained as the additive element X enables the first positive electrode active material 100x to have the crystal structure that is unlikely to be broken by repeated charging and discharging.

Fluorine can be used as the additive element X. A fluorine ion is a monovalent anion, and when fluorine is substituted for part of oxygen in the surface portion 100xa, the lithium extraction energy is lowered. This is because the change in valence of cobalt ions associated with lithium extraction is a change from trivalent to tetravalent in the case of not containing fluorine and a change from divalent to trivalent in the case of containing fluorine, and the oxidation-reduction potential differs therebetween. It can thus be said that when fluorine is substituted for part of oxygen in the surface portion 100xa of the first positive electrode active material 100x, lithium ions near fluorine are likely to be extracted and inserted smoothly. Thus, using the first positive electrode active material 100x in a secondary battery is preferable because the charge and discharge characteristics, rate performance, and the like are improved.

A titanium oxide is known to have superhydrophilicity. Accordingly, the first positive electrode active material 100x that includes titanium oxide in the surface portion 100xa presumably has good wettability with respect to a high-polarity solvent. That is, titanium can be used as the additive element X. In a secondary battery, the first positive electrode active material 100x and a high-polarity electrolyte solution can have favorable contact at the interface therebetween, which may inhibit a resistance increase. In this specification and the like, an electrolyte solution may be rephrased as an electrolyte.

Phosphorus can be used as the additive element X. When phosphorus is used, phosphorus may react with hydrogen fluoride generated by the decomposition of the electrolyte solution, which may decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion of a current collector and/or separation of a coating film in some cases. Furthermore, the decrease in hydrogen fluoride concentration in the electrolyte solution can inhibit a reduction in adhesion properties due to gelling and/or insolubilization of PVDF in some cases.

In the case where the first positive electrode active material 100x has a crack, phosphorus, more specifically, a compound containing phosphorus and oxygen, contained in the inner portion may inhibit crack development, for example.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a capacity decrease due to repetitive charging and discharging.

A short circuit of a secondary battery might cause not only malfunction in charge operation and/or discharge operation of the secondary battery but also heat generation and firing. In order to obtain a safe secondary battery, a short-circuit current is preferably inhibited even at a high charge voltage. In the first positive electrode active material 100x of one embodiment of the present invention, a short-circuit current is inhibited even at high charge voltage. Thus, a secondary battery with both high capacity and safety can be obtained.

Preferably, a secondary battery using the first positive electrode active material 100x of one embodiment of the present invention simultaneously has high capacity, excellent charge and discharge cycle performance, and safety.

The gradient of the concentration of the additive element X can be evaluated using energy dispersive X-ray spectroscopy (EDX). EDX measurement for evaluating an area two-dimensionally while the area is being scanned is referred to as EDX area analysis in some cases. Furthermore, extracting data of a linear region from EDX area analysis and evaluating an atomic concentration distribution in a positive electrode active material particle is referred to as line analysis in some cases.

By EDX area analysis (e.g., elemental mapping), the concentrations of the additive element X in the surface portion 100xa, the inner portion 100xb, the vicinity of the crystal grain boundary, and the like of the second positive electrode active material 100y can be quantitatively analyzed. By EDX line analysis, the concentration peak of the additive element X can be analyzed.

When the first positive electrode active material 100x is analyzed with the EDX line analysis, a peak of the magnesium concentration in the surface portion 100xa is preferably present from the surface of the first positive electrode active material 100x to a depth of 3 nm, further preferably to a depth of 1 nm, still further preferably to a depth of 0.5 nm toward the center.

In addition, the distribution of fluorine contained in the first positive electrode active material 100x preferably overlaps with the distribution of magnesium. Furthermore, the fluorine peak is preferably positioned closer to the surface side of the first positive electrode active material 100x than the magnesium peak is. In the EDX line analysis, a peak of the fluorine concentration in the surface portion 100xa is preferably present from the surface of the first positive electrode active material 100x to a depth of 3 nm, further preferably to a depth of 1 nm, still further preferably to a depth of 0.5 nm toward the center

Note that the concentration distribution may differ between the additive elements X. For example, in the case where the first positive electrode active material 100x contains aluminum as the additive element X, the distribution of aluminum is preferably slightly different from that of magnesium and that of fluorine. For example, in an EDX line analysis, the peak of the magnesium concentration is preferably closer to the surface than the peak of the aluminum concentration is in the surface portion 100xa. For example, the peak of the aluminum concentration is preferably present at a depth that is greater than or equal to 0.5 nm and less than or equal to 20 nm, further preferably greater than or equal to 1 nm and less than or equal to 5 nm toward the center from the surface of the first positive electrode active material 100x.

When a line analysis or area analysis is performed on the first positive electrode active material 100x, the ratio (X/M1) between an additive element X and the transition metal M1 in the vicinity of the crystal grain boundary is preferably greater than or equal to 0.020 and less than or equal to 0.50. Furthermore, it is preferably greater than or equal to 0.025 and less than or equal to 0.30. Furthermore, it is preferably greater than or equal to 0.030 and less than or equal to 0.20. For example, when the additive element X is magnesium and the transition metal M1 is cobalt, the atomic ratio (Mg/Co) between magnesium and cobalt is preferably greater than or equal to 0.020 and less than or equal to 0.50. Furthermore, it is preferably greater than or equal to 0.025 and less than or equal to 0.30. Furthermore, it is preferably greater than or equal to 0.030 and less than or equal to 0.20.

In this specification and the like, uneven distribution means that the concentration of an element in a certain region differs from that in another region, and the element is present at a concentration higher than the concentration in another region. This is synonymous with unbalanced distribution. The state of forming a solid solution and being unevenly distributed is referred to as segregation.

### <<Grain Boundary>>

The additive element X contained in the first positive electrode active material 100x may be present at random and at a slight concentration in the inner portion, but part of the additive element X is further preferably segregated at a grain boundary.

In other words, the concentration of the element X in the crystal grain boundary and its vicinity of the first positive electrode active material 100x is preferably higher than that in the other regions in the inner portion.

Like the particle surface, the crystal grain boundary is also a planar defect. Thus, the crystal grain boundary tends to be unstable and its crystal structure easily starts to change. Therefore, when the concentration of the additive element X in the crystal grain boundary and its vicinity is higher, the change in the crystal structure can be inhibited more effectively.

In the case where the concentration of the additive element X is high in the crystal grain boundary and its vicinity, even when a crack is generated along the crystal grain boundary of the particle of the first positive electrode active material 100x, the concentration of the additive element X is increased in the vicinity of the surface generated by the crack. Thus, the positive electrode active material after generation of a crack can also have an increased corrosion resistance to hydrofluoric acid.

Note that in this specification and the like, the vicinity of the crystal grain boundary refers to a region from the grain boundary to approximately 10 nm.

### <Crystal Structure of Positive Electrode Active Material>

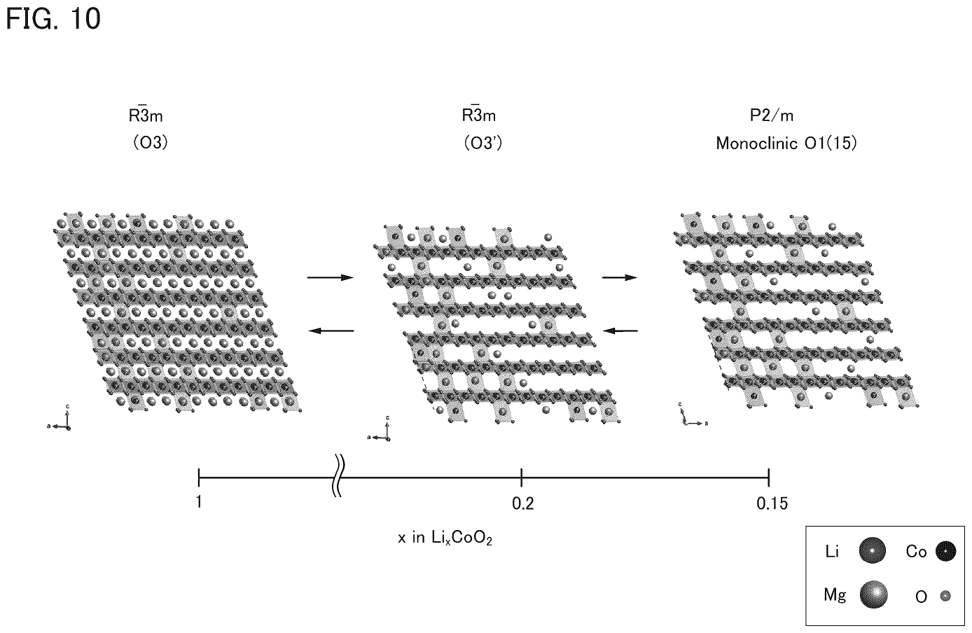

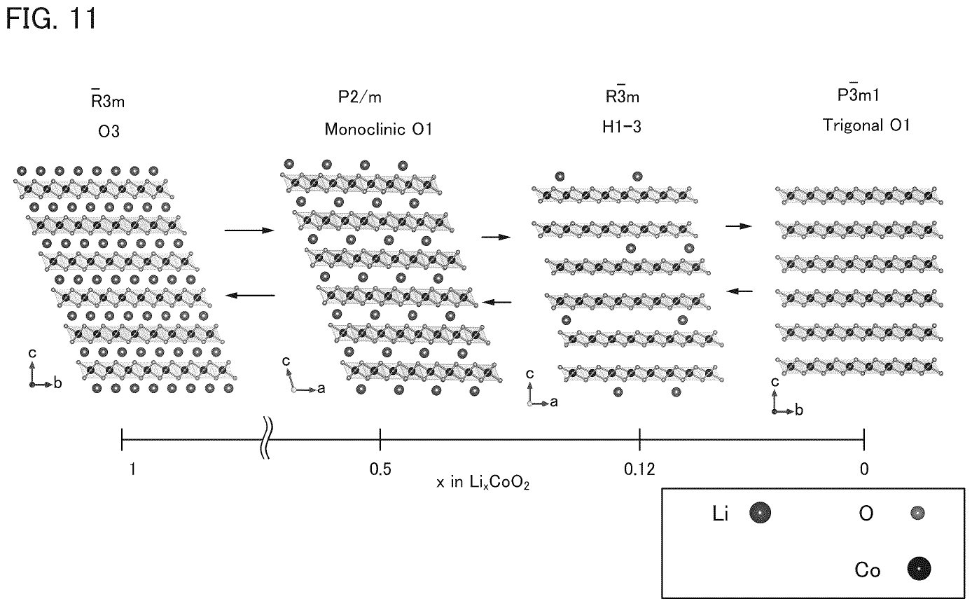

A material with the layered rock-salt crystal structure, such as lithium cobalt oxide (LiCoO₂), is known to have a high discharge capacity and excel as a positive electrode active material of a secondary battery. Crystal structures of lithium cobalt oxide in a discharged state and a charged state are described with reference to FIG. 10 and FIG. 11. FIG. 10 illustrates the first positive electrode active material 100x of one embodiment of the present invention, and FIG. 11 illustrates a conventional positive electrode active material. The conventional positive electrode active material is lithium cobalt oxide (LiCoO₂) containing no additive element. Although lithium ions are present in all of the lithium sites in illustration of FIG. 10 and FIG. 11, the additive element X, typically magnesium ions, may be positioned in one or some of the lithium sites in FIG. 10.

<<x in LiₓCoO₂ being 1>>

The horizontal axis in FIG. 10 and FIG. 11 represents x in LiₓCoO₂ (referred to as x in LiₓCoO₂), and a discharged state is the case where x in LiₓCoO₂ is 1. In the discharged state, lithium cobalt oxide has a layered rock-salt crystal structure belonging to the space group R-3m. In the crystal structure having a layered rock-salt crystal structure, lithium ions occupy octahedral sites and a unit cell includes three CoO₂ layers. Thus, the layered rock-salt crystal structure belonging to the space group R-3m is referred to as an O3 type crystal structure in some cases. Note that the CoO₂ layer refers to a structure in which an octahedral structure with cobalt coordinated to six oxygen atoms continues in a plane in an edge-shared state.

FIG. 10 and FIG. 11 each illustrate a crystal structure when x in LiₓCoO₂ in the discharged state is 1, and the crystal structure is represented by R-3m (O3) in the drawings. The crystal structure represented by R-3m (O3) is a unit cell with a lattice constant of a=2.81610×10⁻¹⁰ (m), b=2.81610×10⁻¹⁰ (m), c=14.05360×10⁻¹⁰ (m), α=90.0000, β=90.0000, and γ=120.0000. The coordinates of lithium, cobalt, and oxygen in the unit cell can be represented by Li (0,0,0), Co (0,0,0.5), and O (0,0,0.23951). That is, in the discharged state, the crystal structure of lithium cobalt oxide is the same regardless of the presence or absence of the additive element X.

<<State where x in LiₓMO₂ is Small>>

Next, a crystal structure in a charged state is described. Note that in a high-voltage charged state, x in LiₓCoO₂ satisfies 0.1<x≤0.24. A high voltage refers to 4.6 V or higher, preferably 4.8 V or higher with reference to a lithium counter electrode metal.

First, FIG. 11 illustrates a change in the crystal structure between a discharged state and a high-voltage charged state of the conventional positive electrode active material. Conventional lithium cobalt oxide with x in LiₓCoO₂ of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

Conventional lithium cobalt oxide with x=0 in LixCoO₂ is known to have the trigonal crystal structure belonging to the space group P-3 ml. This structure also includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x in LixCoO₂ being approximately 0.12 has a crystal structure belonging to the space group R-3m. This structure can also be regarded as a structure in which CoO₂ structures such as trigonal O1 type structures and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. Note that since insertion and extraction of lithium ions do not necessarily uniformly occur in the positive electrode active material in reality, lithium ions are unevenly distributed, that is, the lithium concentration varies; thus, the H1-3 type crystal structure is started to be observed when x is approximately 0.25 experimentally.

For the H1-3 type crystal structure, the coordinates of cobalt and oxygen in the unit cell can be expressed as Co (0,0,0.42150±0.00016), O1 (0,0,0.27671±0.00045), and O2 (0,0,0.11535±0.00045), for example.

A unit cell that should be used for representing a crystal structure in a positive electrode active material can be determined by Rietveld analysis of XRD patterns, for example. For example, a unit cell such that the value of GOF (goodness of fit) is close to 1 is preferably employed.

When charging that makes x in LiₓCoO₂ be 0.24 or less (typically, x is approximately 0.12) and discharging are repeated, the H1-3 type crystal structure and the R-3m (O3) type crystal structure are repeated in the conventional lithium cobalt oxide, and a change in the crystal structure between them, that is, an unbalanced phase change, is repeated. There is a large shift in the CoO₂ layers between these two crystal structures. Such a dynamic structural change can adversely affect the stability of the crystal structure.

A difference in volume between these two crystal structures is also large. The difference in volume per the same number of cobalt atoms between the R-3m (O3) type crystal structure and the H1-3 type crystal structure is greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charging that makes x be 0.24 or less and discharging are repeated in the conventional lithium cobalt oxide, the crystal structure of the conventional lithium cobalt oxide is gradually broken. In the broken crystal structure, the number of sites that lithium ions can stably occupy is reduced and thus insertion and desorption of lithium become difficult, leading to degradation of cycle performance.

On the other hand, in the first positive electrode active material 100x illustrated in FIG. 10, a change in the crystal structure between a discharged state with x=1 in LiₓCoO₂ and a state with x being 0.24 or less is smaller than that in the conventional lithium cobalt oxide. Specifically, a shift in the CoO₂ layers between the state with x being 1 and the state with x being 0.24 or less is small. The difference between the volume of the H1-3 type crystal structure and the volume of the R-3m (O3) type crystal structure per the same number of cobalt atoms can be small. Specifically, when the first positive electrode active material 100x and the conventional positive electrode active material that have the same number of atoms of the transition metal M1 are compared, the first positive electrode active material 100x changes in volume less than the conventional positive electrode active material. Thus, in the first positive electrode active material 100x, the crystal structure is unlikely to be broken and the sites that lithium ions can stably occupy are maintained even when charging that makes x be 0.24 or less and discharging are repeated; accordingly, excellent cycle performance can be achieved.

FIG. 10 illustrates crystal structures of the first positive electrode active material 100x when x in LiₓCoO₂ is approximately 0.2 and x in LiₓCoO₂ is approximately 0.15. Since the inner portion 100xb accounts for the majority of the volume of the first positive electrode active material 100x, the crystal structure illustrated in FIG. 10 can be regarded as the crystal structure in the inner portion 100xb of the first positive electrode active material 100x. Since the inner portion 100xb is a portion that greatly contributes to charging and discharging, it is preferable that a shift in the CoO₂ layers in the inner portion 100xb be small and the volume change of the inner portion 100xb be small.

However, as illustrated in FIG. 10, the first positive electrode active material 100x has a crystal structure different from the H1-3 type crystal structure of the conventional lithium cobalt oxide when x is less than or equal to 0.24, e.g., approximately 0.2 and approximately 0.15.

### <x Being Approximately 0.2>

The first positive electrode active material 100x with x being approximately 0.2 has a trigonal crystal structure belonging to the space group R-3m. The symmetry of the CoO₂ layers of this structure is the same as that of O3. Thus, this crystal structure is called an O3′ type crystal structure. Although this crystal structure is not a spinel structure, an XRD pattern similar to that of the spinel structure appears in some cases, and this crystal structure is referred to as a pseudo-spinel structure in some cases. In FIG. 10, this crystal structure is denoted by R-3m (O3′).

Note that in the unit cell of the O3′ type crystal structure where M is cobalt, the coordinates of cobalt and oxygen can be represented by Co (0,0,0.5) and O (0,0,x) within the range of 0.20≤x≤0.25. In the unit cell, the lattice constant of the a-axis is preferably 2.797×10⁻¹⁰≤α≤2.837×10⁻¹⁰ (m), further preferably 2.807× 10⁻¹⁰≤a≤2.827×10⁻¹⁰ (m), typically α=2.817×10⁻¹⁰ (m). The lattice constant of the c-axis is preferably 13.681× 10⁻¹⁰≤c≤13.881×10⁻¹⁰ (m), further preferably 13.751×10⁻¹⁰≤c≤13.811×10⁻¹⁰ (m), typically, c=13.781×10⁻¹⁰ (m).

### <x Being Approximately 0.15>

When x is approximately 0.15, the first positive electrode active material 100x has a monoclinic crystal structure belonging to the space group P2/m. In this structure, a unit cell includes one CoO₂ layer. The expression “x is approximately 0.15” may mean that lithium in the first positive electrode active material 100x is approximately 15 atomic % of that in a discharged state. Thus, this crystal structure is referred to as a monoclinic O1(15) type structure. In FIG. 10, this crystal structure is denoted by P2/m monoclinic O1(15).

In the unit cell of the monoclinic O1(15) type crystal structure, when M is cobalt, the coordinates of cobalt and oxygen can be represented by Co1 (0.5,0,0.5), Co2 (0,0.5,0.5), and O1 (X_{O1},0,Z_{O1}) where 0.23≤X_{O1}≤0.24 and 0.61≤Z_{O1}≤0.65, and O2 (X_{O2},0.5,Z_{O2}) where 0.75≤X_{O2}≤0.78 and 0.68≤Z_{O2}≤0.71. The unit cell has lattice constants of a=0.4880±0.005 nm, b=0.2817±0.005 nm, c=0.4839±0.005 nm, α=90°, β=109.6±0.1°, and γ=90°.

Note that this crystal structure can have the lattice constants even when belonging to the space group R-3m if a certain degree of error is allowed in Rietveld analysis or the like. In this case, the coordinates of cobalt and oxygen in the unit cell can be represented by Co (0,0,0.5) and O (0,0,Z_{O}) where 0.21≤Z_{O}≤0.23. In the unit cell, the lattice constants are a=0.2817±0.002 nm and c=1.368±0.01 nm.

In each of the O3′ type structure and the monoclinic O1(15) type structure, an ion of cobalt, nickel, magnesium, or the like occupies a site coordinated to six oxygen atoms. Note that a light element such as lithium or magnesium sometimes occupies a site coordinated to four oxygen atoms.

As denoted by the dotted lines in FIG. 10, the CoO₂ layers hardly shift between the R-3m (O3) type crystal structure in a discharged state and the O3′ type crystal structure. The CoO₂ layers hardly shift between the R-3m (O3) type crystal structure in a discharged state and the monoclinic O1(15) type crystal structure.

The R-3m (O3) type crystal structure in a discharged state and the O3′ type crystal structure which contain the same number of cobalt atoms have a difference in volume of 2.5% or less, specifically 2.2% or less, typically 1.8%.

The R-3m (O3) type crystal structure in a discharged state and the monoclinic O1(15) type crystal structure which contain the same number of cobalt atoms have a difference in volume of 3.3% or less, specifically 3.0% or less, typically 2.5%.

As described above, in the first positive electrode active material 100x of one embodiment of the present invention, a change in the crystal structure caused when x in LiₓCoO₂ is small, i.e., when a large amount of lithium is extracted, is smaller than that in a conventional positive electrode active material. In addition, a change in the volume of the case where the positive electrode active materials having the same number of cobalt atoms are compared is reduced. Thus, the crystal structure of the first positive electrode active material 100x is less likely to be broken even when charging that makes x be 0.24 or less and discharging are repeated, so that a decrease in charge and discharge capacity in a charge and discharge cycle test is inhibited. Furthermore, the first positive electrode active material 100x can stably use more lithium ions than a conventional positive electrode active material and thus enables high discharge capacity per weight and per volume. Thus, with use of the first positive electrode active material 100x, a secondary battery with high discharge capacity per weight and per volume can be manufactured.

Not all particles in the inner portion 100xb of the first positive electrode active material 100x necessarily have the O3′ type crystal structure and/or the monoclinic O1(15) type crystal structure. The positive electrode active material may include another crystal structure or may be partly amorphous.

In order to make x in LiₓCoO₂ small, charging at a high charge voltage is necessary in general. Thus, the state where x in LiₓCoO₂ is small can be rephrased as a state where charging at a high charge voltage has been performed. For example, when CC/CV charging is performed at a voltage of 4.6 V or higher with reference to the potential of a lithium metal in a 25 °C environment, the H1-3 type crystal structure appears in a conventional positive electrode active material. Thus, a charge voltage of higher than or equal to 4.6 V with reference to the potential of a lithium metal can be regarded as a high charge voltage.

Thus, in other words, the first positive electrode active material 100x of one embodiment of the present invention is preferable because the R-3m (O3) crystal structure can be maintained even when charging at a high charge voltage, e.g., a voltage higher than or equal to 4.6 V is performed at 25 °C. In other words, the first positive electrode active material 100x of one embodiment of the present invention is preferable because the monoclinic O1(15) type crystal structure can be obtained when charging at an even higher charge voltage, e.g., a voltage higher than or equal to 4.7 V and lower than or equal to 4.8 V is performed at 25 °C.

At a much higher charge voltage, the H1-3 type structure is eventually observed in the first positive electrode active material 100α of one embodiment of the present invention in some cases. That is, depending on charging and discharging conditions, the first positive electrode active material 100x may have the H1-3 type structure after having the O3′ type crystal structure in some cases; however, even when the first positive electrode active material 100x has the H1-3 type crystal structure after having the O3′ type crystal, it is presumed that an effect of inhibiting release of oxygen is exhibited.

As described above, the crystal structure is affected by the number of charge and discharge cycles, a charge current and a discharge current, temperature, an electrolyte, and the like, so that the first positive electrode active material 100x sometimes has the O3′ type crystal structure even at a lower charge voltage, e.g., a charge voltage higher than or equal to 4.5 V and lower than 4.6 V at 25 °C. Similarly, the first positive electrode active material 100x sometimes has the monoclinic O1(15) type crystal structure when charging is performed at a voltage higher than or equal to 4.65 V and lower than or equal to 4.7 V at 25 °C.

Note that in the case where graphite is used as a negative electrode active material in a secondary battery, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of the graphite.

A slight amount of the additive element X such as magnesium present at random between the CoO₂ layers, i.e., in lithium sites, can inhibit a shift in the CoO₂ layers. Thus, magnesium between the CoO₂ layers makes it easier to obtain the O3′ type crystal structure. Therefore, magnesium is preferably distributed throughout a particle of the first positive electrode active material 100x of one embodiment of the present invention. To distribute magnesium throughout the particle, heat treatment is preferably performed in the formation process of the first positive electrode active material 100x of one embodiment of the present invention.

However, cation mixing occurs when the heat treatment temperature is excessively high, so that the additive element X, e.g., magnesium, is highly likely to enter a cobalt site. Magnesium in the cobalt site does not have the effect of maintaining the structure belonging to R-3m in high-voltage charge. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium throughout the particle. The addition of the halogen compound decreases the melting point of lithium cobalt oxide. The decreased melting point makes it easier to distribute magnesium throughout the particle at a temperature at which the cation mixing is unlikely to occur. Furthermore, the presence of the fluorine compound is expected to increase corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably 0.001 times to 0.1 times, preferably larger than 0.01 times and less than 0.04 times, still further preferably approximately 0.02 times the number of cobalt atoms. The magnesium concentration described here may be a value obtained by element analysis on all particles of the positive electrode active material by ICP-MS or the like, or may be a value based on the ratio of the materials mixed in the process of forming the positive electrode active material, for example.

To lithium cobalt oxide, as an additive element X other than cobalt (an additive element), one or more metals selected from nickel, aluminum, manganese, titanium, vanadium, and chromium may be added, for example, and in particular, at least one of nickel and aluminum is preferably added. In some cases, manganese, titanium, vanadium, and chromium are likely to have a valence of four stably and thus contribute highly to structural stability. The addition of the metal Z may enable the positive electrode active material of one embodiment of the present invention to have a more stable crystal structure in a high voltage charged state, for example. Here, in the positive electrode active material of one embodiment of the present invention, the metal Z is preferably added at a concentration that does not greatly change the crystallinity of the lithium cobalt oxide. For example, the additive element is preferably added at an amount with which the aforementioned Jahn-Teller effect is not exhibited.

Aluminum and the transition metal typified by nickel and manganese are preferably present in cobalt sites, but part of them may be present in lithium sites. Magnesium is preferably present in lithium sites. Fluorine may be substituted for part of oxygen.

As the magnesium concentration increases, the capacity of the positive electrode active material decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel as the additive element X in addition to magnesium, the capacity per weight and per volume can be increased in some cases. When the positive electrode active material of one embodiment of the present invention contains aluminum as the additive element X in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentration of the additive element X or the like contained in the positive electrode active material of one embodiment of the present invention is described below using the number of atoms.

The number of nickel atoms in the positive electrode active material of one embodiment of the present invention is preferably less than or equal to 10%, further preferably less than or equal to 7.5%, and still further preferably greater than or equal to 0.05% and less than or equal to 4%, and particularly preferably greater than or equal to 0.1% and less than or equal to 2% of the number of cobalt atoms. The nickel concentration described here may be a value obtained by performing element analysis on all particles of the positive electrode active material using ICP-MS or the like, or may be a value based on the ratio of the materials mixed in the process of forming the positive electrode active material, for example.

When a high-voltage charged state is held for a long time, the transition metal dissolves into an electrolyte solution from the positive electrode active material, and the crystal structure might be broken. However, when nickel is included at the above-described proportion, dissolution of the transition metal from the first positive electrode active material 100x can be inhibited in some cases.

The number of aluminum atoms in the positive electrode active material of one embodiment of the present invention is preferably greater than or equal to 0.05% and less than or equal to 4%, and further preferably greater than or equal to 0.1% and less than or equal to 2% of the number of cobalt atoms. The aluminum concentration described here may be a value obtained by element analysis on all particles of the positive electrode active material using ICP-MS or the like, or may be a value based on the ratio of the materials mixed in the process of forming the positive electrode active material, for example.

### <Analysis Method>

Whether or not a given positive electrode active material is the first positive electrode active material 100x, which has the O3′ type crystal structure at the time of high voltage charging, can be determined by analyzing a positive electrode charged with high voltage with XRD, electron diffraction, neutron diffraction, electron spin resonance (ESR), nuclear magnetic resonance (NMR), or the like. In particular, XRD is preferable because the symmetry of a transition metal such as cobalt included in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described so far, the first positive electrode active material 100x has a feature of a small change in the crystal structure between the high-voltage charged state and the discharged state. A material 50 wt % or more of which is occupied by the crystal structure that largely changes between a high-voltage charged state and a discharged state is not preferable because the material cannot withstand high-voltage charging and discharging. It should be noted that the intended crystal structure is not obtained in some cases only by addition of the additive element X. For example, as for lithium cobalt oxides containing magnesium and fluorine in common, some have the O3′ type crystal structure at 60 wt % or more, and the others have the H1-3 type crystal structure at 50 wt % or more, when charged at high voltage. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, analysis of the crystal structure, including XRD, is needed to determine whether or not a positive electrode active material is the first positive electrode active material 100x.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charge Method>>

High-voltage charging for determining whether or not a given composite oxide is the first positive electrode active material 100x can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive additive, and a binder are mixed to a positive electrode current collector made of aluminum foil.

A lithium metal can be used for the counter electrode. When the counter electrode is formed using a material other than the lithium metal, the potential of a secondary battery differs from the potential of the positive electrode. Unless otherwise specified, the voltage and the potential in this specification and the like refer to a potential of a positive electrode.

As an electrolyte contained in the electrolyte solution, 1 mol/L lithium hexafluorophosphate (LiPF₆) can be used, and for the electrolyte solution, ethylene carbonate (EC) and diethyl carbonate (DEC) at EC:DEC=3:7 (volume ratio) and 2 wt % vinylene carbonate (VC) that are mixed can be used.

As a separator, 25-μm-thick polypropylene can be used.

A positive electrode can and a negative electrode can each formed of stainless steel (SUS) can be used.

The coin cell fabricated with the above conditions is charged with constant current at 0.5 C and 4.6 V and then charged with constant voltage until the current value reaches 0.01 C (CCCV charging). Note that here, 1 C is set to 200 mA/g, which is a current value per weight of the positive electrode active material. The temperature is set to 25 °C. After the charging is performed in this manner, the coin cell is disassembled in a glove box with an argon atmosphere to take out the positive electrode, whereby the positive electrode active material charged at high voltage can be obtained. In order to inhibit a reaction with components in the external environment in performing various analyses later, the positive electrode is preferably enclosed in an argon atmosphere. For example, XRD can be performed on the positive electrode enclosed in an airtight container with an argon atmosphere.

### <<XRD>>

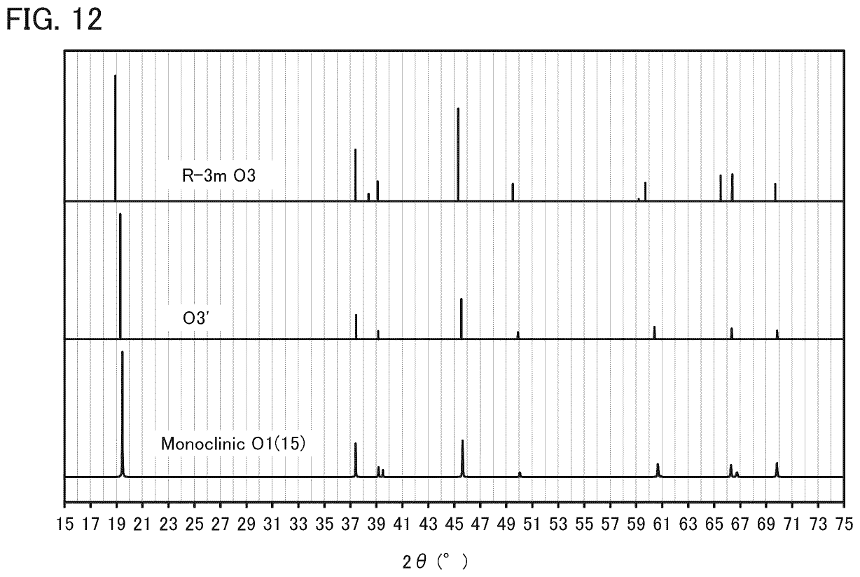

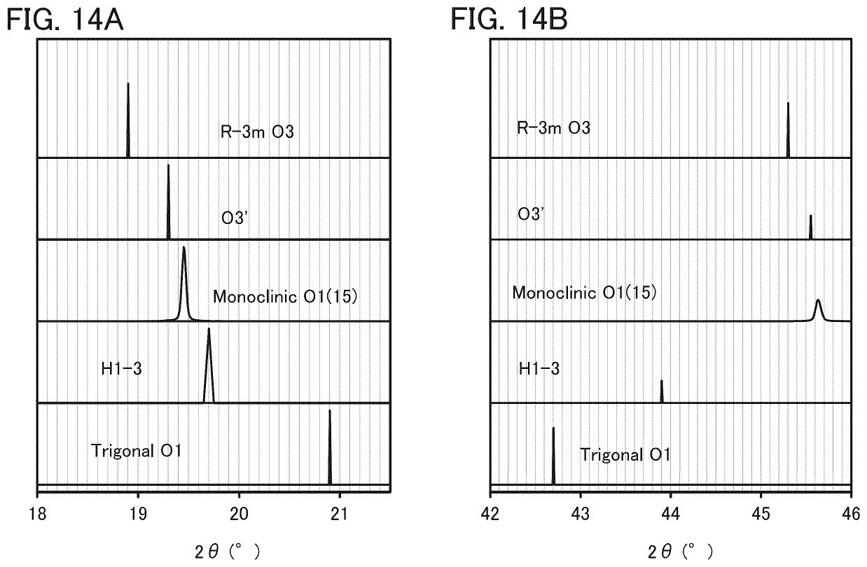

FIG. 12 to FIG. 14 show ideal powder XRD patterns with CuKα₁ radiation that are calculated from models of the O3′ type crystal structure and the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown. Note that the patterns of LiCoO₂ (O3) and CoO₂ (O1) are made from crystal structure data obtained from ICSD (Inorganic Crystal Structure Database) (see Non-Patent Document 5) using Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 3. The pattern of the O3′ type crystal structure is estimated from the XRD pattern of the positive electrode active material of one embodiment of the present invention, the crystal structure is fitted with TOPAS ver. 3 (crystal structure analysis software manufactured by Bruker Corporation), and XRD patterns are made in a manner similar to those of other structures.

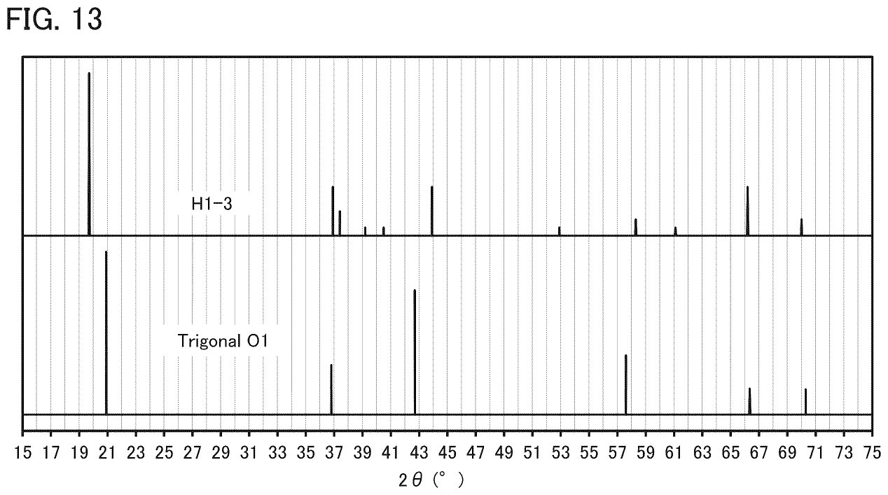

As shown in FIG. 12, the O3′ type crystal structure exhibits diffraction peaks at 2θ of 19.30±0.20° (greater than or equal to 19.10° and less than or equal to) 19.50° and 2θ of 45.55±0.10° (greater than or equal to 45.45° and less than or equal to) 45.65°. More specifically, sharp diffraction peaks appear at 2θ of 19.30±0.10° (greater than or equal to 19.20° and less than or equal to) 19.40° and 2θ of 45.55±0.05° (greater than or equal to 45.50° and less than or equal to) 45.60°. By contrast, as shown in FIG. 13, the H1-3 type crystal structure and CoO₂ (P-3 ml, O1) do not exhibit peaks at these positions. Thus, the peaks appearing at 2θ of 19.30±0.20° and 2θ of 45.55±0.10° in a high-voltage charged state can be the features of the first positive electrode active material 100x.

It can be said that the positions of the XRD diffraction peaks exhibited by the crystal structure with a charge depth of 0 are close to those of the XRD diffraction peaks exhibited by the crystal structure at the time of high voltage charge. More specifically, it can be said that a difference in the positions of two or more, preferably three or more of the main diffraction peaks between the crystal structures is 2θ=0.7 or less, preferably 2θ=0.5 or less.

Although the first positive electrode active material 100x has the O3′ type crystal structure when charged at the time of high voltage, not all the particles necessarily have the O3′ type crystal structure. The positive electrode active material may include another crystal structure or may be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % enables sufficiently good cycle performance. Furthermore, even after 100 or more cycles of charging and discharging after the measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material particle is only decreased to approximately one-tenth that of LiCoO₂ (O3) in a discharged state. Thus, the peak of the O3′ type crystal structure can be clearly observed after high voltage charging even under the same XRD measurement conditions as those of a positive electrode before charging and discharging. By contrast, simple LiCoO₂ has a small crystallite size and exhibits a broad and small peak even if it can partly have a structure similar to the O3′ type crystal structure. The crystallite size can be calculated from the half width of the XRD peak.

### <<EDX>>

One or two or more selected from the additive elements X contained in the first positive electrode active material 100x preferably have a concentration gradient. It is further preferable that the additive elements X included in the first positive electrode active material 100x exhibit concentration peaks at different depths from the surface. The concentration gradients of the additive elements X can be evaluated using, for example, energy dispersive X-ray spectroscopy (EDX) or the like. EDX measurement for evaluating an area two-dimensionally while the area is being scanned is referred to as EDX area analysis. Measurement by line scan, which is performed to evaluate an atomic concentration distribution in a positive electrode active material particle, is referred to as line analysis. Furthermore, extracting data of a linear region from EDX area analysis is referred to as line analysis in some cases. Measurement of a region without scanning is referred to as point analysis in some cases. It is further preferable that the concentration gradients of the additive elements be analyzed by performing line analysis on a cross section of the first positive electrode active material 100x that is exposed with use of an FIB (Focused Ion Beam) or the like. The cross section of the first positive electrode active material 100x is desirably observed with STEM, and a combination of STEM and EDX measurement is referred to as STEM-EDX line analysis.

The surface of the first positive electrode active material 100x in, for example, a cross-sectional STEM image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. Alternatively, the surface refers to an intersection of a tangent drawn to a luminance profile from the surface toward the bulk and an axis in the depth direction in a STEM image. The surface in a STEM image or the like may be determined in combination with analysis with higher spatial resolution.

Thus, a reference point of the first positive electrode active material 100x in STEM-EDX line analysis or the like is a point that is 50% of the average value M_{AVE} of the detected amounts of the characteristic X-ray of the transition metal M1 in the positive electrode active material. In the case where the left side of the reference point is referred to as the outside of the positive electrode active material and the right side of the reference point is referred to as the inner portion of the positive electrode active material, the reference point is referred to as the position of the surface of the positive electrode active material in some cases. In STEM-EDX line analysis or the like, in the case where the detected amount of the characteristic X-ray of the transition metal M1 does not sufficiently decrease at the left side of the reference point, the detected amount of the characteristic X-ray of the transition metal M1 on the left side of the reference point is referred to as a background, and the reference point can be a point that is 50% of the sum of the average value M_{BG} of the detected amounts of the characteristic X-ray of the transition metal M1 of the background and the average value M_{AVE} of the detected amounts of the characteristic X-ray of the transition metal M1 in the inner portion in some cases. Instead of the transition metal M1, the detected amount of characteristic X-rays of oxygen in the positive electrode active material may be used, in which case the reference point can be obtained by replacing the transition metal M1 with oxygen. Note that since oxygen is an element that is easily influenced by the outside of the positive electrode active material, the reference point is preferably calculated from 50% of the average value M_{AVE} of the detected amounts of characteristic X-ray of the transition metal M1. In the case where a point that is 50% of the average value M_{AVE} of the detected amounts of the characteristic X-ray of the transition metal M1 in the inner portion and a point that is 50% of the average value M_{AVE} of the detected amounts of the characteristic X-ray of oxygen in the inner portion are different from each other, there is probably an influence of a carbonate, a metal oxide including oxygen, or the like attached to the surface of the positive electrode active material; thus, a point that is 50% of the average value M_{AVE} of the detected amounts of the characteristic X-ray of the transition metal M1 is preferably employed. In the case of a positive electrode active material including a plurality of the transition metals M1, the reference point can be determined using M_{AVE} or M_{AVE} and M_{BG} of an element whose detection amount of the characteristic X-ray in the inner portion is the largest.

The average value M_{AVE} of the detection amounts of the characteristic X-ray of the transition metal M1 in the inner portion can be calculated by averaging the detection amounts in the range of greater than or equal to 2 nm, preferably greater than or equal to 3 nm in a region in which the detection amount of the characteristic X-ray of the transition metal M1 are saturated and stabilized, e.g., a portion at a depth larger than, by greater than or equal to 30 nm, preferably greater than 50 nm, the depth of the region in which the detection amount of the characteristic X-ray of the transition metal M1 begins to increase. The average value M_{BG} of the detection amounts of the characteristic X-ray of the transition metal M1 of the background can be calculated by averaging the detection amounts in the range of greater than or equal to 2 nm, preferably greater than or equal to 3 nm on the outside, excluding the vicinity of the portion at which the detection amount of the characteristic X-ray of the transition metal M1 begins to increase, for example. The average value O_{BG} of the detection amounts of the characteristic X-ray of oxygen in the inner portion and the average value O_{AVE} of the detection amounts of the characteristic X-ray of oxygen of the background can be obtained in a similar manner.

The spatial resolution of STEM-EDX is at least approximately 1 nm. Thus, the maximum value of an additive element X profile may be shifted by approximately 1 nm. For example, even when the maximum value of the profile of an additive element X such as magnesium is outside the surface determined in the above-described manner, it can be said that a difference between the maximum value and the surface can be regarded as within the margin of error as long as the difference is less than 1 nm.

A peak in STEM-EDX line analysis refers to the maximum value of the detection intensity in each element profile or the maximum value of the characteristic X-ray of each element. A conceivable noise in STEM-EDX line analysis is, for example, a measured value having a half width smaller than or equal to spatial resolution (R), e.g., smaller than or equal to R/2.

STEM-EDX line analysis can be performed as follows, for example. First, a protective film is deposited over the surface of a positive electrode active material. For example, carbon can be deposited with a carbon coating unit of an ion sputtering apparatus (MC1000, Hitachi High-Tech Corporation).

Next, the positive electrode active material is thinned to fabricate a STEM cross-section sample. For example, the positive electrode active material can be thinned with an FIB-SEM apparatus (XVision 200TBS, Hitachi High-Tech Corporation). Here, picking up can be performed by an MPS (micro probing system), and as an example of the conditions of the finishing processing, an acceleration voltage can be 10 kV.

For the STEM-EDX line analysis, a STEM apparatus (JEOL NEOARM) can be used, for example, and a JEOL's dual SDD detector can be used as an EDX detector.

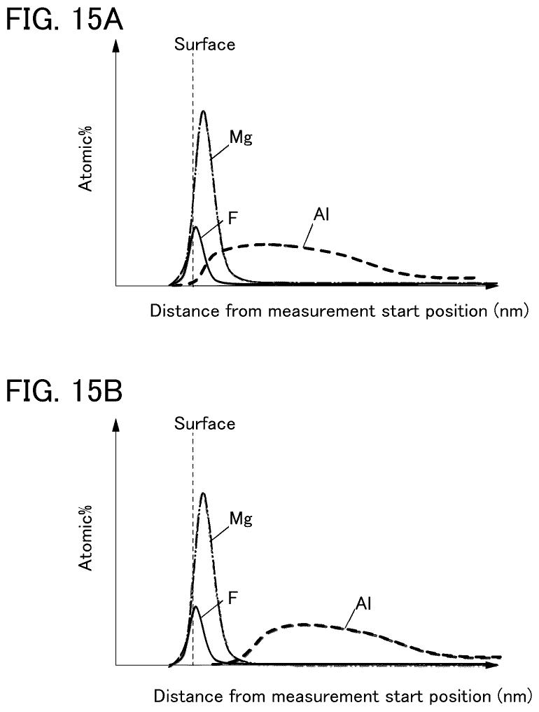

FIG. 15A and FIG. 15B show examples of the STEM-EDX line analysis. This is EDX line analysis of a cross-sectional STEM image in a surface portion having a plane other than the (001) plane. In this case, magnesium, fluorine, and aluminum are detected as the additive elements X. As shown in FIG. 15A and FIG. 15B, the magnesium concentration in the surface portion 100xa is preferably higher than that in the inner portion 100xb. As shown in FIG. 15A and FIG. 15B, the fluorine concentration in the surface portion 100xa is preferably higher than that in the inner portion 100xb. In the STEM-EDX line analysis, a peak of the magnesium concentration in the surface portion 100xa is preferably present from the surface of the first positive electrode active material 100x0 to a depth of 3 nm, further preferably to a depth of 1 nm, still further preferably to a depth of 0.5 nm toward the center. Here, a “peak of concentration” refers to a local maximum value of concentration.

As illustrated in FIG. 15A and FIG. 15B, the distribution of fluorine preferably overlaps with the distribution of magnesium. For example, a difference in the depth direction between the peak of fluorine concentration and the peak of magnesium concentration is preferably within 10 nm, further preferably within 3 nm, still further preferably within 1 nm.

In the STEM-EDX line analysis, the peak of the fluorine concentration in the surface portion 100xa is preferably present from the surface of the first positive electrode active material 100x to a depth of 3 nm, further preferably to a depth of 1 nm, still further preferably to a depth of 0.5 nm toward the center. As illustrated in FIG. 15A and FIG. 15B, it is further preferable that the peak of the fluorine concentration be present slightly closer to the surface side than the peak of the magnesium concentration is, which increases resistance to hydrofluoric acid. For example, it is preferable that the peak of the fluorine concentration be present 0.5 nm or more, further preferably 1.5 nm or more, closer to the surface side than the peak of the magnesium concentration is. The maximum values of the fluorine concentrations shown in FIG. 15A and FIG. 15B can be increased by the above-described fluorination treatment.

As shown in FIG. 15A and FIG. 15B, in the case where the first positive electrode active material 100x includes aluminum as the additive element X, in the surface portion 100xa, the peaks of the magnesium concentration and the fluorine concentration are preferably closer to the surface than the peak of the aluminum concentration is, in the STEM-EDX line analysis. FIG. 15B shows an example of STEM-EDX line analysis in which the peak of the aluminum concentration is positioned at a deeper portion of the first positive electrode active material 100x than that shown in FIG. 15A. As shown in FIG. 15A and FIG. 15B, the aluminum distribution is not normal distribution in some cases. For example, the peak of the aluminum concentration is preferably present at a depth that is greater than or equal to 0.5 nm and less than or equal to 50 nm, further preferably greater than or equal to 5 nm and less than or equal to 50 nm toward the center from the surface of the first positive electrode active material 100x.

Although not shown, in the first positive electrode active material 100x containing nickel as the additive element X, a peak of the nickel concentration in the surface portion 100xa is preferably present from the surface of the first positive electrode active material 100x to a depth of 3 nm, further preferably to a depth of 1 nm, still further preferably to a depth of 0.5 nm toward the center. When the first positive electrode active material 100x contains magnesium and nickel, the distribution of nickel preferably overlaps with the distribution of magnesium. For example, a difference in the depth direction between a peak of the nickel concentration and a peak of the magnesium concentration is preferably within 10 nm, further preferably within 3 nm, still further preferably within 1 nm.

### <<XPS>>

By X-ray photoelectron spectroscopy (XPS), a region from a surface to a depth of approximately 2 nm to 8 nm (normally, approximately 5 nm) can be analyzed; thus, the concentration of each element in approximately half of the surface portion 100xa can be quantitatively analyzed. The bonding states of elements can be analyzed by narrow scanning. The quantitative accuracy of XPS allows about ±1 atomic % in many cases.

When the first positive electrode active material 100x is subjected to XPS analysis, the number of atoms of the additive element X is preferably greater than or equal to 0.3 times and less than or equal to 1.6 times, further preferably greater than or equal to 0.4 times and less than 1.2 times the number of atoms of the transition metal. When the additive element X is magnesium and the transition metal is cobalt, the number of magnesium atoms is preferably greater than or equal to 0.4 times and less than or equal to 1.2 times, further preferably greater than or equal to 0.4 times and less than 1.0 times the number of cobalt atoms. The number of atoms of a halogen such as fluorine is preferably greater than or equal to 0.2 times and less than or equal to 1.5 times, further preferably greater than or equal to 0.4 times and less than 1.0 times the number of atoms of the transition metal.

In the XPS analysis, a monochromatic aluminum source can be used as an X-ray source, for example. An extraction angle is preferably, for example, 45°.

In addition, when the first positive electrode active material 100x is analyzed with XPS, a peak indicating the bonding energy of fluorine with another element is preferably higher than or equal to 682 eV and lower than 685 eV, further preferably approximately 684.3 eV. The above value is different from 685 eV, which is the bonding energy of lithium fluoride, and 686 eV, which is the bonding energy of magnesium fluoride.

Furthermore, when the first positive electrode active material 100x is analyzed with XPS, a peak indicating the bonding energy of magnesium with another element is preferably higher than or equal to 1302 eV and lower than 1304 eV, further preferably approximately 1303 eV. The above value is different from 1305 eV, which is the bonding energy of magnesium fluoride, and is close to the bonding energy of magnesium oxide.

The concentration of the additive element X that is preferably present in large amount in the surface portion 100xa in a large amount, such as magnesium and aluminum, measured with XPS or the like is preferably higher than the concentration measured with ICP-MS (inductively coupled plasma mass spectrometry), GD-MS (glow discharge mass spectrometry), or the like.

When a cross section is exposed by processing and analyzed by TEM-EDX, the concentrations of magnesium and aluminum in the surface portion 100xa are preferably higher than that in the inner portion 100xb. An FIB can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the ratio of the number of magnesium atoms (Mg/Co) is preferably higher than or equal to 0.001 and lower than or equal to 0.06.

By contrast, it is preferable that nickel, which is one of the transition metals, not be unevenly distributed in the surface portion 100xa but be distributed in the entire first positive electrode active material 100x. However, this does not apply to the case of the presence of a region where the excess additive element X described above is unevenly distributed.

This embodiment can be used in combination with any of the other embodiments.

### <<Formation Method 1 of Positive Electrode Active Material>>

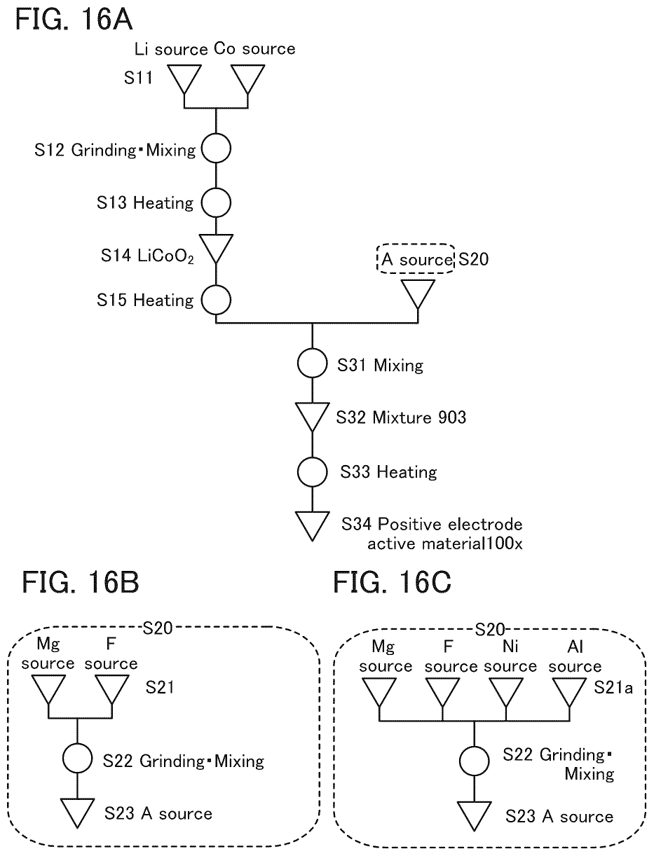

A formation method 1 of the first positive electrode active material 100x is described with reference to FIG. 16A to FIG. 16C. Through the initial heating, the smooth first positive electrode active material 100x can be provided.

### <Step S11>

In Step S11 shown in FIG. 16A, a lithium source (Li source) and a cobalt source (Co source) are prepared as materials for lithium and a transition metal that are starting materials, respectively.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide such as tricobalt tetraoxide or cobalt hydroxide can be used.

### <Step S12>

Next, in Step S12 illustrated in FIG. 16A, the lithium source and the cobalt source are ground and mixed to form a mixed material. The grinding and mixing can be performed by a dry method or a wet method. A wet method is preferable because it can crush a material into a smaller size. When the grinding and mixing are performed by a wet method, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used.

A ball mill, a bead mill, or the like can be used for the grinding and mixing. When a ball mill is used, aluminum oxide balls or zirconium oxide balls are preferably used as a medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium.

### <Step S13>

Next, in Step S13 shown in FIG. 16A, the above mixed material is heated. The heating is preferably performed at a temperature higher than or equal to 800 °C and lower than or equal to 1100 °C, further preferably at a temperature higher than or equal to 900 °C and lower than or equal to 1000 °C, still further preferably at a temperature approximately 950 °C.

After the heating, the heated material is ground as needed and may be made to pass through a sieve. Before collection of the heated material, the material may be moved from the crucible to a mortar. As the mortar, an aluminum oxide mortar or a zirconium oxide mortar is suitably used.

### <Step S14>

Through the above process, lithium cobalt oxide (LiCoO₂) can be synthesized in Step S14 in FIG. 16A.

Although the example is described in which the lithium cobalt oxide is formed by a solid phase method as in Step S11 to Step S14, lithium cobalt oxide may be formed by a coprecipitation method. Alternatively, lithium cobalt oxide may be formed by a hydrothermal method.

### <Step S15>

Next, as Step S15 shown in FIG. 16A, the lithium cobalt oxide is heated. The heating in Step S15 is the first heating performed on the lithium cobalt oxide and thus, this heating is sometimes referred to as initial heating. The heating is performed before Step S20 described next and thus is sometimes referred to as preheating or pretreatment.

As a crucible used at the time of the heating in Step S15, a crucible made of aluminum oxide is preferable. A crucible made of aluminum oxide has a material property that hardly releases impurities. In this embodiment, a crucible made of aluminum oxide with a purity of 99.9% is used. The heating is preferably performed with the crucible covered with a lid. This can prevent volatilization or sublimation of a material. It is acceptable that covering a crucible with a lid can prevent volatilization or sublimation of a material from the temperature rise to the temperature fall in this step, and does not necessarily seal off the crucible. For example, this step can be performed without sealing off the crucible in the case where the reaction chamber is filled with oxygen as described above.

A used crucible is preferred to a new crucible. In this specification and the like, a new crucible refers to a crucible that is subjected to heating two or less times while lithium cobalt oxide is included therein. A used crucible refers to a crucible that is subjected to heating three or more times while lithium cobalt oxide and/or a material containing an additive element X are included therein. In the case where a new crucible is used, part of a material such as lithium fluoride might be absorbed by, diffused in, transferred to, and/or attached to a sagger. Loss of part of a material due to such phenomena increases a concern that an element is not distributed in a preferred range particularly in the surface portion of the positive electrode active material. In contrast, such a concern is reduced in the case of a used crucible.

Although the initial heating is expected to provide the following effects, the initial heating is not essential for obtaining the positive electrode active material of one embodiment of the present invention.

By the initial heating, lithium is extracted from part of the surface portion 100xa of the lithium cobalt oxide as described above. In addition, an effect of increasing the crystallinity of the inner portion 100xb can be expected. The lithium source and/or the cobalt source prepared in Step S11 and the like might contain impurities. The initial heating can reduce impurities in the lithium cobalt oxide completed in Step S14.

Through the initial heating, an effect of smoothing the surface of the lithium cobalt oxide is obtained. A smooth surface of lithium cobalt oxide refers to a state where the lithium cobalt oxide has little unevenness and is rounded as a whole, and its corner portion is rounded. The smooth surface of lithium cobalt oxide means a smooth surface of a composite oxide that is a positive electrode active material particle. A smooth surface also refers to a surface to which few foreign matters are attached. Foreign matters are deemed to cause unevenness and are preferably not attached to a surface.

For the initial heating, a lithium source does not need to be prepared. Alternatively, an additive element source does not need to be prepared. Alternatively, a material functioning as a fusing agent does not need to be prepared.

When the heating time in this step is too short, a sufficient effect is not obtained, but when the heating time in this step is too long, the productivity is lowered. For example, any of the heating conditions described for Step S13 can be selected to perform the heating. As a supplementary explanation of the heating conditions, the heating temperature in this step is preferably lower than that in Step S13 so that the crystal structure of the lithium cobalt oxide can be maintained. The heating time of this step is preferably shorter than the heating time in Step S13 so that the crystal structure of the lithium cobalt oxide can be maintained. For example, the heating is preferably performed at a temperature of higher than or equal to 700 °C and lower than or equal to 1000 °C for longer than or equal to 2 hours and shorter than or equal to 20 hours. Maintaining the crystal structure of lithium cobalt oxide means maintaining the crystal structure of a composite oxide that is a positive electrode active material particle.

The effect of increasing the crystallinity of the inner portion 100xb is, for example, an effect of reducing distortion, a shift, or the like derived from differential shrinkage or the like of the lithium cobalt oxide formed in Step S13.

The heating in Step S13 may cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can level a shift in the lithium cobalt oxide. When the shift is leveled, the surface of the lithium cobalt oxide may become smooth. This is also referred to as alignment of crystal grains. In other words, it is deemed that Step S15 reduces a shift in a crystal caused in the lithium cobalt oxide to make the surface of the lithium cobalt oxide smooth. The smooth surface of lithium cobalt oxide means a smooth surface of a composite oxide that is a positive electrode active material particle.

In a secondary battery including a composite oxide with a smooth surface as a positive electrode active material, deterioration by charging and discharging is suppressed and a crack in the positive electrode active material can be prevented.

Owing to extraction of lithium ions from part of the surface portion 100xa by the initial heating in Step S15, the distribution of the additive element X becomes more favorable. In the following mechanism, the distributions of the additive elements X are likely to be different from each other by the initial heating. First, lithium ions are extracted from part of the surface portion 100xa by the initial heating. Next, the lithium cobalt oxide containing the surface portion 100xa in which the lithium ions are deficient is mixed with additive element sources, and heating is performed. Among the additive elements, magnesium is a typical element and is a divalent ion. Therefore, in part of the surface portion 100xa, a rock-salt phase including Mg²⁺ and Co²⁺, which is obtained by reduction due to lithium deficiency, is formed. Mg²⁺ and Co²⁺ are bonded to oxygen, whereby magnesium oxide having a rock-salt crystal structure and cobalt (II) oxide having a rock-salt crystal structure are formed.

Among the additive elements X, nickel is likely to be dissolved and is diffused to the inner portion 100xb in the case where the surface portion 100xa is lithium cobalt oxide that has a layered rock-salt crystal structure, but nickel is likely to remain in the surface portion 100xa in the case where part of the surface portion 100xa has a rock-salt crystal structure. Thus, the initial heating can make it easy for a divalent additive element X such as nickel to remain in the surface portion 100xa. The additive element X is distributed favorably. The effect of this initial heating is large particularly at the surface having an orientation other than the (001) orientation of the first positive electrode active material 100x and the surface portion 100xa thereof.

Furthermore, in such a rock-salt crystal structure, the bond distance between a metal Me and oxygen (Me-O distance) tends to be longer than that in a layered rock-salt crystal structure.

For example, the Me-O distance is 2.09×10⁻¹⁰ m and 2.11×10⁻¹⁰ m in Ni_{0.5}Mg_{0.5}O having a rock-salt crystal structure and MgO having a rock-salt crystal structure, respectively. Even when a spinel phase is formed in part of the surface portion 100xa, the Me-O distance is 2.0125×10⁻¹⁰ m and 2.02×10⁻¹⁰ m in NiAl₂O₄ having a spinel structure and MgAl₂O₄ having a spinel structure, respectively. In each case, the Me-O distance is longer than 2×10⁻¹⁰ m.

Meanwhile, in a layered rock-salt crystal structure, the bond distance between oxygen and a metal other than lithium is shorter than the above-described distance. For example, the Al—O distance is 1.905×10⁻¹⁰ m (Li—O distance is 2.11×10⁻¹⁰ m) in LiAlO₂ having a layered rock-salt crystal structure. In addition, the Co—O distance is 1.9224×10⁻¹⁰ m (Li—O distance is 2.0916×10⁻¹⁰ m) in LiCoO₂ having a layered rock-salt crystal structure.

According to Shannon's ionic radius described in Non-Patent Document 15, the ion radius of hexacoordinated aluminum is 0.535×10⁻¹⁰ m and the ion radius of hexacoordinated oxygen is 1.4×10⁻¹⁰ m and the sum of these values is 1.935×10⁻¹⁰ m.

From the above, aluminum is considered to be present at sites other than lithium sites more stably in a layered rock-salt crystal structure than in a rock-salt crystal structure. Thus, in the surface portion 100xa, aluminum is more likely to be distributed in a region having a layered rock-salt phase at a larger depth and/or the inner portion 100xb than in a region having a rock-salt phase and being close to the surface.

Note that pre-synthesized lithium cobalt oxide may be used in Step S14. In this case, Step S11 to Step S13 can be omitted. When Step S15 is performed on the pre-synthesized lithium cobalt oxide, lithium cobalt oxide with a smooth surface can be obtained.

### <Step S20>

Next, as shown in Step S20, the additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIG. 16B and FIG. 16C.

### <Step S21>

In Step S21 shown in FIG. 16B, an additive element A source (A source) to be added to the lithium cobalt oxide is prepared. A lithium source may be prepared in addition to the additive element A source.

As the additive element A, one or two or more selected from the additive elements X described in the above embodiment, specifically, magnesium, fluorine, nickel, aluminum, titanium, and phosphorus, can be specifically used.

When magnesium is selected as the additive element, the additive element source can be referred to as a magnesium source (Mg source). As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source (F source). As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848 °C.

Magnesium fluoride can be used as both the fluorine source and the magnesium source. Lithium fluoride can also be used as both the fluorine source and the lithium source. Another example of the lithium source that can be used in Step S21 is lithium carbonate.

The fluorine source is preferably a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like is preferably used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, cycle performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x is 0.33 or a value in the vicinity thereof). Note that the vicinity means a value greater than 0.9 times and less than 1.1 times a given value.

### <Step S22>

Next, in Step S22 shown in FIG. 16B, the magnesium source and the fluorine source are ground and mixed. Any of the conditions for grinding and mixing that are described for Step S12 can be selected to perform this step.

### <Step S23>

Next, in Step S23 shown in FIG. 16B, the materials ground and mixed in the above step are collected to obtain the additive element A source (A source). Note that the additive element A source shown in Step S23 includes a plurality of starting materials and can be referred to as a mixture.

As for the particle diameter of the mixture, the median diameter (D50) is preferably greater than or equal to 600 nm and less than or equal to 10 μm, further preferably greater than or equal to 1 μm and less than or equal to 5 μm. When one kind of material is used as the additive element source, the median diameter (D50) is preferably greater than or equal to 600 nm and less than or equal to 10 μm, further preferably greater than or equal to 1 μm and less than or equal to 5 μm.

Such a pulverized mixture (which may include one kind of the additive element) is easily attached to the surface of lithium cobalt oxide uniformly in a later step of mixing with the lithium cobalt oxide. The mixture is preferably attached uniformly to the surfaces of the lithium cobalt oxide particles, in which case the additive element is easily distributed or dispersed uniformly in the surface portion 100xa of the composite oxide after heating.

### <Step S21a>

A process different from that in FIG. 16B is described with reference to FIG. 16C. In Step S21a illustrated in FIG. 16C, four kinds of additive element sources to be added to the lithium cobalt oxide are prepared. In other words, FIG. 16C is different from FIG. 16B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 16B. As the nickel source, nickel oxide, nickel hydroxide, or the like can be used. As the aluminum source, aluminum oxide, aluminum hydroxide, or the like can be used.

### <Step S22 and Step S23>

Step S22 and Step S23 illustrated in FIG. 16C are similar to the steps described with reference to FIG. 16B.

### <Step S31>

Next, in Step S31 illustrated in FIG. 16A, the lithium cobalt oxide and the additive element A source (A source) are mixed. The atomic ratio of cobalt Co in the lithium cobalt oxide to magnesium Mg included in the additive element A source is preferably Co:Mg=100:y (0.1≤y≤6), further preferably Co:Mg=100:y (0.3<y<3).

The condition of the mixing in Step S31 is preferably milder than that of the mixing in Step S12 not to damage the lithium cobalt oxide particle shape. For example, conditions with a lower rotational frequency or a shorter time than those for the mixing in Step S12 are preferable. In addition, it can be said that a dry method has a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100 °C and lower than or equal to −10 °C.

### <Step S32>

Next, in Step S32 in FIG. 16A, the materials mixed in the above manner are collected, whereby a mixture 903 is obtained. At the time of the collection, the materials may be crushed as needed and made to pass through a sieve.

Note that although FIG. 16A to FIG. 16C illustrate the formation method in which addition of the additive element X is performed after the initial heating, the present invention is not limited to the above-described method. The addition of the additive element X may be performed at another timing or may be performed a plurality of times. The timing of the addition may be different between the additive elements X.

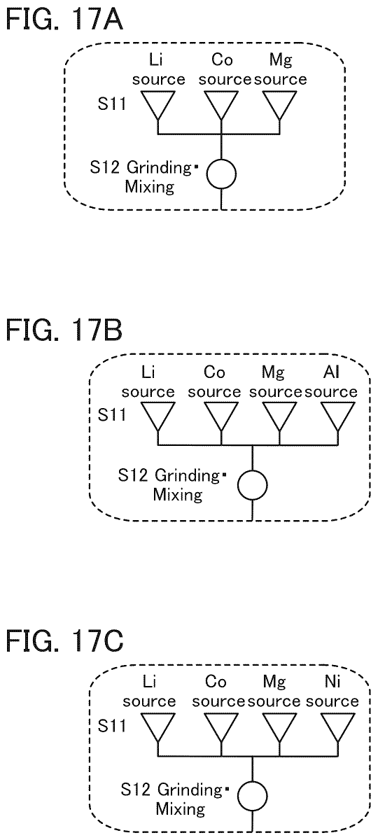

As illustrated in FIG. 17A to FIG. 17C, for example, the additive element X may be added to the lithium source and the cobalt source in Step S11, i.e., at the stage of the starting materials of the composite oxide. FIG. 17A shows a flowchart for adding the magnesium source to the lithium source and the cobalt source. FIG. 17B shows a flowchart for adding the magnesium source and the aluminum source to the lithium source and the cobalt source. FIG. 17C shows a flowchart for adding the magnesium source and the nickel source to the lithium source and the cobalt source. The additive element sources shown in FIG. 17A to FIG. 17C are examples.

The process is followed by Steps S12 and S13, and the lithium cobalt oxide including the additive elements X can be obtained in Step S14. The distributions of the additive elements X can be controlled by changing the timing of the addition of the additive elements X. The additive elements X added as illustrated in FIG. 17A to FIG. 17C are expected to be located in the inner portion of the first positive electrode active material 100x. Steps S21 to S23 described above do not need to be performed separately from Steps S11 to S14 described above in the case where any of the flowcharts illustrated in FIG. 17A to FIG. 17C is employed, so that the method is simplified and enables increased productivity. Needless to say, a new additive element may be added in Step S20 also in the case where any of the flowcharts shown in FIG. 17A to 17C is employed.

Alternatively, lithium cobalt oxide that includes one or some of the additive elements X in advance may be used. For example, when lithium cobalt oxide to which magnesium and fluorine are added is used, some of Step S11 to Step S14 and Step S20 can be skipped. This method can be regarded as being simple and highly productive.

Alternatively, after the heating in Step S15 is performed, to lithium cobalt oxide to which magnesium and fluorine are added in advance, a magnesium source and a fluorine source, or a magnesium source, a fluorine source, a nickel source, and an aluminum source may be added as in Step S20.

### <Step S33>

Then, in Step S33 illustrated in FIG. 16A, the mixture 903 is heated. Any of the heating conditions described for Step S15 can be selected to perform the heating. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere may cause reduction of cobalt or the like and hinder the lithium cobalt oxide or the like from maintaining a layered rock-salt crystal structure.

Here, a supplementary explanation of the heating temperature is given. The lower limit of the heating temperature in Step S33 needs to be higher than or equal to the temperature at which a reaction between the lithium cobalt oxide and the additive element source proceeds. The temperature at which the reaction proceeds is preferably a temperature at which interdiffusion of elements included in lithium cobalt oxide and the additive element source occurs, and may be lower than the melting temperatures of these materials. It is known that in the case of an oxide as an example, solid phase diffusion occurs at the temperature 0.757 times the melting temperature Tₘ (the Tamman temperature Ta). Accordingly, the heating temperature in Step S33 is preferably higher than or equal to 650 °C.

Needless to say, the reaction more easily proceeds at a temperature higher than or equal to the temperature at which one or two or more selected from the materials included in the mixture 903 are melted. For example, in the case where LiF and MgF₂ are included as the additive element sources, the lower limit of the heating temperature in Step S33 is preferably higher than or equal to 742 °C because the eutectic point of LiF and MgF₂ is around 742 °C.

The mixture 903 obtained by mixing such that LiCoO₂:LiF:MgF₂=100:0.33:1 (molar ratio) exhibits an endothermic peak at around 830 °C in DSC measurement. Therefore, the lower limit of the heating temperature is further preferably higher than or equal to 830 °C.

A higher heating temperature is preferable because it facilitates the reaction, shortens the heating time, and enables high productivity.

The upper limit of the heating temperature is lower than the decomposition temperature (the melting point: 1130 °C) of the lithium cobalt oxide. At around the decomposition temperature, a slight amount of lithium cobalt oxide might be decomposed. Thus, the upper limit of the heating temperature is preferably lower than or equal to 1000 °C, further preferably lower than or equal to 950 °C, still further preferably lower than or equal to 900 °C.

In view of the above, the heating temperature in Step S33 is preferably higher than or equal to 650 °C and lower than or equal to 1130 °C, further preferably higher than or equal to 650 °C and lower than or equal to 1000 °C, still further preferably higher than or equal to 650 °C and lower than or equal to 950 °C, yet still further preferably higher than or equal to 650 °C and lower than or equal to 900 °C. Furthermore, the heating temperature is preferably higher than or equal to 742 °C and lower than or equal to 1130 °C, further preferably higher than or equal to 742 °C and lower than or equal to 1000 °C, still further preferably higher than or equal to 742 °C and lower than or equal to 950 °C, yet still further preferably higher than or equal to 742 °C and lower than or equal to 900 °C. Furthermore, the temperature is preferably higher than or equal to 830 °C and lower than or equal to 1130 °C, further preferably higher than or equal to 830 °C and lower than or equal to 1000 °C, still further preferably higher than or equal to 830 °C and lower than or equal to 950 °C, yet still further preferably higher than or equal to 830 °C and lower than or equal to 900 °C. Note that the heating temperature in Step S33 is preferably lower than the heating temperature in Step S13.

Cooling after the heating in Step S33 above can be performed by natural cooling, and the time it takes for the temperature to decrease to room temperature from a predetermined temperature is preferably longer than or equal to 10 hours and shorter than or equal to 50 hours; for example, the temperature falling rate (hereinafter also referred to as cooling rate) is preferably higher than or equal to 80 °C/h and lower than or equal to 250 °C/h, further preferably higher than or equal to 180 °C/h and lower than or equal to 210 °C/h. The cooling rate in Step S33 is preferably higher than that in Step S13. Cooling at a high cooling rate is referred to as rapid cooling. Performing rapid cooling after the above-described melting makes it possible to form a shell adequately. Specifically, it is possible to form a thin shell. Note that as long as the temperature becomes acceptable to the next step, the cooling is not necessarily continued until the temperature reaches a room temperature.

In addition, at the time of heating the mixture 903, the partial pressure of fluorine or a fluorine compound originating from the fluorine source or the like is preferably controlled to be within an appropriate range. The partial pressure may be controlled by performing the heating in this step with the crucible covered with the lid. As described above, the use of the lid can prevent volatilization or sublimation of a material. Thus, from the temperature rise to the temperature fall in this step, the crucible is not necessarily sealed off with the lid as long as volatilization or sublimation of a material is prevented. For example, this step can be performed without sealing off the crucible in the case where a reaction chamber in which the crucible is put is filled with oxygen. A positive electrode active material including fluorine or a fluorine compound in an appropriate manner is preferable because such positive electrode active material can inhibit ignition and fuming if an internal short circuit occurs.

In the formation method described in this embodiment, one or some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742 °C and lower than or equal to 950 °C, which allows distribution of the additive elements X such as magnesium in the surface portion and manufacture of the positive electrode active material having favorable characteristics.

However, since LiF in a gas phase has a specific gravity lighter than that of oxygen, heating might volatilize or sublimate LiF and in that case, LiF in the mixture 903 decreases. As a result, the function as a fusing agent deteriorates. Therefore, heating needs to be performed while volatilization of LiF is inhibited. In addition, even when LiF is not used as the fluorine source or the like, Li at the surface of LiCoO₂ and F of the fluorine source might react to produce LiF, which might be volatilized. Thus, such inhibition of volatilization is needed even when a fluorine compound having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903. The crucible is preferably covered with a lid so that volatilization of LiF is inhibited.

The heating in this step is preferably performed such that the particles of the mixture 903 are not adhered to each other. Adhesion of the particles of the mixture 903 during the heating may decrease the area of contact with oxygen in the atmosphere and inhibit a path of diffusion of the additive element X (e.g., fluorine), thereby hindering distribution of the additive element X (e.g., magnesium and fluorine) in the surface portion. In order to promote a reaction with oxygen in the atmosphere, it may be unnecessary to seal off the crucible with the lid.

It is considered that uniform distribution of the additive element X (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it may cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example. This is the same as the lid which covers the crucible.

A supplementary explanation of the heating time is given. The heating time depends on conditions such as the heating temperature and the size and composition of the lithium cobalt oxide obtained in Step S14. In the case where the lithium cobalt oxide is small, the heating is preferably performed at a lower temperature or for a shorter time than heating in the case where the lithium cobalt oxide is large, in some cases.

When the median diameter (D50) of the lithium cobalt oxide obtained in Step S14 in FIG. 16A is approximately 12 μm, the heating temperature is preferably higher than or equal to 650 °C and lower than or equal to 950 °C, for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the temperature decreasing time after the heating is, for example, preferably longer than or equal to 10 hours and shorter than or equal to 50 hours.

When the median diameter (D50) of the lithium cobalt oxide obtained in Step S14 is approximately 5 μm, the heating temperature is preferably higher than or equal to 650 °C and lower than or equal to 950 °C, for example. The heating time is preferably longer than or equal to 1 hour and shorter than or equal to 10 hours, further preferably approximately 5 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 16A; thus, the first positive electrode active material 100x is obtained. The collected particles may be made to pass through a sieve. Through the above steps, the first positive electrode active material 100x of one embodiment of the present invention can be formed. The positive electrode active material of one embodiment of the present invention has a smooth surface.

### <<Formation Method 2 of Positive Electrode Active Material>>

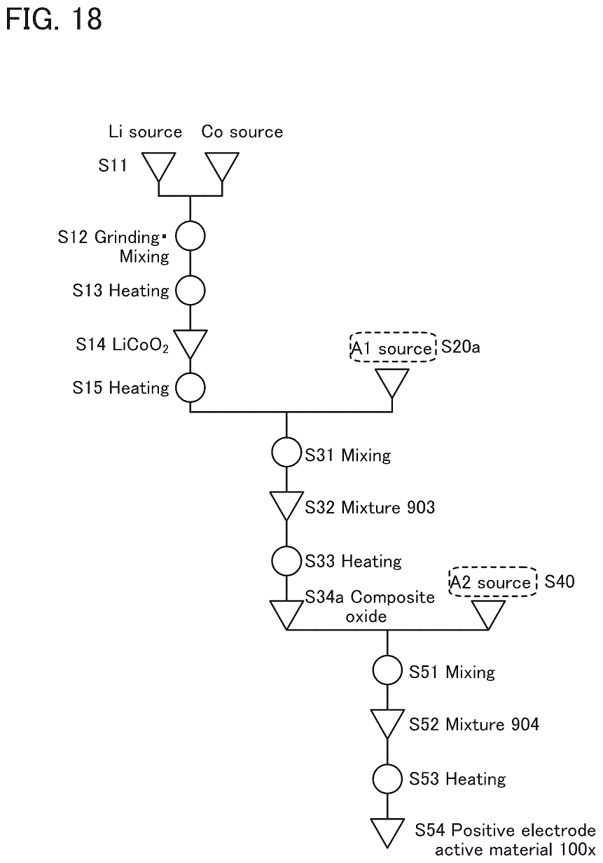

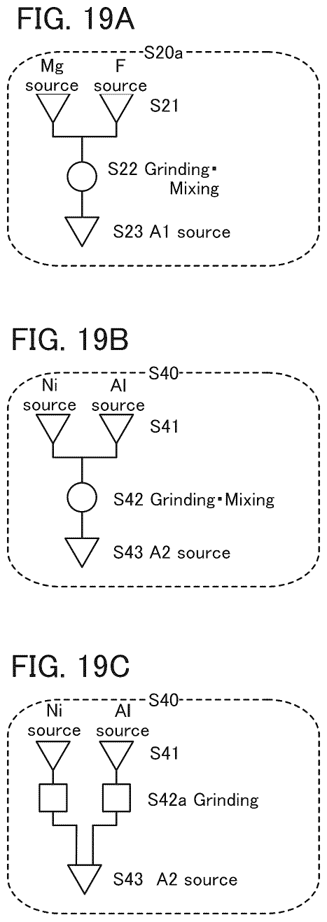

Next, as one embodiment of the present invention, a formation method 2 of a positive electrode active material, which is different from the formation method 1 of a positive electrode active material, will be described with reference to FIG. 18 to FIG. 19C. The formation method 2 of the positive electrode active material is different from the formation method 1 mainly in the number of times of adding additive elements X and a mixing method. For other points, the description of the formation method 1 can be referred to.

Steps S11 to S15 in FIG. 18 are performed as in FIG. 16A to prepare lithium cobalt oxide that has been subjected to the initial heating.

### <Step S20a>

Next, as illustrated in Step S20a, an additive element A1 is preferably added to the lithium cobalt oxide that has been subjected to the initial heating.

### <Step S21>

In Step S21 shown in FIG. 19A, a first additive element source (A1 source) is prepared. The first additive element source can be selected from the additive elements described for Step S21 in FIG. 16B to be used. For example, one or more elements selected from magnesium and fluorine can be suitably used as the first additive element source. FIG. 19A illustrates an example of using a magnesium source (Mg source) and a fluorine source (F source) as the first additive element sources.

Step S21 to Step S23 illustrated in FIG. 19A can be performed under the conditions similar to those in Step S21 to Step S23 illustrated in FIG. 16B. As a result, the first additive element source can be obtained in Step S23.

Step S31 to Step S33 illustrated in FIG. 18 can be performed in steps similar to those of Step S31 to Step S33 illustrated in FIG. 16A.

### <Step S34a>

Next, the material heated in Step S33 is collected to give lithium cobalt oxide containing the first additive element source. This is called a second composite oxide to be distinguished from the composite oxide in Step S14.

<Step S40>

In Step S40 shown in FIG. 18, a second additive element source (A2 source) is added. Descriptions are given also with reference to FIG. 19B and FIG. 19C.

### <Step S41>

In Step S41 illustrated in FIG. 19B, the second additive element source is prepared. The second additive element source can be selected from the additive elements described for Step S21 with reference to FIG. 19A. For example, one or more elements selected from nickel, titanium, and aluminum can be suitably used as the second additive element source. FIG. 19B illustrates an example of using a nickel source (Ni source) and an aluminum source (Al source) as the second additive element source.

Step S41 to Step S43 illustrated in FIG. 19B can be performed under the conditions similar to those in Step S21 to Step S23 illustrated in FIG. 16B. As a result, the second additive element source can be obtained in Step S43.

FIG. 19C illustrates a variation example of the steps which are described with reference to FIG. 19B. A nickel source (Ni source) and an aluminum source (Al source) are prepared in Step S41 illustrated in FIG. 19C and are separately ground in Step S42a. Accordingly, a plurality of the second additive element sources are prepared in Step S43. The step in FIG. 19C is different from the step in FIG. 19B in separately grinding the additive elements X in Step S42a.

### <Step S51 to Step S54>

Next, Step S51 to Step S54 illustrated in FIG. 18 can be performed under the conditions similar to those in Step S31 to Step S34 illustrated in FIG. 16A. The heating in Step S53 can be performed at a lower temperature and for a shorter time than the heating in Step S33. Through the above steps, the first positive electrode active material 100x of one embodiment of the present invention can be formed in Step S54. The positive electrode active material of one embodiment of the present invention has a smooth surface.

As illustrated in FIG. 18 to FIG. 19C, in the formation method 2, introduction of the additive elements X to the lithium cobalt oxide is separated into introduction of the first additive element source and introduction of the second additive element source. When the additive elements are separately introduced, the additive elements X can be present at different positions or the like in the depth direction. For example, the first additive element X can be positioned such that its concentration is higher in the surface portion than in the inner portion, and the second additive element X can be positioned such that its concentration is higher in the inner portion than in the surface portion.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element X is preferably added to the lithium cobalt oxide after the initial heating. The adding step can be separated into two or more steps. Such an order of steps is preferable, which can maintain the smoothness of the surface achieved by the initial heating.

This embodiment can be freely combined with any of the other embodiments.

### Embodiment 4

In this embodiment, a lithium-ion secondary battery including a positive electrode active material of one embodiment of the present invention will be described. The secondary battery includes at least an exterior body, a current collector, an active material (a positive electrode active material or a negative electrode active material), a conductive additive, and a binder. The lithium-ion secondary battery also includes an electrolyte solution in which a lithium salt or the like is dissolved. In the secondary battery including an electrolyte solution, a positive electrode, a negative electrode, and a separator between the positive electrode and the negative electrode are provided.

### [Positive Electrode]

The positive electrode includes a positive electrode active material layer and a positive electrode current collector. The positive electrode active material layer preferably includes the positive electrode active material composite 100α described in Embodiment 1, and may further include a binder, a conductive additive, or the like.

The current collector is metal foil, and the positive electrode is formed by applying a slurry onto the metal foil and performing drying. Pressing may be performed after drying. The positive electrode is a component obtained by forming an active material layer over the current collector.

Slurry refers to a material solution that is used to form an active material layer over a current collector and includes at least an active material, a binder, and a solvent, preferably also a conductive additive mixed therewith. Slurry may also be referred to as slurry for an electrode or active material slurry; in some cases, slurry for a positive electrode is used for forming a positive electrode active material layer, and slurry called negative electrode slurry is used for forming a negative electrode active material layer.

A conductive additive is also referred to as a conductivity-imparting agent or a conductive material, and a carbon material is used. A conductive additive is attached between a plurality of active materials, whereby the plurality of active materials are electrically connected to each other, and the conductivity increases. Note that the term “attach” refers not only to a state where an active material and a conductive additive are physically in close contact with each other, and conceptually includes, for example, the following cases: a case where covalent bonding occurs, a case where bonding with the Van der Waals force occurs, a case where a conductive additive covers part of the surface of an active material, a case where a conductive additive is embedded in surface roughness of an active material, and a case where an active material and a conductive additive are electrically connected to each other without being in contact with each other.

Typical examples of a carbon material used as the conductive additive include carbon black (e.g., furnace black, acetylene black, and graphite).

In a positive electrode of a secondary battery, a binder (a resin) is mixed in order to fix a current collector such as metal foil and an active material. The binder is also referred to as a binding agent. Since the binder is a high molecular material, a large amount of the binder contained lowers the proportion of the active material in the positive electrode, thereby reducing the discharge capacity of the secondary battery. Therefore, the amount of the binder mixed is reduced to a minimum.

Graphene, which has electrically, mechanically, or chemically remarkable characteristics, is a carbon material that is expected to be used in a variety of fields, such as field-effect transistors and solar batteries.

The graphene or graphene compound may have excellent electrical characteristics of high conductivity and excellent physical properties of high flexibility and high mechanical strength. The graphene or graphene compound have a sheet-like shape. The graphene or graphene compound have a curved surface in some cases, thereby enabling low-resistant surface contact. Furthermore, the graphene compound has extremely high conductivity even with a small thickness in some cases and thus allows a conductive path to be formed in an active material layer efficiently even with a small amount. Hence, the use of graphene or a graphene compound as a conductive material can increase the area where an active material and the conductive material are in contact with each other. Note that a graphene compound preferably clings to at least part of an active material particle. A graphene compound preferably overlays at least part of an active material particle. The shape of a graphene compound preferably conforms to at least part of the shape of an active material particle. The shape of an active material particle means, for example, unevenness of a single active material particle or unevenness formed by a plurality of active material particles. A graphene compound preferably surrounds at least part of an active material particle. The graphene compound may have a hole.

The positive electrode active material composite 100α obtained in Embodiment 1 is used in the positive electrode, whereby a secondary battery having a high energy density and high safety can be obtained.

The above structure is an example of a secondary battery using an electrolyte solution, without particular limitation thereto.

For example, a semi-solid-state battery or an all-solid-state battery can be fabricated using the positive electrode active material composite 100α described in Embodiment 1.

In this specification and the like, a semi-solid-state battery refers to a battery in which at least one of an electrolyte layer, a positive electrode, and a negative electrode includes a semi-solid-state material. The semi-solid-state here does not mean that the proportion of a solid-state material is 50%. The semi-solid-state means having properties of a solid, such as a small volume change, and also partly having properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery manufactured using the positive electrode active material composite 100α described in Embodiment 1 is a secondary battery having high discharge capacity. The semi-solid-state battery can have high charge and discharge voltages. Alternatively, a highly safe or reliable semi-solid-state battery can be provided.

The positive electrode active material composite 100α described in Embodiment 1 and another positive electrode active material may be mixed to be used.

Examples of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (LiNiO₂ or LiNi₁₋ₓMₓO₂ (0<x<1) (M=Co, Al, etc.) with a lithium-containing material that has a spinel crystal structure and contains manganese, such as LiMn₂O₄. This can improve the characteristics of the secondary battery.

As the another positive electrode active material, a lithium-manganese composite oxide that can be represented by a composition formula LiₐMn_{b}M_{c}O_{d} can be used. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26≤(b+c)/d<0.5. Note that the proportions of metals, silicon, phosphorus, and the like in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICPMS combined with fusion gas analysis and valence evaluation of XAFS (X-ray absorption fine structure) analysis. Note that the lithium-manganese composite oxide is an oxide containing at least lithium and manganese, and may contain at least one element selected from a group consisting of chromium, cobalt, aluminum, nickel, iron, magnesium, molybdenum, zinc, indium, gallium, copper, titanium, niobium, silicon, phosphorus, and the like.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, water-soluble polymers are preferably used, for example. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used.

As the binder, two or more of the above materials may be used in combination.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. A material having a significant viscosity modifying effect is referred to as a thickener in some cases. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

As for a cellulose derivative such as carboxymethyl cellulose, for example, a salt such as a sodium salt or an ammonium salt of carboxymethyl cellulose is used to provide a higher solubility, and thus an effect as a viscosity modifier is easily obtained. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material or another material combined as a binder, e.g., styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Positive Electrode Current Collector>

For the positive electrode current collector, a material that has high conductivity, such as a metal like stainless steel, gold, platinum, aluminum, or titanium, or an alloy thereof can be used. In the case where aluminum is used for the positive electrode current collector, there is a risk that a thermite reaction between the positive electrode active material and aluminum may occur when the secondary battery has a high temperature due to an abnormality such as an internal short circuit. It is difficult to stop the thermite reaction that has started, which might lead to ignition and thermal runway of the secondary battery. The positive electrode active material composite 100α of one embodiment of the present invention can inhibit the thermite reaction with aluminum even when abnormality occurs, in other ways, thermal runaway can be inhibited.

It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel.

The positive electrode current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material, and may further contain a conductive additive and a binder.

### <Negative Electrode Active Material>

As the negative electrode active material, an alloy-based material, a carbon material, and a mixture thereof can be used, for example.

As the carbon material, graphite, graphitizing carbon (soft carbon), non-graphitizing carbon (hard carbon), carbon nanotube, graphene, carbon black, or the like is used.

Examples of graphite include artificial graphite and natural graphite, and one or more selected from these can be used. The interplanar spacing d(002) of the (002) plane of the graphite structure is preferably greater than or equal to 0.335 nm and less than or equal to 0.337 nm, and the interplanar spacing d(002) can be typically obtained from powder X-ray diffraction. Graphite having the interplanar spacing d (002) value outside the range may fail to have favorable discharge capacity and/or charge capacity.

Examples of artificial graphite include mesocarbon microbeads (MCMB), coke-based artificial graphite, and pitch-based artificial graphite. Artificial graphite can have a spherical shape, which is referred to as spherical graphite. MCMB have a spherical shape in some cases and are preferable as spherical graphite. Moreover, MCMB can relatively easily have a small surface area. In the case where the specific surface area is large, the decomposition reaction with the electrolyte solution occurs significantly on the surface of the negative electrode active material; thus, favorable cycle characteristics cannot be obtained in some cases. In order to inhibit the decomposition reaction, the specific surface area of the carbon material, specifically, the specific surface area of MCMB as the powder characteristics, is preferably greater than or equal to 0.8 m²/g and 8 m²/g, further preferably greater than or equal to 1 m²/g and 4.8 m²/g measured by a BET method (Brunauer Emmett Teller method). The BET method is an analytical method in which Langmuir's theory is extended to multilayer molecular adsorption of adsorbed gas molecules, which is the most common method for calculating the specific surface area. For measuring the specific surface area by the BET method, an automated specific surface area analyzer TriStar2 3020 can be used.

The carbon material with a small particle diameter (D50) may become bulky, hindering an increase in electrode density. Thus, the median diameter (D50) of the carbon material, specifically, the median diameter of MCMB as the powder characteristics, is preferably greater than or equal to 3 μm and less than or equal to 25 μm, further preferably greater than or equal to 5 μm and less than or equal to 10 μm. The median diameter (D50) is typically measured by a laser diffraction method.

Examples of natural graphite include flake graphite and spherical natural graphite. The flake graphite can be ground with a grinding mill so that the median diameter (D50) can be adjusted. The median diameter (D50) is preferably greater than or equal to 3 μm and less than or equal to 25 μm, further preferably greater than or equal to 5 μm and less than or equal to 10 μm. In addition, spheroidizing treatment may be performed on natural graphite. In the case where the specific surface area is large, the decomposition reaction with the electrolyte solution occurs significantly on the surface of the negative electrode active material; thus, favorable cycle characteristics cannot be obtained in some cases. In order to inhibit the decomposition reaction, the specific surface area of natural graphite as the powder characteristics is preferably greater than or equal to 0.8 m²/g and 8 m²/g, further preferably greater than or equal to 1 m²/g and 4.8 m²/g measured by a BET method (Brunauer Emmett Teller method).

Graphite has a low potential substantially equal to that of lithium metal (higher than or equal to 0.01 V and lower than or equal to 0.3 V vs. Li/Li⁺) when lithium ions are inserted into graphite (while a lithium-graphite intercalation compound is formed). For this reason, a lithium-ion secondary battery using graphite can have a high operating voltage. In addition, graphite is preferable, which has advantages such as a relatively high capacity per unit volume, relatively small volume expansion, low cost, and a higher level of safety than that of lithium metal.

For the alloy material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements enable higher capacity than carbon; in particular, silicon has a high theoretical capacity of 4200 mAh/g per weight of the active material. For this reason, silicon is preferably used as the negative electrode active material. Alternatively, a compound including any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, such an element that enables charge and discharge reactions by alloying and dealloying reactions with lithium and such a compound containing the element, for example, are referred to as alloy materials.

In this specification and the like, SiO refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, Cu) with a Li₃N structure, which is a nitride of lithium and a transition metal, can be used. For example, Li_{2.6}Co_{0.4}N is preferable because of its high discharge capacity (900 mAh/g per weight of the active material and 1890 mAh/cm³).

A nitride of lithium and a transition metal is preferably used, in which case lithium ions are included in the negative electrode active material and thus the negative electrode active material can be used in combination with a positive electrode active material that does not include lithium ions, such as V₂O₅ or Cr₃O₈. Note that even in the case of using a material including lithium ions as a positive electrode active material, the nitride including lithium and a transition metal can be used as the negative electrode active material by extracting the lithium ions included in the positive electrode active material in advance.

A material that causes a conversion reaction can also be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be contained in the negative electrode active material layer, materials similar to those of the conductive additive and the binder that can be contained in the positive electrode active material layer can be used.

### <Negative Electrode Current Collector>

For the negative electrode current collector, copper or the like can be used in addition to a material similar to that of the positive electrode current collector. Note that aluminum cannot be used for the negative electrode current collector. Note that a material that does not alloy with carrier ions of lithium or the like is preferably used for the negative electrode current collector.

### [Separator]

A separator is placed between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator during high-voltage charging and discharging can be inhibited and thus the reliability of the secondary battery can be improved. When the separator is coated with the fluorine-based material, the separator is easily brought into close contact with an electrode, resulting in high output performance. When the separator is coated with a polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte]

As one mode of an electrolyte, an electrolyte solution containing a solvent and an electrolyte dissolved in the solvent can be used. As the solvent, an aprotic organic solvent is preferably used; for example, one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used, or two or more kinds thereof can be used in an appropriate combination at an appropriate ratio.

### <Organic Solvent>

An organic solvent using an organic compound containing fluorine is described as a further preferable solvent. Specific examples of the fluorine-containing organic compound include a fluorinated cyclic carbonate (also referred to as cyclic carbonate fluoride in some cases). An organic compound containing fluorine is a fluorinated chain carbonate (also referred to as chain carbonate fluoride in some cases). Each of the fluorinated cyclic carbonate and the fluorinated chain carbonate has a substituent with an electron-withdrawing property. An organic compound having a substituent with an electron-withdrawing property has lower solvation energy of a lithium ion than an organic compound having no substituent with an electron-withdrawing property. Accordingly, an organic compound containing fluorine is suitable for an organic solvent, and a secondary battery having favorable initial characteristics due to the organic solvent can be provided. The above organic solvent further preferably contains both a fluorinated cyclic carbonate and a fluorinated chain carbonate.

As a fluorinated cyclic carbonate, fluoroethylene carbonate (also referred to as fluorinated ethylene carbonate, abbreviated as FEC, or F1EC), difluoroethylene carbonate (abbreviated as DFEC or F2EC), trifluoroethylene carbonate (abbreviated as F3EC), or tetrafluoroethylene carbonate (abbreviated as F4EC), pentafluoroethylene carbonate (abbreviated as F5EC) or the like can be used. Note that DFEC has isomers such as a cis-4,5 isomer and a trans-4,5 isomer. Each of these fluorinated cyclic carbonates includes a substituent with an electron-withdrawing property and thus is presumed to have a low solvation energy of a lithium ion in an organic solvent using a fluorinated cyclic carbonate.

The structural formula of FEC is shown in (H11) below. The substituent with an electron-withdrawing property in FEC is an F group.

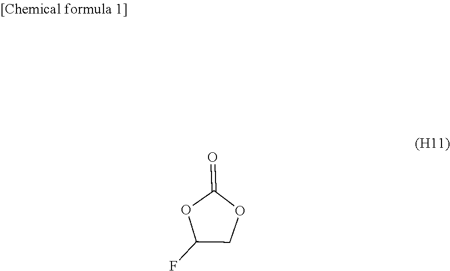

The structural formula of 4-5-difluoroethylene carbonate is shown in (H12) below. The substituent with an electron-withdrawing property in 4,5-difluoroethylene carbonate is an F group.

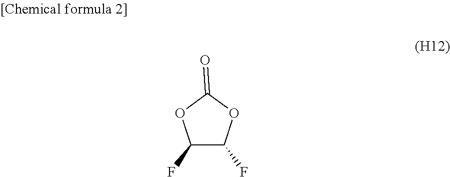

The structural formula of 4,4-difluoroethylene carbonate is shown in (H13) below. In the 4,4-difluoroethylene carbonate, the substituent with an electron-withdrawing property is an F group.

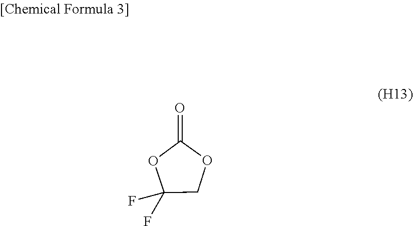

The structural formula of F3EC is shown in (H14) below. The substituent with an electron-withdrawing property in F3EC is an F group.

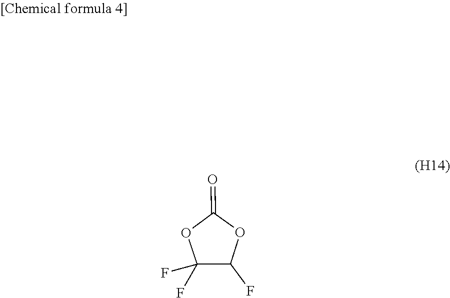

The structural formula of F4EC is shown in (H15) below. The substituent with an electron-withdrawing property in F4EC is an F group.

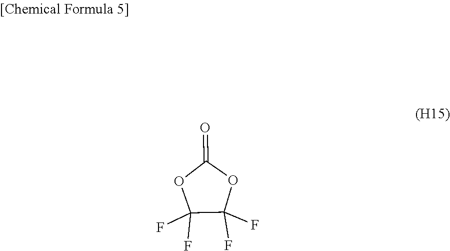

The above-described fluorinated cyclic carbonates may be collectively referred to as cyclic molecules.

An example of the fluorinated chain carbonate is methyl trifluoropropionate, typically methyl 3,3,3-trifluoropropionate. The structural formula of methyl 3,3,3-trifluoropropionate is shown in (H21) below. An abbreviation of methyl 3,3,3-trifluoropropionate is “MTFP”. The substituent with an electron-withdrawing property in MTFP is a CF₃ group.

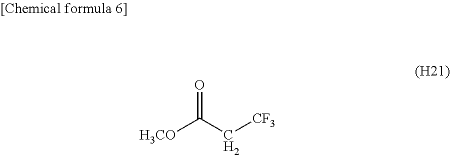

An example of the fluorinated chain carbonate is methyl 2,2-difluoropropionate. The structural formula of methyl 2,2-difluoropropionate is shown in (H22) below. In methyl 2,2-difluoropropionate, the substituent with an electron-withdrawing property is a CF₂ group.

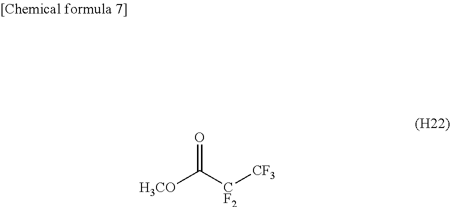 [SMILES: COC(=O)C(F)(F)C(F)(F)F]

An example of the fluorinated chain carbonate is trifluoromethyl propionate. The structural formula of trifluoromethyl propionate is shown in (H23) below. In trifluoromethyl propionate, the substituent with an electron-withdrawing property is a CF₃ group.

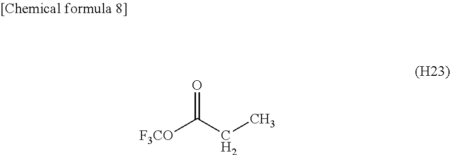

An example of the fluorinated chain carbonate is methyl pentafluoropropionate. The structural formula of methyl pentafluoropropionate is shown in (H24) below. In methyl pentafluoropropionate, the substituent with an electron-withdrawing property is a CF₃ group.

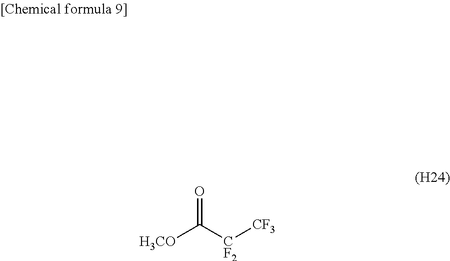 [SMILES: COC(=O)C(F)(F)C(F)(F)F]

An example of the fluorinated chain carbonate is trifluoromethyl 3,3,3-trifluoropropionate. The structural formula of trifluoromethyl 3,3,3-trifluoropropionate is represented by Structural Formula (H25) below. In trifluoromethyl 3,3,3-trifluoropropionate, the substituent with an electron-withdrawing property is a CF₃ group.

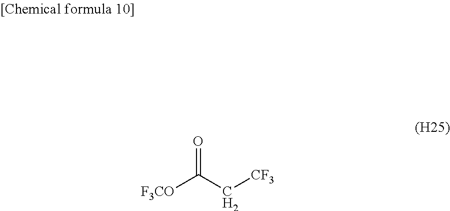 [SMILES: O=C(CC(F)(F)F)OC(F)(F)F]

The above-described fluorinated chain carbonates may be collectively referred to as chain molecules.

The organic solvent preferably contains one or more selected from the above-described fluorinated cyclic carbonates and one or more selected from the above-described fluorinated chain carbonates. A secondary battery having favorable initial characteristics can be provided. Further preferably, an organic solvent containing both FEC and MTFP is used. The reason for that is as follows.

### <FEC and MTFP>

FEC is a cyclic carbonate and has a high dielectric constant. Thus, when FEC is used as the organic solvent, an effect of promoting dissociation of a lithium salt is exhibited. Meanwhile, it can be said that since FEC includes a substituent having an electron-withdrawing property, a lithium ion is desolvated with FEC more easily than with ethylene carbonate (abbreviated as “EC”). Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC is presumed to have a deep highest occupied molecular orbital (HOMO) level and/or a deep lowest unoccupied molecular orbital (LUMO) level. FEC is not easily oxidized owing to its deep HOMO level, which is preferable because FEC enables the electrolyte to have high oxidation resistance. On the other hand, FEC has slightly high viscosity, and in the case where only FEC is used as the organic solvent, there is a concern that the impedance may be increased. In view of this, a mixed organic solvent containing not only FEC but also MTFP is preferably used for the electrolyte solution. MTFP, which is a chain carbonate, exhibits an effect of reducing or maintaining the viscosity. Maintaining the viscosity is required especially when the operating temperature of a secondary battery becomes low, and is important also at room temperature. MTFP also has a substituent with an electron-withdrawing property. Accordingly, MTFP also has a lower solvation energy than methyl propionate (abbreviated as “MP”), which does not have a substituent with an electron-withdrawing property, but may solvate a lithium ion.

The mixing ratio of FEC to MTFP is described. The volume ratio of FEC to MTFP preferably satisfies y:100-y (where 5≤y≤30, preferably 10≤y≤20) with the total content, that is, the total volume of FEC and MTFP, being 100 vol %. In other words, MTFP is preferably contained more than FEC is. An organic solvent in which FEC and MTFP are mixed exhibits viscosity suitable for an electrolyte solution. Accordingly, a secondary battery with favorable initial characteristics can be provided. Moreover, FEC and MTFP can maintain viscosity suitable for the electrolyte solution, so that the secondary battery can have favorable low-temperature characteristics.

The volume ratio is measured before FEC and MTFP are mixed as an organic solvent. Even if volatilization slightly occurs in the mixing, there is no problem as long as favorable initial characteristics can be exhibited. The mixture of the organic solvent is performed at room temperature.

Although FEC is described above as a typical example, it can be said that any of the organic compounds given as the fluorinated cyclic carbonate has an effect of promoting dissociation of a lithium salt, facilitates lithium-ion desolvation, has high viscosity and thus cannot exhibit a suitable viscosity when used alone. Although MTFP is described above as a typical example, it can be said that any of the organic compounds given as the fluorinated chain carbonate has an effect of reducing or maintaining the viscosity of an electrolyte. Therefore, a secondary battery with favorable initial characteristics can be provided as long as the organic solvent contains a fluorinated cyclic carbonate and a fluorinated chain carbonate.

The above-described organic solvent is preferably highly purified and has low contents of dust particles or molecules other than the constituent molecules of the organic solvent (hereinafter also simply referred to as “impurities”, including oxygen (O2), water (H₂O), or moisture). Specifically, the amount of impurities in the electrolyte is at less than or equal to 100 ppm, preferably less than or equal to 50 ppm, further preferably less than 10 ppm. The concentration of moisture can be detected by Karl Fischer titration.

The use of one or more ionic liquids (room temperature molten salts) which have non-flammability and non-volatility as the solvent of the electrolyte solution can prevent a power storage device from exploding, catching fire, and the like even when the power storage device internally short outs or the internal temperature increases owing to overcharging or the like. An ionic liquid includes a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one kind of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more kinds of these lithium salts can be used in an appropriate combination at an appropriate ratio.

The electrolyte solution used for a power storage device is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%. A polymer gel electrolyte in which a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

As the electrolyte, a solid electrolyte including an inorganic material such as a sulfide-based inorganic material or an oxide-based inorganic material, or a solid electrolyte including a high-molecular material such as a PEO (polyethylene oxide)-based high-molecular material can be used. When the solid electrolyte is used, a separator or a spacer is not necessary. Furthermore, the battery can be entirely solidified; therefore, there is no possibility of liquid leakage and thus the safety of the battery is dramatically improved.

Accordingly, the positive electrode active material composite 100α obtained in Embodiment 1 can also be applied to all-solid-state batteries. By using the positive electrode slurry or the electrode in an all-solid-state battery, an all-solid-state battery with high safety and favorable characteristics can be obtained.

### <Additive Agent>

An additive agent is preferably mixed with the organic solvent for the purpose of improving safety or the like. As the additive agent, one or two or more selected from vinylene carbonate (VC), propane sultone (PS), tert-butylbenzene (TBB), fluoroethylene carbonate (FEC), lithium bis(oxalate)borate (LiBOB), SUN (suberonitrile), or a dinitrile compound such as succinonitrile or adiponitrile is/are preferably used. Preferably, the concentration of the additive agent in the whole organic solvent is, for example, higher than or equal to 0.1 wt % and lower than or equal to 5 wt %. The electrolyte of one embodiment of the present invention may not necessarily include any of the above-described additives. An organic compound that is different from the organic solvent is preferably selected as the additive agent.

### [Exterior Body]

For an exterior body included in the secondary battery, a metal material such as aluminum or a resin material can be used, for example. A film-shaped exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The contents described in this embodiment can be combined with any of the contents described in the other embodiments.

### Embodiment 5

In this embodiment, examples of shapes of a plurality of types of secondary batteries including the positive electrode or the negative electrode formed by the formation method described in the above embodiment will be described.

### [Coin-Type Secondary Battery]

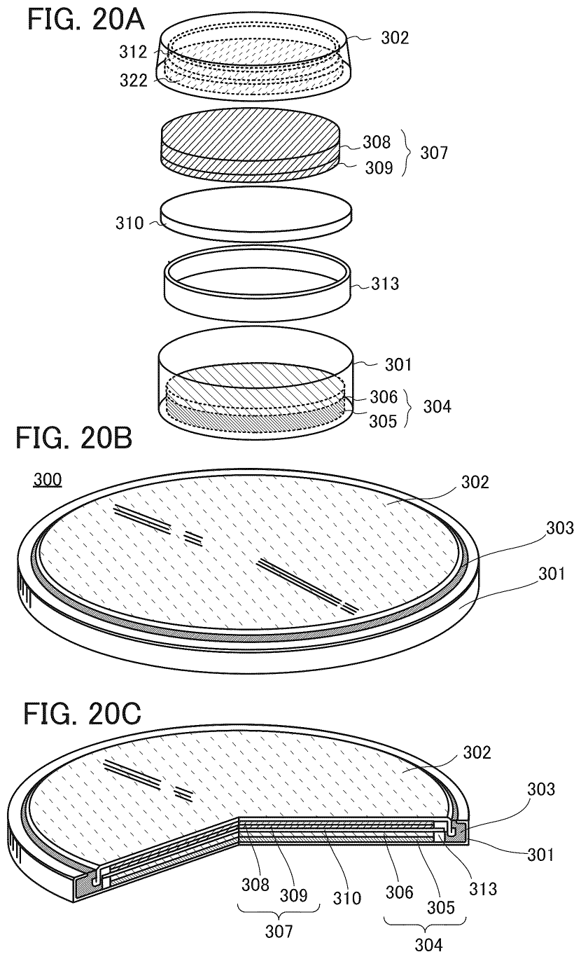

An example of a coin-type secondary battery is described. FIG. 20A is an exploded perspective view of a coin-type (single-layer flat type) secondary battery, FIG. 20B is an external view thereof, and FIG. 20C is a cross-sectional view thereof. Coin-type secondary batteries are mainly used in small electronic devices. In this specification and the like, coin-type batteries include button-type batteries.

For easy viewing, FIG. 20A is a schematic view illustrating overlap (a vertical relation and a positional relation) between components. Thus, FIG. 20A and FIG. 20B do not completely correspond with each other.

In FIG. 20A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 20A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 20B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is preferably provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, and the like in order to prevent corrosion due to the electrolyte, for example. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte solution; as illustrated in FIG. 20C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

With the above structure, the coin-type secondary battery 300 can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

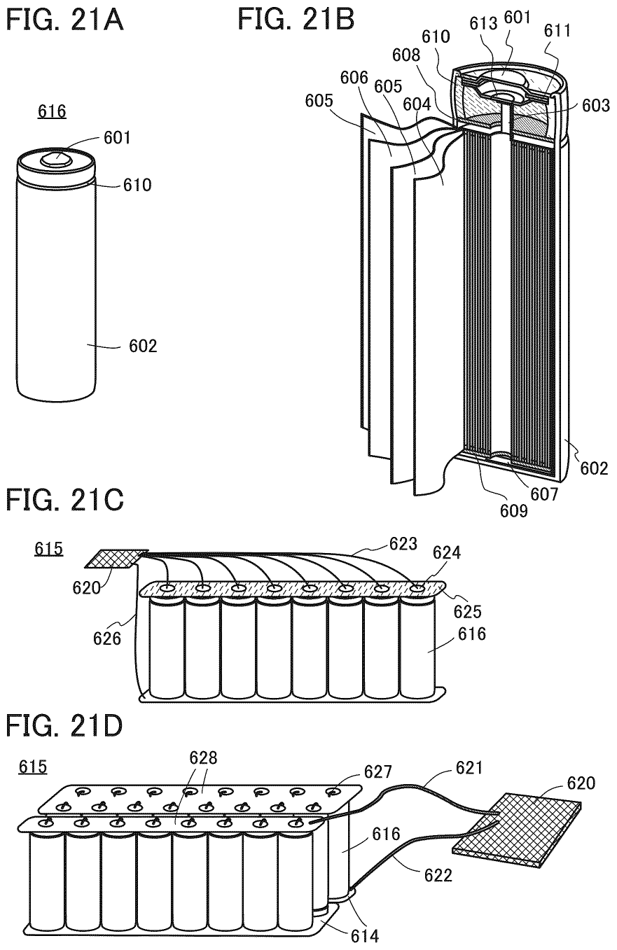

An example of a cylindrical secondary battery is described with reference to FIG. 21A. As illustrated in FIG. 21A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 21B schematically illustrates a cross section of a cylindrical secondary battery. The cylindrical secondary battery illustrated in FIG. 21B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that FIG. 21A to FIG. 21D each illustrate the secondary battery 616 in which the height of the cylinder is larger than the diameter of the cylinder, as a non-limiting example. In a secondary battery, the diameter of the cylinder may be larger than the height of the cylinder. Such a structure can reduce the size of a secondary battery, for example.

The positive electrode active material composite 100α obtained in Embodiment 1 is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. The positive electrode terminal 603 can be formed using a metal material such as aluminum and the negative electrode terminal 607 can be formed using a metal material such as copper. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO3)-based semiconductor ceramic or the like can be used for the PTC element.

FIG. 21C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharging or overdischarging can be used, for example.

FIG. 21D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 21D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

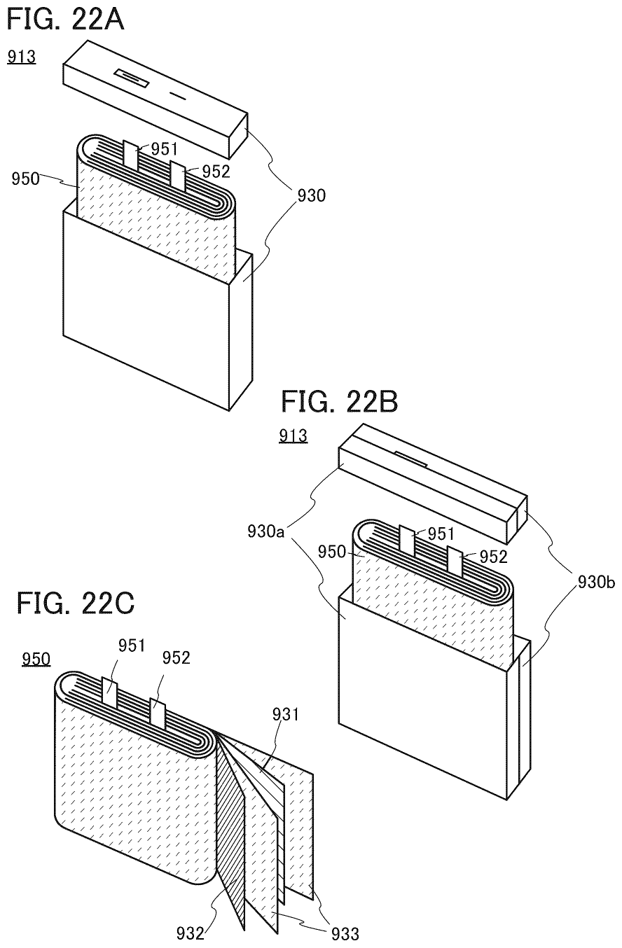

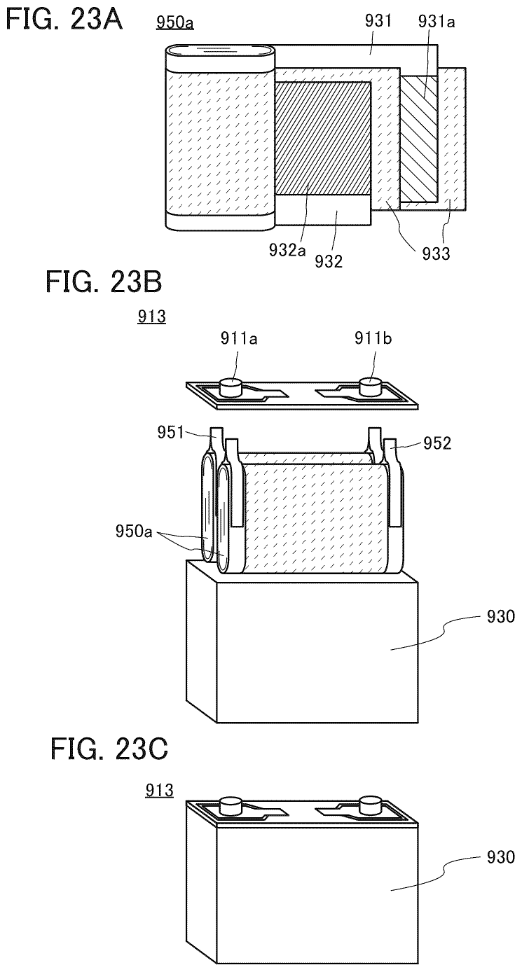

Structure examples of secondary batteries are described with reference to FIG. 22 and FIG. 23.

A secondary battery 913 illustrated in FIG. 22A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 22A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a stack of a metal material and a resin material can be used.

Note that as illustrated in FIG. 22B, the housing 930 illustrated in FIG. 22A may be formed using a plurality of materials. For example, in the secondary battery 913 illustrated in FIG. 22B, a housing 930a and a housing 930b are bonded to each other, and the wound body 950 is provided in a region surrounded by the housing 930a and the housing 930b.

For the housing 930a, a metal material (e.g., aluminum) or a stack of a metal material and a resin material can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material (e.g., aluminum) or a stack of a metal material and a resin material can be used.

Furthermore, FIG. 22C illustrates the structure of the wound body 950. The wound body 950 includes a negative electrode 931, a positive electrode 932, and separators 933. The wound body 950 is obtained by rolling a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 23A to FIG. 23C, the secondary battery 913 may include a wound body 950a. The wound body 950a illustrated in FIG. 23A includes the negative electrode 931, the positive electrode 932, and the separators 933. The negative electrode 931 includes a negative electrode active material layer 931a. The positive electrode 932 includes a positive electrode active material layer 932a.

When the positive electrode active material composite 100α obtained in Embodiment 1 is used for the positive electrode 932, the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 23B, the negative electrode 931 in FIG. 23A is electrically connected to the terminal 951. The terminal 951 is electrically connected to a terminal 911a. The positive electrode 932 in FIG. 23A is electrically connected to the terminal 952. The terminal 952 is electrically connected to a terminal 911b.

As illustrated in FIG. 23C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 23B, the secondary battery 913 may include a plurality of wound bodies 950a. The use of the plurality of wound bodies 950a enables the secondary battery 913 to have higher discharge capacity. The description of the secondary battery 913 illustrated in FIG. 22A to FIG. 22C can be referred to for the other components of the secondary battery 913 illustrated in FIG. 23A and FIG. 23B.

### <Laminated Secondary Battery>

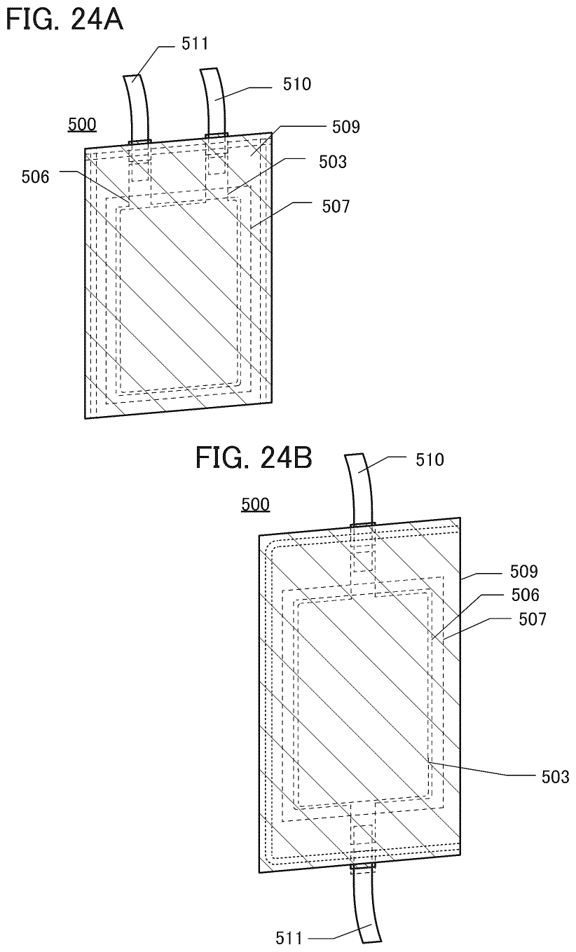

Next, examples of the appearance of a laminated secondary battery are illustrated in FIG. 24A and FIG. 24B. In FIG. 24A and FIG. 24B, a positive electrode 503, a negative electrode 506, a separator 507, an exterior body 509, a positive electrode lead electrode 510, and a negative electrode lead electrode 511 are included.

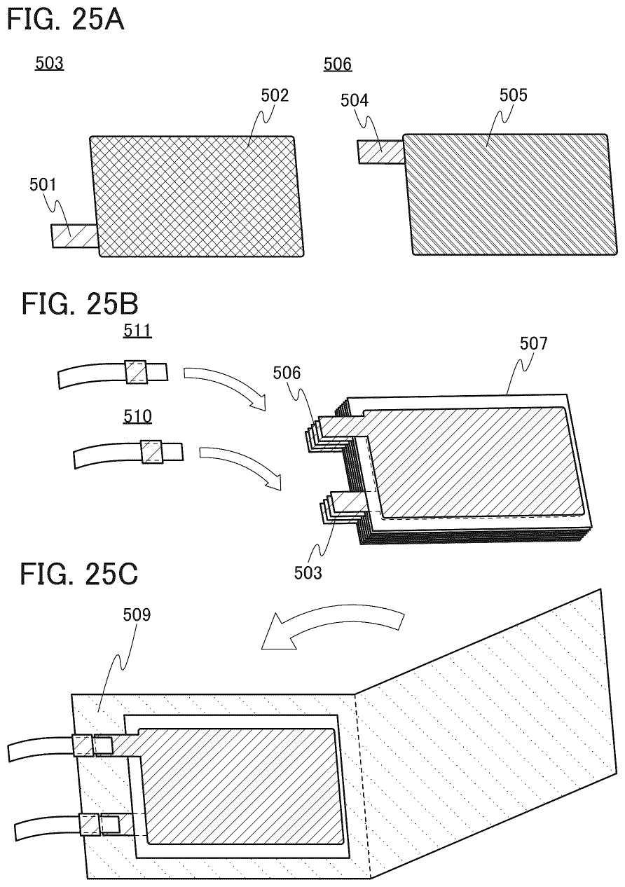

FIG. 25A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 25A.

### <Method for Manufacturing Laminated Secondary Battery>

Here, an example of a method for manufacturing the laminated secondary battery whose external view is illustrated in FIG. 24A is described with reference to FIG. 25A to FIG. 25C.

First, the negative electrode 506, the separator 507, and the positive electrode 503 are stacked. FIG. 25B illustrates the negative electrodes 506, the separators 507, and the positive electrodes 503 that are stacked. Here, an example in which five negative electrodes and four positive electrodes are used is shown. The negative electrode, the separator, and the positive electrode that are stacked can be referred to as a stack. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 25C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated secondary battery 500 can be manufactured.

When the positive electrode active material composite 100α described in Embodiment 1 is used for the positive electrode 503, the secondary battery 500 can have high capacity, high charge and discharge capacity, and excellent cycle performance.

### [Examples of Battery Pack]

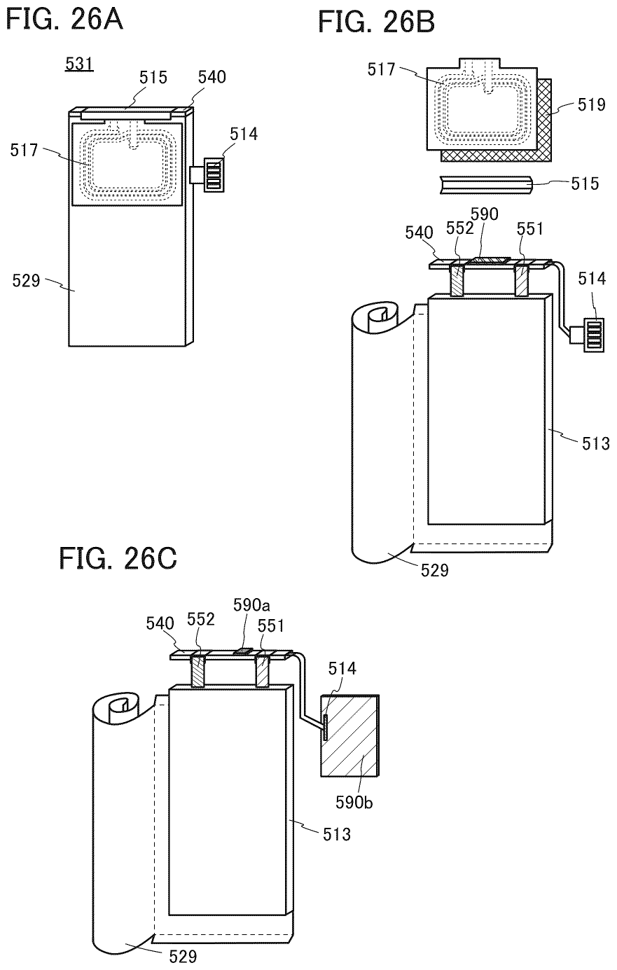

Examples of a secondary battery pack of one embodiment of the present invention that is capable of wireless charging using an antenna are described with reference to FIG. 26A to FIG. 26C.

FIG. 26A is a diagram illustrating the appearance of a secondary battery pack 531 that has a rectangular solid shape with a small thickness (also referred to as a flat plate shape with a thickness). FIG. 26B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 26B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 26C, a circuit system 590a provided over the circuit board 540 and a circuit system 590b electrically connected to the circuit board 540 through the terminal 514 may be included.

Note that the shape of the antenna 517 is not limited to a coil shape and is preferably a linear shape or a plate shape, for example. Furthermore, a planar antenna, an aperture antenna, a traveling-wave antenna, an EH antenna, a magnetic-field antenna, a dielectric antenna, or the like is preferably used. Alternatively, the antenna 517 is preferably a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with any of the contents in the other embodiments.

### Embodiment 6

In this embodiment, an example in which an all-solid-state battery is manufactured using the positive electrode active material composite 100α obtained in Embodiment 1 will be described.

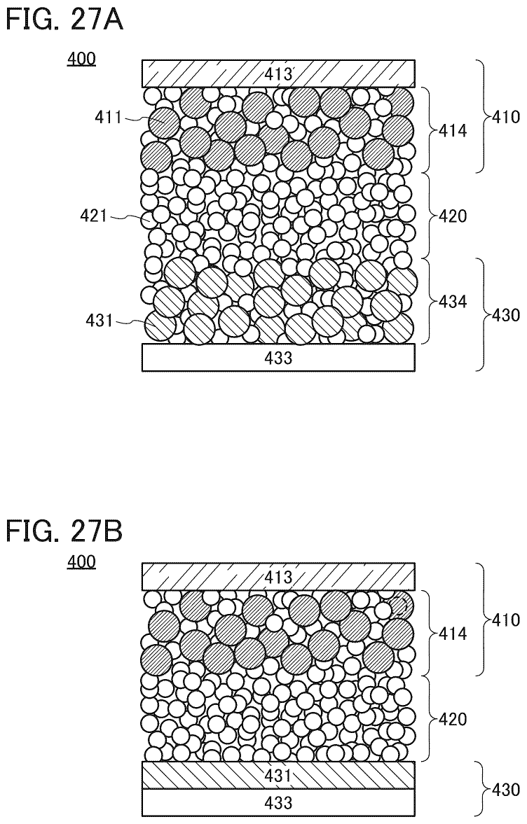

As illustrated in FIG. 27A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active composite 100α obtained in Embodiment 1 is used as the positive electrode active material 411. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used as the negative electrode active material 431, metal lithium does not need to be processed into particles; thus, the negative electrode 430 that does not include the solid electrolyte 421 can be formed, as illustrated in FIG. 27B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity, low-temperature synthesis, and ease of maintaining a path for electrical conduction after charging and discharging because of its relative softness.

The oxide-based solid electrolyte includes a material with a perovskite crystal structure (e.g., La_{2/3-x}Li₃ₓTiO₃), a material with a NASICON crystal structure (e.g., Li_{1-γ}Al_{γ}Ti_{2-γ}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄·50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element that the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

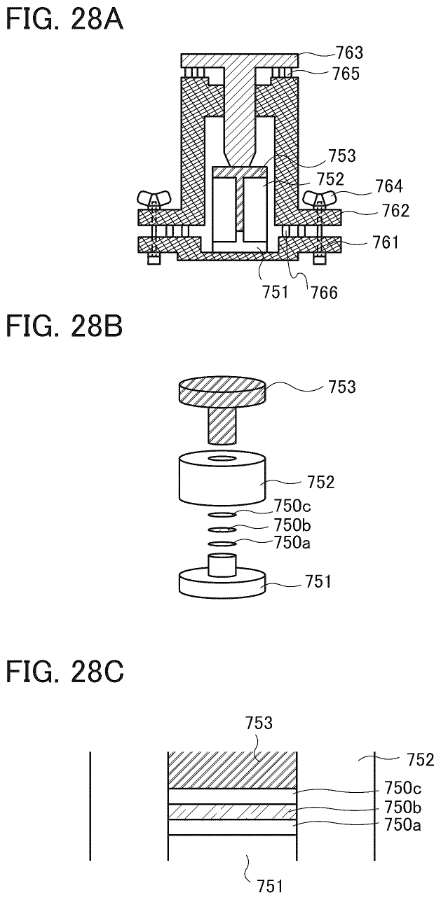

FIG. 28 illustrates an example of a cell for evaluating materials of an all-solid-state battery, for example.

FIG. 28A is a cross-sectional schematic view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 28B is an enlarged perspective view of the evaluation material and its vicinity.

A stack of a positive electrode 750a, a solid electrolyte layer 750b, and a negative electrode 750c is illustrated here as an example of the evaluation material, and its cross-sectional view is illustrated in FIG. 28C. Note that the same portions in FIG. 28A to FIG. 28C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

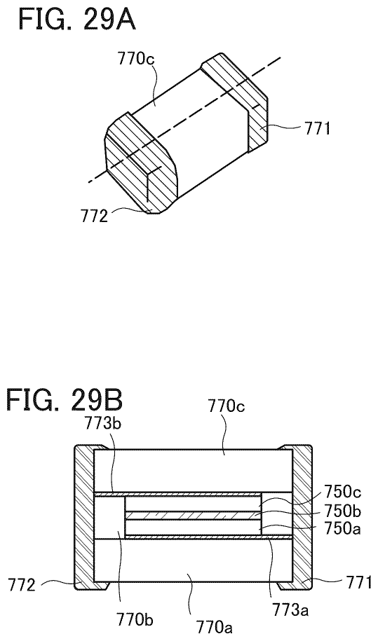

FIG. 29A illustrates a perspective view of a secondary battery of one embodiment of the present invention that has an exterior body and a shape different from those in FIG. 28. The secondary battery in FIG. 29A includes external electrodes 771 and 772 and is sealed with an exterior body including a plurality of package components.

FIG. 29B illustrates an example of a cross section along the dashed-dotted line in FIG. 29A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and ceramics, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material composite 100α obtained in Embodiment 1 can achieve an all-solid-state secondary battery having a high energy density and favorable output characteristics.

The contents in this embodiment can be combined with any of the contents in the other embodiments as appropriate.

### Embodiment 7

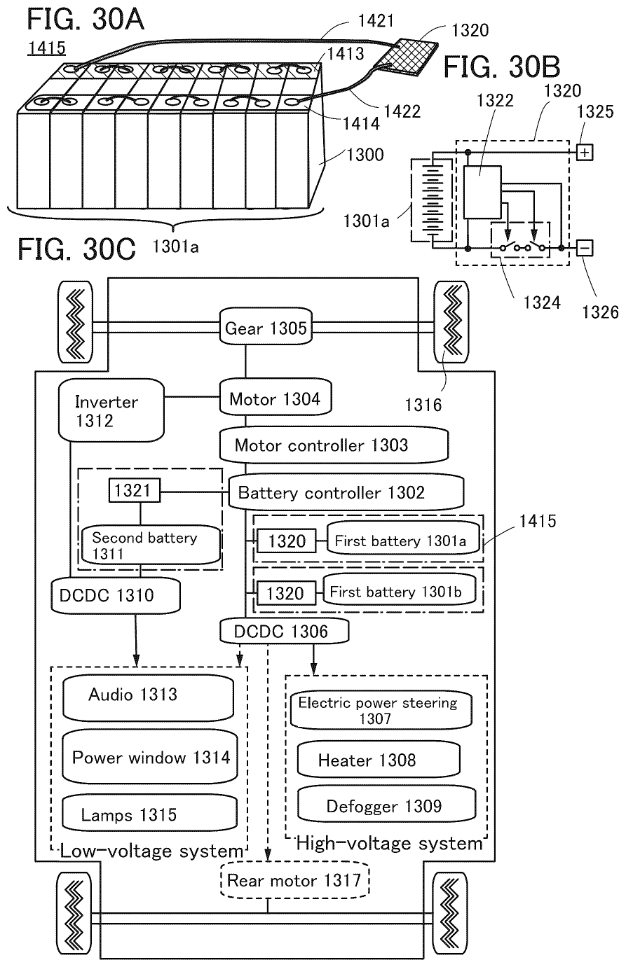

This embodiment will describe an example different from the cylindrical secondary battery in FIG. 21D. An example of application to an electric vehicle (EV) will be described with reference to FIG. 30C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and does not need high capacity so much; the capacity of the second battery 1311 is lower than those of the first batteries 1301a and 1301b.

The internal structure of the first battery 1301a may be the wound structure illustrated in FIG. 22A or FIG. 23C. Alternatively, the first battery 1301a may be an all-solid-state battery in Embodiment 5. The use of the all-solid-state battery in Embodiment 5 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The service plug or the circuit breaker is provided for the first battery 1301a.

Electric power from the first batteries 1301a and 1301b is mainly used to rotate the motor 1304 and is supplied to 42-V system in-vehicle parts (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to 14-V system in-vehicle parts (such as a stereo 1313, a power window 1314, and lamps 1315) through a DCDC circuit 1310.

The first battery 1301a will be described with reference to FIG. 30A.

FIG. 30A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

FIG. 30B illustrates an example of a block diagram of the battery pack 1415 illustrated in FIG. 30A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to 42-V system (high-voltage system) in-vehicle devices, and the second battery 1311 supplies electric power to 14-V system (low-voltage system) in-vehicle devices.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 5 may be used. The use of the all-solid-state battery in Embodiment 5 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection with an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, the connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, and a three-phase 200 V outlet with 50 kW, for example. Furthermore, charging can be performed with electric power supplied from external charge equipment by a contactless power feeding method or the like.

For fast charging, secondary batteries that can withstand high-voltage charging have been desired to perform charging in a short time.

The above-described secondary battery in this embodiment uses the positive electrode active material composite 100α obtained in Embodiment 1. Moreover, it is possible to achieve a secondary battery in which graphene is used as a conductive material, an electrode layer is formed thick to increase the loading level while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, as the above-described secondary battery in this embodiment, the use of the positive electrode active material composite 100α described in Embodiment 1 can increase the operating voltage of the secondary battery, and the increase in charge voltage can increase the available capacity. Moreover, using the positive electrode active material composite 100α described in Embodiment 1 in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery described in the above embodiment on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

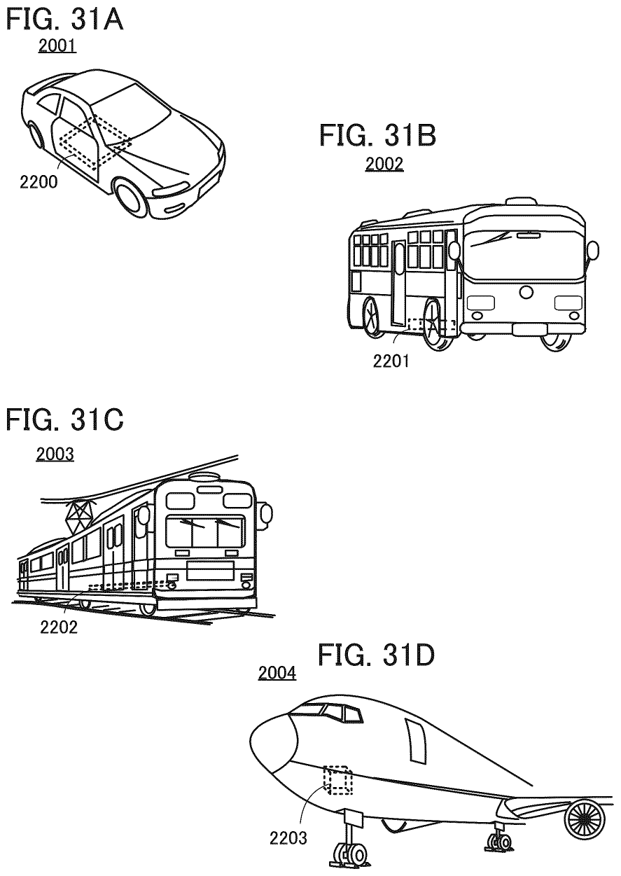

FIG. 31A to FIG. 31D illustrate examples of transport vehicles using one embodiment of the present invention. A motor vehicle 2001 illustrated in FIG. 31A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 4 is provided at one position or several positions. The motor vehicle 2001 illustrated in FIG. 31A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system, a contactless charge system, or the like. In charging, a given method such as CHAdeMO (registered trademark) or Combined Charging System may be employed as a charge method, the standard of a connector, and the like as appropriate. A charge device is preferably a charge station provided in a commerce facility or a power source in a house. For example, with use of the plug-in system, a power storing device mounted on the motor vehicle 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 31B illustrates a large transporter 2002 having a motor controlled by electricity as an example of a transport vehicle. The secondary battery module of the transporter 2002 has a cell unit of four secondary batteries with a nominal voltage of 3.0 V or higher and 5.0 V or lower, and 48 cells are connected in series to have a maximum voltage of 170 V. A battery pack 2201 has the same function as that in FIG. 31A except, for example, the number of secondary batteries configuring the secondary battery module; thus, the description is omitted.

FIG. 31C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and a maximum voltage is 600 V, for example. When a secondary battery including the positive electrode active material composite 100α described in Embodiment 1 for a positive electrode is used, a secondary battery having favorable rate performance and charge and discharge cycle performance can be manufactured, which can contribute to higher performance and a longer lifetime of the transport vehicle 2003. A battery pack 2202 has the same function as that in FIG. 31A except, for example, the number of secondary batteries configuring the secondary battery module; thus, the description is omitted.

FIG. 31D illustrates an aircraft 2004 having a combustion engine as an example. The aircraft 2004 illustrated in FIG. 31D can be regarded as a kind of transport vehicles since it is provided with wheels for takeoff and landing. The aircraft 2004 has a battery pack 2203 including a secondary battery module and a charge control device; the secondary battery module includes a plurality of connected secondary batteries.

The secondary battery module of the aircraft 2004 has eight 4 V secondary batteries connected in series, which has a maximum voltage of 32 V, for example. The battery pack 2203 has the same function as that in FIG. 31A except, for example, the number of secondary batteries configuring the secondary battery module; thus, the description is omitted.

The contents in this embodiment can be combined with any of the contents in the other embodiments as appropriate.

### Embodiment 8

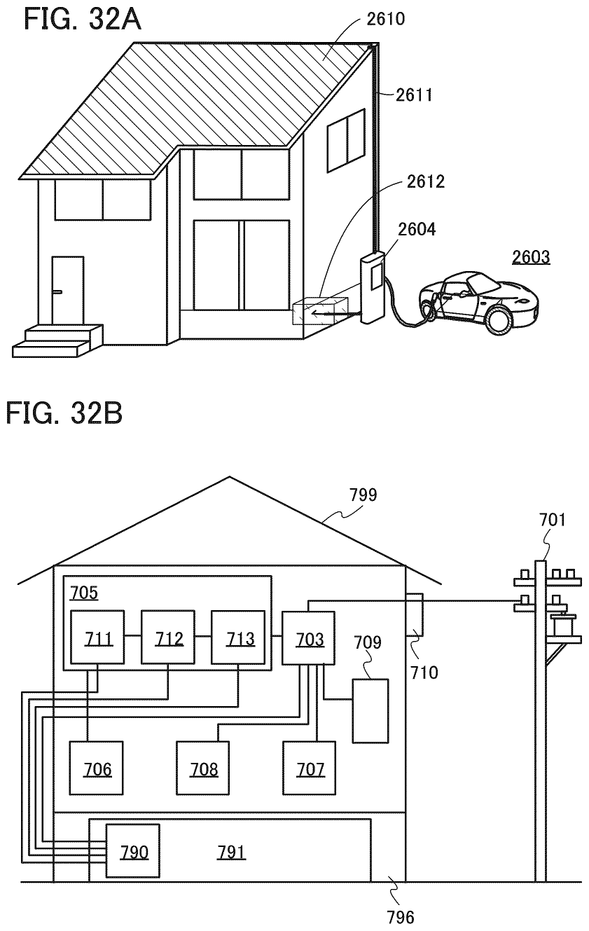

In this embodiment, examples in which the secondary battery of one embodiment of the present invention is mounted on a building will be described with reference to FIG. 32A and FIG. 32B.

A house illustrated in FIG. 32A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, using the power storage device 2612 of one embodiment of the present invention as an uninterruptible power source enables electronic devices to used even when electric power cannot be supplied from a commercial power source due to power failure or the like.

FIG. 32B illustrates an example of a power storage device of one embodiment of the present invention. As illustrated in FIG. 32B, a power storage device 791 of one embodiment of the present invention is provided in an underfloor space 796 of a building 799. The power storage device 791 may be provided with a control circuit, and by using, for the power storage device 791, a secondary battery including a positive electrode using the positive electrode active material composite 100α obtained in Embodiment 1, the power storage device 791 can have a long lifetime.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

The contents in this embodiment can be combined with any of the contents in the other embodiments as appropriate.

### Embodiment 9

In this embodiment, examples in which a vehicle such as a motorcycle and a bicycle is provided with the power storage device of one embodiment of the present invention will be described.

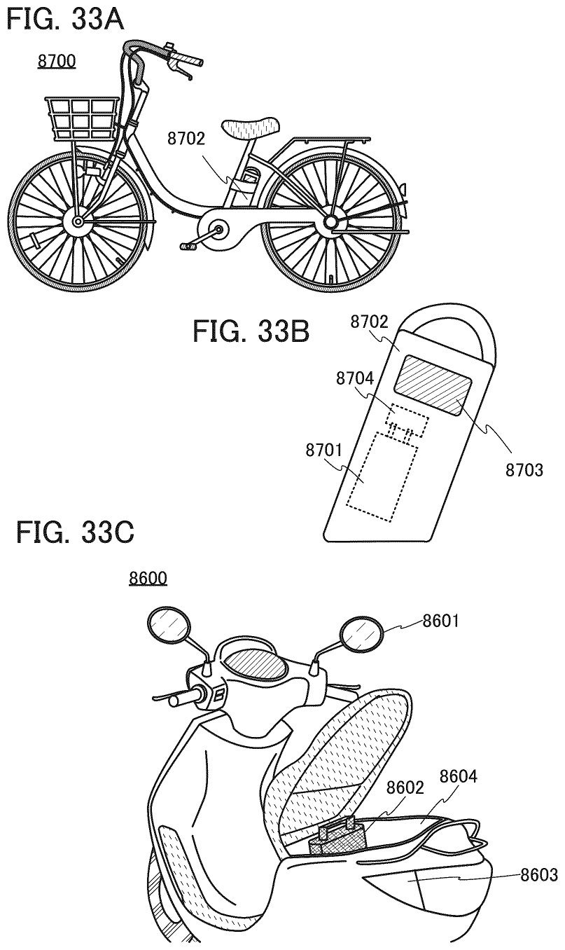

FIG. 33A illustrates an example of an electric bicycle using the power storage device of one embodiment of the present invention. The power storage device of one embodiment of the present invention can be used for an electric bicycle 8700 illustrated in FIG. 33A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 33B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may be provided with the small solid-state secondary battery illustrated in FIG. 30A and FIG. 30B. When the control circuit 8704 is used in combination with a secondary battery including a positive electrode using the positive electrode active material composite 100α obtained in Embodiment 1, the synergy on safety can be obtained. The secondary battery including the positive electrode active material composite 100α obtained in Embodiment 1 in the positive electrode and the control circuit 8704 can greatly contribute to elimination of accidents due to secondary batteries, such as fires.

FIG. 33C illustrates an example of a motorcycle using the power storage device of one embodiment of the present invention. A motor scooter 8600 illustrated in FIG. 33C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material composite 100α obtained in Embodiment 1 can have high capacity and contribute to a reduction in size.

In the motor scooter 8600 illustrated in FIG. 33C, the power storage device 8602 can be stored in an under-seat storage unit 8604. The power storage device 8602 can be stored in the under-seat storage unit 8604 even when the under-seat storage unit 8604 is small.

The contents in this embodiment can be combined with any of the contents in the other embodiments as appropriate.

### Embodiment 10

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

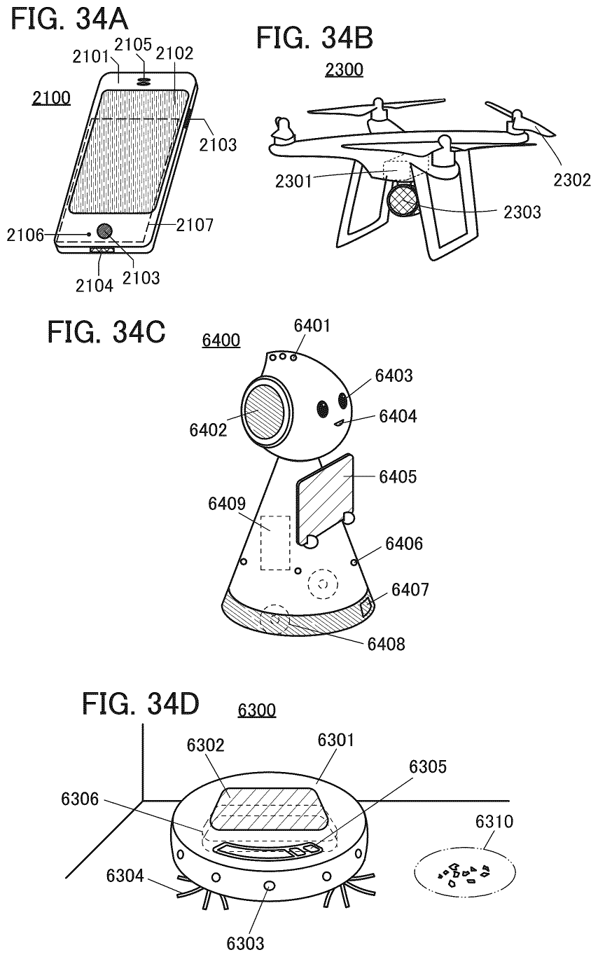

FIG. 34A shows an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material composite 100α described in Embodiment 1 has high capacity and can have a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by an operating system incorporated in the mobile phone 2100.

The mobile phone 2100 can employ near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 34B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material composite 100α obtained in Embodiment 1 has high energy density and high safety, and thus can be used safely for a long time over a long period of time and is preferable as the secondary battery included in the unmanned aircraft 2300.

FIG. 34C illustrates an example of a robot. A robot 6400 illustrated in FIG. 34C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material composite 100α obtained in Embodiment 1 has high energy density and high safety, and thus can be used safely for a long time over a long period of time and is preferable as the secondary battery 6409 included in the robot 6400.

FIG. 34D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material composite 100α obtained in Embodiment 1 has high energy density and high safety, and thus can be used safely for a long time over a long period of time and is preferable as the secondary battery 6306 included in the cleaning robot 6300.

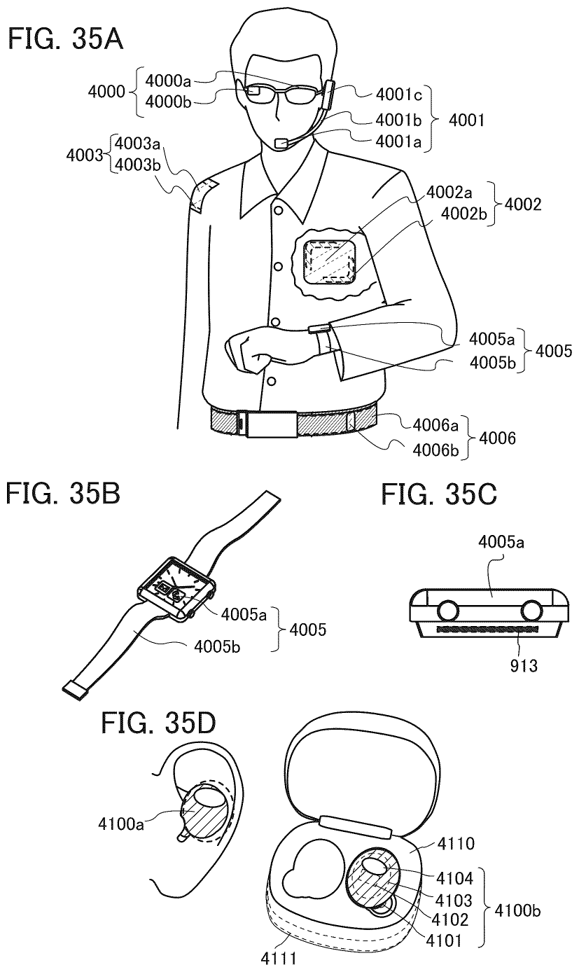

FIG. 35A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 35A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material composite 100α obtained in Embodiment 1 has high energy density and can have a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material composite 100α obtained in Embodiment 1 has high energy density and can have a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material composite 100α obtained in Embodiment 1 has high energy density and can have a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material composite 100α obtained in Embodiment 1 has high energy density and can have a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material composite 100 obtained in Embodiment 1 has high energy density and can have a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material composite 100α obtained in Embodiment 1 has high energy density and can have a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 35B illustrates a perspective view of the watch-type device 4005 that is detached from an arm.

FIG. 35C is a side view. FIG. 35C illustrates a state where the secondary battery 913 is incorporated in the inner region. The secondary battery 913 is the secondary battery described in Embodiment 4. The secondary battery 913 is provided to overlap with the display portion 4005a, can have high density and high capacity, and is small and lightweight.

Since the secondary battery in the watch-type device 4005 is required to be small and lightweight, the use of the positive electrode active material composite 100α obtained in Embodiment 1 in the positive electrode of the secondary battery 913 enables the secondary battery 913 to have high energy density and a small size.

FIG. 35D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material composite 100α obtained in Embodiment 1 has a high energy density; thus, with use of the secondary battery as the secondary battery 4103 and the secondary battery 4111, a structure that accommodates space saving due to a reduction in size of the wireless earphones can be obtained.

This embodiment can be implemented in appropriate combination with any of the other embodiments.

### Example 1

In this example, the characteristics of each sample were measured. Samples were fabricated as follows.

### <Formation of Samples A and B>

As the first positive electrode active material 100x, commercially available lithium cobalt oxide containing no additive element (Cellseed C-10N produced by NIPPON CHEMICAL INDUSTRIAL CO., LTD., hereinafter referred to as “C-10N”) was prepared. As the second positive electrode active material 100y, commercially available lithium iron phosphate (EQ-Lib-LFPO(KJ-2) produced by MTI Corporation, hereinafter referred to as “LFP”) was prepared.

As the positive electrode active material composite 100x, a sample A in which the above-described C-10N:LFP satisfies 80:20 (weight ratio) and a sample B in which the above-described C-10N:LFP satisfies 90:10 (weight ratio) were fabricated. Kneading was performed as the mixing condition as described later. The conditions of the samples A and B are shown together below.

TABLE 1

| | | | First positive electrode active |
|---|---|---|---|
| | First positive | Second positive | material:Second positive |
| | electrode active | electrode active | electrode active material |
| | material | material | (Weight ratio) |
| Sample A | C-10N | LFP | 80:20 |
| Sample B | | | 90:10 |

### <Formation of Positive Electrodes A and B>

The samples A and B described above were prepared as positive electrode active materials, acetylene black (AB) was prepared as a conductive material, and poly(vinylidene fluoride) (PVDF) was prepared as a binding agent. The PVDF prepared was one dissolved in N-methyl-2-pyrrolidone (NMP) with the weight proportion of PVDF to NMP being 5%. Then, the positive electrode active material, AB, and PVDF were mixed at a weight ratio of 95:3:2 to form a slurry, and kneading was performed.

### <Kneading Step>

The kneading step is specifically described below. First, PVDF dissolved in NMP and AB were kneaded under a stirring condition of 2000 rpm for 3 minutes in a kneading apparatus, whereby a mixture A was formed. After that, the sample A was added to the mixture A, and the mixture was kneaded under a stirring condition of 2000 rpm for 3 minutes in a kneading apparatus, whereby a mixture B was formed. Furthermore, PVDF dissolved in NMP and NMP were added to the mixture B, and the mixture was kneaded under a stirring condition of 2000 rpm for 3 minutes in a kneading apparatus, whereby a mixture C was formed. Note that the NMP was added to obtain an appropriate viscosity of the mixture C. Through this kneading steps, slurry A was obtained. Furthermore, the sample B was used instead of the sample A, and thus slurry B was obtained.

The slurry A was applied to a positive electrode current collector of aluminum, and the slurry was dried at 80 °C for one hour to volatilize NMP. After that, the positive electrode A was completed by pressing under a linear pressure of 210 kN/m. The slurry B was also applied to a positive electrode current collector of aluminum, and the slurry was dried at 80 °C for one hour to volatilize NMP. After that, the positive electrode B was completed by pressing under a linear pressure of 210 kN/m. Note that the loading level of the positive electrode active material in each of the positive electrode A and the positive electrode B was approximately 21 mg/cm².

### <Fabrication of Coin Cells A and B>

A coin cell A (CR2032 type with a diameter of 20 mm and a height of 3.2 mm) was fabricated using the positive electrode A obtained above, a lithium metal foil, an electrolyte solution, a separator, a positive electrode can, and a negative electrode can. Similarly, a coin cell B (CR2032 type with a diameter of 20 mm and a height of 3.2 mm) was fabricated using the positive electrode B, a lithium metal foil, a separator, an electrolyte solution, a positive electrode can, and a negative electrode can.

As the electrolyte solution, a mixed solvent of ethylene carbonate (EC) and diethyl carbonate (DEC) at a volume ratio of 3:7 was used. Lithium hexafluorophosphate (LiPF₆) was used as a lithium salt in the electrolyte solution. The lithium salt was adjusted to be 1 mol/L in the mixed solvent. As the separator, polypropylene was used. As the positive electrode can and the negative electrode can, stainless steel (SUS) was used.

### <DSC Test>

As pretreatment for the DSC test, aging was performed on coin cells A and B placed in a thermostatic unit set at 25 °C. The aging conditions are shown below.

### <Aging Conditions>

Charging: CCCV, 0.1 C, 4.3 V, 0.005 C cutoff
Discharging: CC, 0.1 C, 2.5 V cutoff
The amount of current corresponding to 1 C: 200 mA/g per weight of the positive electrode active material
The number of repetition times of charging and discharging: two

In this example, the total weight of the first positive electrode active material and the second positive electrode active material is regarded as the weight of the positive electrode active material.

After the aging, DSC was measured. The charge conditions at the time of the DSC measurement are shown below.
Charging: CCCV, 0.1 C, 4.6 V, 0.005 C cutoff

Next, a sample for measuring DSC was fabricated. First, the coin cell A and the coin cell B in charged states were each disassembled in a glove box with an argon atmosphere to take out the positive electrode A and the positive electrode B, and the positive electrodes were washed with DMC to remove the electrolyte solution. Then, the positive electrode A and the positive electrode B taken out were each stamped out to 3 mmφ.

After the positive electrode A and the positive electrode B stamped out were put in respective stainless steel containers, 1.5 μL of an electrolyte solution was dripped thereto. The lithium salt was prepared under the same condition as that used for the coin cells. Then, zirconium oxide balls with a diameter of 2 mm were put on the positive electrode in the above stainless steel container. Putting zirconium oxide balls has an effect of inhibiting the above positive electrode from being detached from the bottom surface of the container. After that, a stainless steel lid was put on the container to seal off the container.

### <DSC Measurement>

For DSC measurement, a high-sensitive differential scanning calorimeter, Rigaku Thermo plus EVO2 DSC8231, was used. For the measurement conditions, the temperature range was from room temperature to 400 °C, and the temperature rise rate was 5 °C/min.

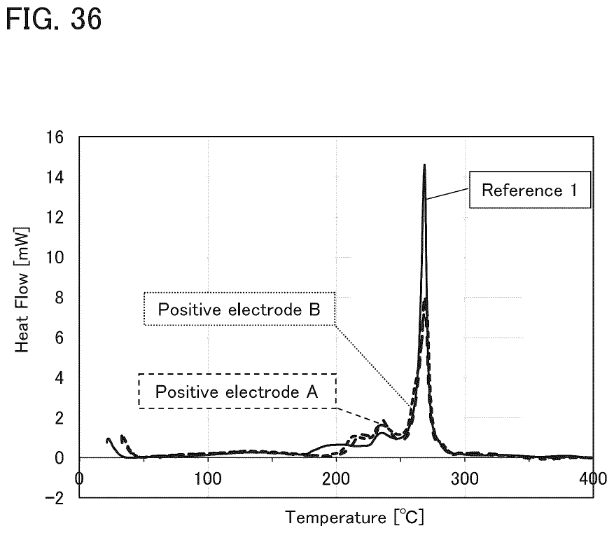

FIG. 36 is a DSC measurement graph. The horizontal axis represents Temperature, and the vertical axis represents Heat Flow. Note that as background removal processing, the DSC measurement graph is subjected to correction in which a straight line with a measurement value at around 50 °C as a starting point and a measurement value at around 390 °C as an end point was set as a base line. The temperature around 50 °C is higher than or equal to 45 °C and lower than or equal to 55 °C, and the temperature around 390 °C is higher than or equal to 385 °C and lower than or equal to 395 °C.

Reference 1 in FIG. 36 is a positive electrode including C-10N (referred to as Reference 1). As shown in FIG. 36, the maximum peaks in the positive electrodes in the 4.6-V charged state were 269.4 °C for the positive electrode A including the sample A, 269.7 °C for the positive electrode B including the sample B, and 269.0 °C for the reference 1 including C-10N. Although the positive electrode A and the positive electrode B have no difference in the temperatures corresponding to the maximum peaks from that of the reference 1, they have smaller areas of the regions having the maximum peaks.

The DSC measurement shows that the addition of LFP improves thermal stability. It is also shown that as the proportion of LFP increases, thermal stability increases.

### <Charge and Discharge Test>

The coin cell A and the coin cell B were prepared again and subjected to charge and discharge tests. In the charge and discharge test, the loading levels of the positive electrode active materials (i.e., the positive electrode active material composites) in the coin cells were approximately 7 mg/cm². As a charge-discharge measuring instrument, a charge-discharge measuring system (TOSCAT-3000) manufactured by TOYO SYSTEM Co., LTD. was used.

Without performing aging, a charge and discharge test was performed on coin cells respectively including the coin cell A, the coin cell B, and the coin cell including C-10N (referred to as Reference 1) placed in a thermostatic device set at 25 °C or 45 °C under the following conditions. The charge and discharge test conditions are shown below.
Charging: CCCV charging, 0.5 C rate, 4.6 V, 0.05 C cutoff
Discharging: CC discharging, 0.5 C rate, 2.5 V cutoff
The amount of current corresponding to 1 C: 200 mA/g per weight of the positive electrode active material
The number of repetition times of charging and discharging: 50
Break period: 10 minutes
Cutoff time: 3 hours

The break period refers to a period during which charging and discharging are not performed from the end of charging until the start of the next discharging. The cutoff time refers to a condition where charging is terminated at a predetermined time in the case where current does not reach the cutoff current of the charge condition after the predetermined time has elapsed. The 4.6 V in the charge condition is referred to as the upper limit voltage, and in the period of the CV charging, the voltage is held at the upper limit voltage. The 2.5 V in the discharge condition is referred to as the lower limit voltage.

### <Charge Capacity and Discharge Capacity>

In the charge and discharge cycle test, current is measured with a charge-discharge measuring instrument and measured currents are used as charge capacity and discharge capacity. In charge and discharge measurement, current flowing through the secondary battery is measured by a four-terminal method. In charging, electrons flow from a positive electrode terminal to a negative electrode terminal through the charge-discharge measuring instrument and thus, a charge current flows from the negative electrode terminal to the positive electrode terminal through the charge-discharge measuring instrument. In discharging, electrons flow from the negative electrode terminal to the positive electrode terminal through the charge-discharge measuring instrument and thus, a discharge current flows from the positive electrode terminal to the negative electrode terminal through the charge-discharge measuring instrument. The charge current and the discharge current are measured with an ammeter included in the charge-discharge measuring instrument. The accumulated amount of electric charge flowing in one cycle of charging corresponds to the charge capacity. The accumulated amount of electric charge flowing in one cycle of discharging corresponds to the discharge capacity. For example, the accumulated amount of the discharge current flowing in the first cycle of discharging can be regarded as the discharge capacity in the first cycle, and the accumulated amount of the discharge current flowing in the 50th cycle of discharging can be regarded as the discharge capacity in the 50th cycle. The discharge capacity is converted to a discharge capacity per weight of the positive electrode active material, and a higher discharge capacity is more desirable as a battery characteristic. The charge capacity is also converted to a charge capacity per weight of the positive electrode active material.

### <Discharge Capacity Retention Rate>

The discharge capacity retention rate (%) in the n-th cycle was calculated by (the discharge capacity in the n-th cycle/the maximum value of the discharge capacity in the first cycle to the n-th cycle)×100. In the formula, n is a natural number excluding zero, and n=50 in this example. A higher discharge capacity retention rate after 50 cycles is desirable as a battery characteristic because a reduction in battery capacity after repeated charging and discharging is inhibited.

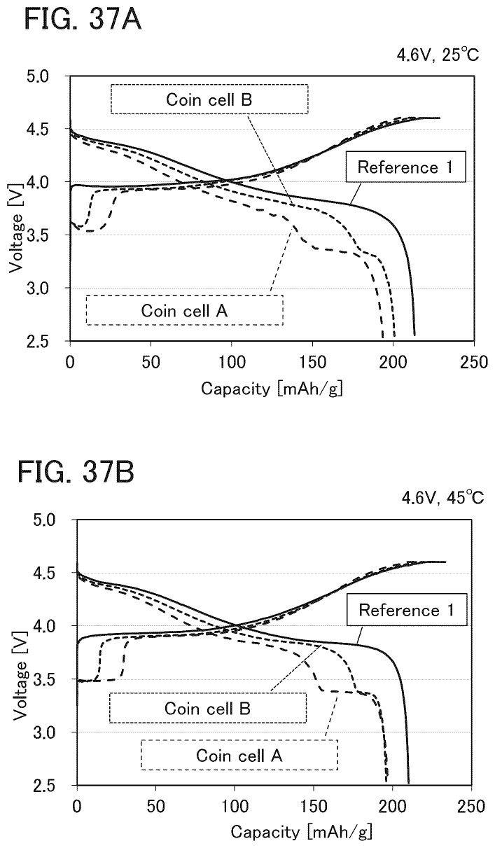

FIG. 37A is a graph showing charge curves and discharge curves (referred to as charge and discharge curves) in the first cycle at 25 °C. The horizontal axis of the graph represents capacity (mAh/g), the charge capacity is shown with the charge curve, and the discharge capacity is shown with the discharge curve. The vertical axis of the graph represents voltage (V), and the discharge voltage and the charge voltage are shown. FIG. 37B is a graph showing charge and discharge curves in the first cycle at 45 °C.

FIG. 37A is a graph showing charge curves and discharge curves (referred to as charge and discharge curves) in the first cycle at 25 °C. The horizontal axis of the graph represents capacity (mAh/g), the charge capacity is shown with the charge curve, and the discharge capacity is shown with the discharge curve. The vertical axis of the graph represents voltage (V), and the discharge voltage and the charge voltage are shown. FIG. 37B is a graph showing charge and discharge curves in the first cycle at 45 °C.

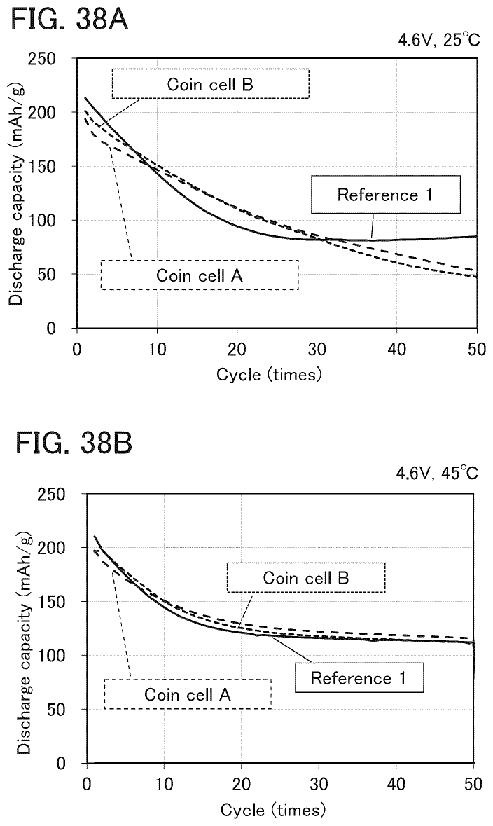

FIG. 38A is a graph of a cycle test at 25 °C. The horizontal axis of the graph represents the number of cycles (times) and the vertical axis represents discharge capacity (mAh/g). FIG. 38B is a graph of a cycle test at 45 °C.

These results show that the discharge capacity decreased when LFP was added to C-10N. It is also shown that the discharge capacity retention rate slightly decreased when LFP was added to C-10N.

### <Laminate Cell>

Laminate cells for a nail penetration test were prepared next.

### <Preparation of Positive Electrode>

As positive electrode active materials of the laminated cells, the sample A and the sample B described above were prepared again. Positive electrodes of the laminated cells were prepared under the same conditions as those for the positive electrodes A and B. As the positive electrodes of the laminate cells, double-side coated positive electrodes were prepared (where slurry was applied on both surfaces of the positive electrode current collectors). For the cell A, 16 double-side coated positive electrodes A were prepared, and for the cell B, 17 double-side coated positive electrodes B were prepared.

### <Formation of Negative Electrode>

The negative electrode of the laminated cell was formed as follows. As the negative electrode active material, a carbon material, specifically, spherical natural graphite with a median diameter (D50) of 20.9 μm and a specific surface area of 1.01 m²/g (FormulaBT 1520, manufactured by Superior Graphite) was prepared. The specific surface area is a value measured by a BET method. SBR and CMC were prepared as a binder and a thickener, respectively. Carbon fiber (VGCF (registered trademark) manufactured by SHOWA DENKO K.K.) was prepared as a conductive material. Then, slurry mixed at spherical natural graphite:VGCF:CMC:SBR=97:1:1:1 (weight ratio) was manufactured. As a solvent of the slurry, water was used. The slurry was applied to a copper negative electrode current collector, and then the solvent was volatilized. The thickness of the copper negative electrode current collector was 18 μm.

After that, pressing treatment was performed with a roller press machine to increase the density of the negative electrode active material layer after the solvent was volatilized. As a pressing treatment condition, a linear pressure was 28 KN/m, which was lower than the linear pressure for the positive electrode.

As negative electrodes of the laminate cells, double-side coated negative electrodes (where slurry was applied on both surfaces of the negative electrode current collector) and single-side coated negative electrodes (where slurry was applied on one surface of the negative electrode current collector) were prepared. For the laminated cell A, 15 double-side coated negative electrodes and two single-side coated negative electrodes were prepared. For the laminated cell B, 16 double-side coated negative electrodes and two single-side coated negative electrodes were prepared. These negative electrodes were alternately placed with the positive electrode A or the positive electrode B to form a stack. The single-side coated negative electrodes were placed as an outer surface of the stack.

Through the above process, the negative electrodes were obtained.

### <Separator, Electrolyte Solution>

For separators of the laminate cells, polypropylene was used. As electrolyte solutions of the laminate cells, a mixed solvent of ethylene carbonate (EC) and diethyl carbonate (DEC) at a volume ratio of 3:7 was used. Lithium hexafluorophosphate (LiPF₆) was used as a lithium salt in the electrolyte solution. The lithium salt was adjusted to be 1 mol/L in the mixed solvent.

### <Exterior Body>

As exterior bodies of the laminate cells, an aluminum laminated film was used. The aluminum laminate film includes first polypropylene (also referred to as PP and with a thickness of 22.5 μm), second polypropylene (with a thickness of 22.5 μm), aluminum foil (with a thickness of 40 μm), and nylon (with a thickness of 25 μm) in this order from the inside of the exterior body. The first polypropylene includes a region in contact with the single-side coated negative electrode, specifically, the negative electrode current collector. Furthermore, nylon is positioned as the outermost surface of the exterior body.

### <Fabrication of Laminate Cells for Nail Penetration Test>

A laminate cell A was fabricated using the above positive electrode A, the above negative electrode, the electrolyte solution, the separator, and the exterior body. A laminated cell B was fabricated using the positive electrode B in place of the positive electrode A. After 15 mL of electrolyte solution was injected into each of the cells, the cells were sealed under reduced pressure set at −60 kPa with the use of a degassing sealer capable of reducing pressure.

The loading level of the positive electrode active material (the loading level of the positive electrode active material composite) in each of the laminate cells A and B was approximately 21 mg/cm². The loading level of the negative electrode active material in the negative electrode was approximately 15 mg/cm². In the case of double-side coating, the loading level of the active material is represented by a value per active material layer on one side of the current collector. In each of the laminate cells, the area of the positive electrode applied to one side of the current collector was approximately 21 cm² and the area of the negative electrode was approximately 24 cm². In each of the laminate cells, the area of the negative electrode is preferably larger than the area of the positive electrode, and is preferably more than or equal to 1.1 times and less than or equal to 1.3 times the area of the positive electrode. Therefore, the loading level of the negative electrode active material is preferably lower than the loading level of the positive electrode active material (the loading level of the positive electrode active material composite).

The table below lists the fabrication conditions of the laminate cells for the nail penetration test.

TABLE 2

| | | Laminate cell A | Laminate cell B |
|---|---|---|---|
| Positive | Active material | Sample A | Sample B |
| electrode | composite | C-10N:LFP (8:2) | C-10N:LFP (9:1) |
| | Binder | PVDF | |
| | Conductive additive | Acetylene black | |
| | Loading level (per one | Approx. 21 mg/cm² | |
| | side) | | |
| | Current collector | Al (double mirror surfaces)/20 μm | |
| | Material/Thickness | | |
| | Active material layer | 75 μm | 74 μm |
| | thickness (average per | | |
| | one side) | | |
| | Pressing pressure | 210 kN/m | |
| Negative | Active material | FormulaBT SLC1520T (spherical natural graphite) | |
| electrode | Binder, Thickener | SBR, CMC | |
| | Conductive additive | VGCF | |
| | Loading level (per one | Approx. 15 mg/cm² | |
| | side) | | |
| | Current collector | Cu/18 μm | |
| | Material/Thickness | | |
| | Active material layer | 127 μm | 125 μm |
| | thickness (average per | | |
| | one side) | | |
| | Pressing pressure | 28 kN/m | |
| Separator | Material/Thickness | PP (polypropylene)/25 μm | |
| Electrolyte | Main solvent/Additive | EC:DEC (3:7)/None | |
| solution | Lithium salt | 1M LiPF₆ | |
| Cell | Number of positive | 16 pieces (double-side | 17 pieces (double-side |
| condition | electrodes | coating) | coating) |
| | Number of negative | 15 pieces (double-side | 16 pieces (double-side |
| | electrodes | coating) + 2 pieces on outer | coating) + 2 pieces on outer |
| | | side (single-side coating) | side (single-side coating) |
| | Exterior body | Aluminum laminate film | |
| | | (PP 22.5 μm, PP 22.5 μm, Al 40 μm, nylon 25 μm in | |
| | | this order from the inside) | |
| | Injection amount of | 15 mL | |
| | electrolyte solution | | |

### <Aging and Resealing>

First, aging and resealing of the laminate cells A and B were performed. The aging and resealing methods are shown in the table below. Note that aging is sometimes referred to as initial charging and discharging or conditioning. In the table below, 1 C is 200 mA/g (per weight of a positive electrode active material). Step A4 in the table below corresponds to resealing, and resealing is referred to as degasification resealing. The ambient temperature in the table below allows an error of ±5 °C.

TABLE 3

| | Charging/ | |
|---|---|---|
| | discharging | Conditions |
| Step A1 | Constant | 0.01 C, ambient temperature: 23 °C |
| | current | Charging was stopped when the voltage reached |
| | charging | 4.5 V or the capacity reached 15 mAh/g. |
| Step A2 | Constant | 0.1 C, ambient temperature: 23 °C |
| | current | Charging was stopped when the voltage reached |
| | charging | 4.5 V or the capacity reached 105 mAh/g. |
| Step A3 | w/o | Placed still in a thermostatic chamber set at |
| | | 60 °C for 24 hours |
| Step A4 | w/o | In a glove box, one side of a cell was opened and |
| | | resealed under a pressure reduced to −60 kPa. |
| Step A5 | Constant | 0.1 C, 4.5 V, ambient temperature: 23 °C |
| | current- | Charging was stopped when the current reached |
| | constant | 0.01 C or less or 10 hours elapsed. |
| | voltage | |
| | charging | |
| Step A6 | Constant | 0.2 C, ambient temperature: 23 °C |
| | current | Discharging was stopped when the voltage |
| | discharging | reached 2.5 V or 8 hours elapsed. |
| Step A7 | Constant | 0.2 C, 4.5 V, ambient temperature: 23 °C |
| | current- | Charging was stopped when the current reached |
| | constant | 0.02 C or less or 8 hours elapsed. |
| | voltage | |
| | charging | |
| Step A8 | Constant | 0.2 C, ambient temperature: 23 °C |
| | current | Discharging was stopped when the voltage |
| | discharging | reached 2.5 V or 8 hours elapsed. |

*Step A7 and Step A8 were repeated three times in total.

### <Charge Capacity Measurement>

After the aging treatment, the laminate cells A and B were charged in accordance with Step A7 in Table 3, and the charge capacity of the cells was measured. As a charge-discharge measuring instrument for measuring charge capacity, a charge-discharge measuring system (TOSCAT-3000) manufactured by TOYO SYSTEM Co., LTD. was used. The following table shows charge capacities in fully charged states of the laminate cells A and B and charge capacities per weight of the positive electrode active material of the laminate cells A and B. The laminate cells each showed the charge capacity close to 2500 mAh as a set value, and abnormality in the charge capacity was not observed. It was found that when the proportion of LFP was high, the charge capacity tended to decrease.

TABLE 4

| | | Laminate cell A | Laminate cell B |
|---|---|---|---|
| Conditions | Charge voltage | 4.5 V | |
| of nail | Charge capacity | 2887 mAh | 2936 mAh |
| penetration | Charge capacity per | 199 mAh/g | 208 mAh/g |
| | weight of positive | | |
| | electrode active material | | |

### <Nail Penetration Test>

After AC impedance measurement, the laminate cells A and B in a fully charged state were subjected to a nail penetration test. For the nail penetration test, an advanced safety tester (manufactured by ESPEC CORP.) was used as the tester illustrated in FIG. 6A and FIG. 6B, and the tester was placed in an environment at 25 °C.

Before the nail penetration test, the temperature of the exterior body of each of the laminate cells A and B was confirmed to be approximately 22 °C. In this example, a temperature sensor was placed at a distance of 2 cm from the nail hole, and the value obtained with the temperature sensor was used as the temperature of the exterior body. Note that by placing the temperature sensor in the same position, there is presumed to be no difference or an extremely small difference in the temperature of the exterior body between the laminate cells A and B even in the case where the temperature gradient in the exterior body is taken into consideration.

As the nail 1003 in FIG. 6A and FIG. 6B, a nail having a diameter of 3 mm was used. The nail penetration speed was 5 mm/s. The depth of nail penetration was the thickness of the secondary battery+5 mm. The other conditions in the nail penetration test were compliant with SAE J2464, “Electric and Hybrid Electric Vehicle Rechargeable Energy Storage System (RESS) Safety and Abuse Testing”.

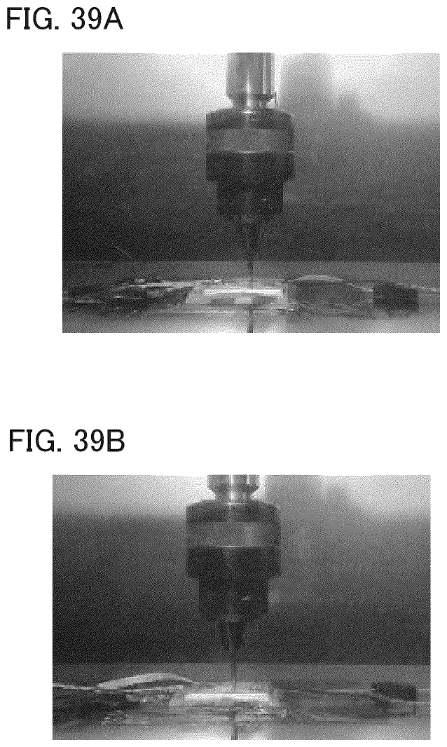

FIG. 39A shows the state of the nail penetration test of the laminate cell A, and FIG. 39B shows the state of the nail penetration test of the laminate cell B. As shown in FIG. 39A and FIG. 39B, it was determined that the laminated cells A and B showed no ignition because they did not ignite or only a small amount of fumes from them was observed.

The cell temperatures (the temperature of the exterior body read by the temperature sensor) of the laminate cells A and B immediately after the nail penetration operation were the maximum temperatures, and the maximum temperatures of the laminate cell A and the laminate cell B were 51 °C and 60 °C, respectively. It was found that when the proportion of LFP is high, the maximum temperature reached tends to decrease. The temperature presumed to be increased by heat generation in the nail penetration test is a difference obtained by subtracting 22 °C from the maximum value obtained with the temperature sensor (which is referred to as temperature rise ΔT). The temperature rise ΔT of the laminate cell A was 29 °C, and the temperature rise ΔT of the laminate cell B was 38 °C. That is, it is found that the temperature rise ΔT of the cell is preferably lower than or equal to 50 °C, further preferably lower than or equal to 45 °C, still further preferably lower than or equal to 40 °C, in order that no ignition was caused in the nail penetration test. The table below shows evaluation results and maximum temperatures reached in the nail penetration test.

TABLE 5

| | | Laminate cell A | Laminate cell B |
|---|---|---|---|
| Nail penetration | Evaluation results | No ignition•slightly fuming | No ignition•slightly fuming |
| test | Maximum temperature | 51 °C | 60 °C |
| | reached (°C) | | |

Note that when a nail penetration test was performed on the reference laminated cell using C-10N under the same conditions, the laminated cell ignited. In accordance with this example, it is inferred that mixing LFP with C-10N can inhibit ignition in the nail penetration test. That is, a secondary battery in which LFP is added to LCO is inferred to have improved safety. However, an increase in the proportion of LFP lowers the charge capacity; thus, the proportion of LFP to the entire positive electrode active material (LFP/C-10N+LFP) is preferably higher than or equal to 5% and lower than or equal to 25%, further preferably higher than or equal to 10% and lower than or equal to 20%, still further preferably approximately 10%.

### Example 2

In this example, a new sample was prepared and its characteristics were measured. The new sample was fabricated as follows.

### <Formation of Lithium Cobalt Oxide Containing Mg, F, Ni, and Al>

The formation conditions of lithium cobalt oxide containing Mg, F, Ni, and Al are described. A commercially available lithium cobalt oxide containing no additive element (CELLSEED C-10N produced by NIPPON CHEMICAL INDUSTRIAL CO., LTD.) was prepared and sieved with an automatic sieving machine. Processing with an automatic sieve machine can be performed under the following conditions: for example, an electromagnetic vibrating sieve MS-200 produced by Ito Seisakusho Co., Ltd. is used, a size of a sieve opening is 53 μm, and tapping balls are used. As the initial heating in Step S15, heating was performed on the lithium cobalt oxide put in a saggar covered with a lid, in a roller hearth kiln simulator furnace (produced by NORITAKE CO., LIMITED) as a baking furnace at 850 °C for two hours. Air (compressed air which was sufficiently dried) was made to flow at 10 L/min in the furnace. The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200 °C/h, with the air keeping on flowing until the temperature reached 200 °C.

As the additive element A source in Step S20, a Mg source and an F source were prepared. Specifically, LiF was prepared as the F source and MgF₂ was prepared as the Mg source. LiF and MgF₂ were weighed such that the molar ratio of LiF to MgF₂ was 1:3, and were mixed in dehydrated acetone at a rotation speed of 500 rpm for 20 hours in Step S22. In Step S23, sieving was performed with the automatic sieving machine to form the additive element source (A1 source) with a uniform particle diameter.

Next, in Step S31, the A1 source was weighed such that magnesium of the A1 source was 1 mol % with respect to cobalt of the lithium cobalt oxide, and the A1 source and the lithium cobalt oxide that had been subjected to the initial heating were stirred with Picobond (Hosokawa Micron) at a rotation speed of 3000 rpm for 10 minutes, whereby the mixture 903 was obtained (Step S32). Nobilta was used as a rotor of Picobond. Before the subsequent Step S33, the mixture 903 was sieved with an automatic sieving machine.

Next, in Step S33, the mixture 903 was heated. The heating conditions were 900 °C and 20 hours. During the heating, the mixture 903 was placed in a saggar covered with a lid. The saggar was placed in a roller hearth kiln simulator furnace (NORITAKE CO., LIMITED), and heated at the above heating temperature. Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200 °C/h, with oxygen keeping on flowing until the temperature reached 200 °C. In this manner, a composite oxide including Mg and F was obtained (Step S34a).

Then, in Step S40, a composite oxide and an additive element source (A2 source) were prepared. First, nickel hydroxide subjected to a grinding step was prepared as a nickel source and aluminum hydroxide subjected to a grinding step was prepared as an aluminum source in accordance with Step S41, and these were used as the additive element source (the A2 source). As the grinding step, the nickel hydroxide and the aluminum hydroxide were mixed in dehydrated acetone at a rotation speed of 500 rpm for 20 hours. After that, the mixture was made to pass through a sieve with an aperture size of 300 μm.

As the A2 source, the nickel hydroxide and the aluminum hydroxide were weighed such that nickel in the nickel hydroxide and aluminum in the aluminum hydroxide were each 0.5 mol % with respect to the cobalt. The weighed nickel hydroxide, aluminum hydroxide, and composite oxide containing Mg and F were stirred at a rotational speed of 3000 rpm for 10 minutes with use of Picobond (Hosokawa Micron), whereby a mixture 904 was obtained (Step S52). Nobilta was used as a rotor of Picobond. Before the subsequent Step S53, the mixture 904 was sieved with an automatic sieving machine.

In Step S53, the mixture 904 was heated. The heating conditions were 850 °C and 10 hours. During the heating, the mixture 904 was placed in a saggar covered with a lid. The saggar was placed in a roller hearth kiln simulator furnace (NORITAKE CO., LIMITED), and heated at the above heating temperature. Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the heating, cooling in the furnace was performed at a rate of 200 °C/h, with oxygen keeping on flowing until the temperature reached 200 °C.

In this manner, lithium cobalt oxide containing Mg, F, Ni, and Al was obtained (Step S54).

### <Formation of Samples C and D>

As the first positive electrode active material 100x, lithium cobalt oxide containing Mg, F, Ni, and Al (referred to as LCO21) was prepared. As the second positive electrode active material 100y, commercially available lithium iron phosphate (EQ-Lib-LFPO (KJ-2) produced by MTI Corporation, hereinafter referred to as “LFP”) was prepared.

As the positive electrode active material composite 100α, a sample C in which the LCO21:LFP satisfies 80:20 (weight ratio) and a sample D in which the LCO21:LFP satisfies 90:10 (weight ratio) were fabricated. Kneading was performed as the mixing condition in a manner similar to that in Example 1. The conditions of the sample C and the sample D are collectively shown below.

TABLE 6

| | First positive | Second | First positive electrode active |
|---|---|---|---|
| | electrode | positive | material:Second positive |
| | active | electrode active | electrode active material |
| | material | material | (Weight ratio) |
| Sample C | LCO21 | LFP | 80:20 |
| Sample D | | | 90:10 |

### <Formation of Positive Electrodes C and D>

The samples C and D described above were prepared as the positive electrode active material, and the positive electrodes C and D were formed under the same conditions as those of the positive electrodes A and B.

### <Fabrication of Coin Cells C and D>

A coin cell C (CR2032 type with a diameter of 20 mm and a height of 3.2 mm) was fabricated using the positive electrode C obtained above, a lithium metal foil, an electrolyte solution, a separator, a positive electrode can, and a negative electrode can. Similarly, a coin cell D (CR2032 type with a diameter of 20 mm and a height of 3.2 mm) was fabricated using the positive electrode D, a lithium metal foil, a separator, an electrolyte solution, a positive electrode can, and a negative electrode can.

The electrolyte solution, the separator, and the like of the coin cells C and D were the same as those of the coin cells A and B.

### <DSC Test>

As pretreatment for the DSC test, aging was performed on the coin cells C and D placed in a thermostatic unit set at 25 °C. The conditions of the aging are shown below.
Charging: CCCV, 0.1 C, 4.6 V, 0.005 C cutoff
Discharging: CC, 0.1 C, 2.5 V cutoff
The amount of current corresponding to 1 C: 200 mA/g per weight of the positive electrode active material
The number of repetition times of charging and discharging: two

After the aging, DSC was measured. The charge conditions at the time of the DSC measurement are shown below.
Charging: CCCV, 0.1 C, 4.6 V, 0.005 C cutoff

Next, a sample for measuring DSC was fabricated. First, the coin cells C and D in charged states were each disassembled in a glove box with an argon atmosphere to take out the positive electrodes C and D, and the positive electrodes were washed with DMC to remove the electrolyte solution. Then, the positive electrodes C and D taken out were each stamped out to 3 mm.

After the positive electrodes C and D stamped out were each put in a stainless steel container, 1.5 μL of an electrolyte solution was dripped thereto. The lithium salt was prepared under the same condition as that used for the coin cells. Then, zirconium oxide balls with a diameter of 2 mm were put on the positive electrode in the above stainless steel container. Putting zirconium oxide balls has an effect of inhibiting the above positive electrode from being detached from the bottom surface of the container. After that, a stainless steel lid was put on the container to seal off the container.

### <DSC Measurement>

For DSC measurement, a high-sensitive differential scanning calorimeter, Rigaku Thermo plus EVO2 DSC8231, was used. For the measurement conditions, the temperature range was from room temperature to 400 °C, and the temperature rise rate was 5 °C/min.

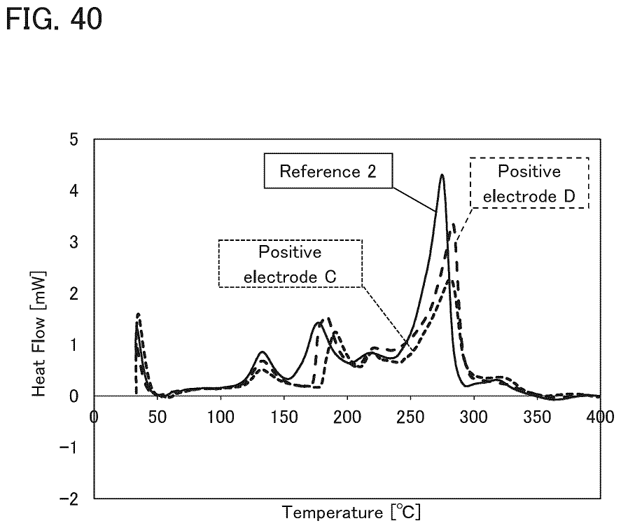

FIG. 40 is a DSC measurement graph. The horizontal axis represents Temperature, and the vertical axis represents Heat Flow. Note that as the background removal processing, the DSC measurement graph is subjected to correction in which a straight line with a measurement value at around 50 °C as a starting point and a measurement value at around 390 °C as an end point was set as a base line. The temperature around 50 °C is higher than or equal to 45 °C and lower than or equal to 55 °C, and the temperature around 390 °C is higher than or equal to 385 °C and lower than or equal to 395 °C.

Reference 2 in FIG. 40 is a positive electrode including LCO 21 (referred to as Reference 2). As shown in FIG. 40, the maximum peaks in the positive electrodes in the 4.6-V charged state were 284.3 °C for the positive electrode C, 283.6 °C for the positive electrode D, and 276.1 °C for Reference 2. It was found that the temperatures corresponding to the maximum peaks in the positive electrodes C and D were higher than that in Reference 2, i.e., due to the composite formation, the temperatures corresponding to the maximum peaks were shifted to the high temperature side, and the areas of the regions having the maximum peaks were decreased. As the reaction having the maximum peak, a thermal decomposition reaction involving release of oxygen from CoO₂ to CoO and Co₃O₄ is considered to occur at higher than or equal to 250 °C and lower than or equal to 300 °C. That is, the peak at higher than or equal to 250 °C and lower than or equal to 300 °C is shifted to the high temperature side due to the formation of the positive electrode active material composite, which indicates that the safety of the secondary battery including the positive electrode active material composite is improved.

It is inferred that mixing LFP as the second positive electrode active material with each of C-10N used in Example 1 and LCO21 used in Example 2 inhibited a thermal decomposition reaction involving release of oxygen from CoO₂ to CoO and Co₃O₄. That is, irrespective of the first positive electrode active material, mixing the second positive electrode active material makes it possible to provide a highly safe secondary battery.

### REFERENCE NUMERALS

100α: positive electrode active material composite, 100x: first positive electrode active material, 100xa: surface portion, 100xb: inner portion, 100y: second positive electrode active material, 100z: third positive electrode active material, 100za: surface portion, 100zb: inner portion, 102: carbon layer, 103: carbon layer

1. A secondary battery comprising:
a positive electrode, a negative electrode, and an electrolyte,
wherein the positive electrode comprises a first positive electrode active material and a second positive electrode active material,
wherein the first positive electrode active material is represented by LiM1O₂ (M1 represents one or two or more selected from Fe, Ni, Co, Mn, and Al),
wherein the second positive electrode active material is represented by LiM2PO₄ (M2 represents one or two or more selected from Fe, Ni, Co, and Mn),
wherein the first positive electrode active material comprises an additive element X on a surface portion,
wherein the additive element X comprises one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic,
wherein the negative electrode comprises graphite, and
wherein the graphite has a specific surface area greater than or equal to 0.8 m²/g m²/g which is measured by a BET method.

2. A secondary battery comprising:
a positive electrode, a negative electrode, and an electrolyte,
wherein the positive electrode comprises a first positive electrode active material and a second positive electrode active material,
wherein the first positive electrode active material is represented by LiM1O2 (M1 represents one or more selected from Fe, Ni, Co, Mn, and Al),
wherein the second positive electrode active material is represented by LiM2PO₄ (M2 represents one or more selected from Fe, Ni, Co, and Mn),
wherein the first positive electrode active material comprises an additive element X on a surface portion,
wherein the additive element X comprises one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic,
wherein the negative electrode comprises graphite, and
wherein the graphite has a median diameter (D50) greater than or equal to 3 μm and less than or equal to 50 μm which is measured by a laser diffraction method.

3. The secondary battery according to claim 1,
wherein the electrolyte comprises a fluorinated cyclic carbonate and a fluorinated chain carbonate as a solvent.

4. The secondary battery according to claim 1,
wherein the electrolyte comprises a fluoroethylene carbonate and methyl trifluoropropionate as a solvent, and
wherein when a total volume of the fluoroethylene carbonate and the methyl trifluoropropionate is 100 vol %, a volume ratio of the fluoroethylene carbonate to the methyl trifluoropropionate is y:100−y (where 5≤y≤30).

5. The secondary battery according to claim 1,
wherein the additive element X comprises at least the magnesium and the fluorine, and
wherein when a cross section of the first positive electrode active material is analyzed by STEM-EDX line analysis, a peak of a concentration of the fluorine is positioned closer to a surface than a peak of a concentration of the magnesium is.

6. A vehicle comprising the secondary battery according to claim 1.

7. An electronic device comprising the secondary battery according to claim 1.
